(19) United States
(12) Patent Application Publication
(10) Pub. No.: US 2015/0335400 A1
(43) Pub. Date: Nov. 26, 2015

(54) TOOTH SCAFFOLDS

(71) Applicant: Jeremy J. Mao, Closter, NJ (US)

(72) Inventor: Jeremy J. Mao, Closter, NJ (US)

(73) Assignee: The Trustees of Columbia University in the City of New York, New York, NY (US)

(21) Appl. No.: 14/660,745

(22) Filed: Mar. 17, 2015

Related U.S. Application Data
(63) Continuation-in-part of application No. 13/378,789, filed on Jul. 26, 2012, now Pat. No. 8,979,534.
(60) Provisional application No. 61/354,164, filed on Jun. 11, 2010.
(60) Provisional application No. 61/187,875, filed on Jun. 17, 2009.

(51) Int. Cl. A61C 8/00; A61C 13/00; A61D 5/00; A61C 8/02

(52) U.S. Cl. CPC A61C 8/0036; A61C 8/0006; A61C 8/0012; A61C 13/0019; A61D 5/00

(57) ABSTRACT

Provided is a mammalian tooth-shaped scaffold including a composition that is chemotactic, osteogenic, dentinogenic, amelogenic, or cementogenic. Also provided is a method of replacing a tooth in the mouth of a mammal, where the tooth is absent and a tooth socket is present in the mouth at the position of the absent tooth. The method comprises implanting a scaffold having the shape of the missing tooth into the tooth socket. Additionally, a method of making a tooth scaffold is provided. The method comprises synthesizing a scaffold in the shape of a mammalian tooth and adding at least one composition that is chemotactic, osteogenic, dentinogenic, amelogenic, or cementogenic.

### CROSS-REFERENCE TO RELATED APPLICATION

The present application is a Continuation-in-Part of U.S. Nonprovisional application Ser. No. 13/378,789, filed 17 Jun. 2010, which claims the benefit of PCT International Application No. PCT/US10/39035 filed 17 Jun. 2010, which claims the benefit of U.S. Provisional Application Ser. No. 61/354,164 filed 11 Jun. 2010, and U.S. Provisional Application Ser. No. 61/187,875 filed 17 Jun. 2009; all of which are incorporated herein by reference in their entireties.

### STATEMENT REGARDING FEDERALLY SPONSORED RESEARCH OR DEVELOPMENT

This invention was made with government support under grant numbers RC2DE020767 and R01DE023112 awarded by the National Institute of Health and National Institute of Dental and Craniofacial Research. The Government has certain rights in this invention.

### FIELD OF INVENTION

The present invention relates to tissue engineering of tooth scaffolds.

### BACKGROUND

Tooth loss is the most common organ failure, and has been shown to severely deteriorate quality of life. By 2020, a total of 38 million Americans are estimated to be completely edentulous. Currently, about 7 million conventional dental implants are placed in the U.S. per year, far less than the total number of dentures (about 15 million). Strikingly, about 13 million edentulous patients do not receive any treatment for their missing teeth.

A tooth is a complex organ consisting of hard or soft tissues, including enamel, dentin, cementum, or vascularized dental pulp. The periodontium refers to tissues surrounding or supporting the tooth, including cementum, periodontal ligament (PDL), or alveolar bone. Despite textbook definition as separate anatomical entities, it is presently thought that tooth root and the periodontium is functionally a single unit. Approximately 64% of the U.S. population has lost at least one permanent tooth due to dental caries, periodontal disease, trauma, or genetic disorders. The field of tooth regeneration has grown robustly.

Biomedical engineering and tooth regeneration. Tooth loss often results from a variety of oral diseases and physiological causes, including dental caries, periodontal disease, trauma, genetic disorders and aging (Amar 2003, Philstrom 2005, Kim 2006). Tooth loss can lead to physical and mental suffering that can lower an individual's self-esteem and quality of life (Amar 2003, Philstrom 2005, Kim 2006). Many forms of dental disease and some medical conditions like uncontrolled diabetes increase the risk of tooth loss. For the treatment of edentulism, the current options have been limited to the use of dental implants or conventional fixed or removable prostheses.

Recently, the emergence and development of biomedical engineering tools have led to a new scope of patient care in the field of medicine. For example, preliminary human clinical trials have reported of improved levels of bone formation in children with osteogenesis imperfecta, following systemic infusions of bone marrow stromal stem cells (BMSSC) or bone marrow cells (Horwitz 2001, Horwitz 2002). Recent advances in the fields of dental tissue engineering, materials science and stem cell biology suggest that tooth regeneration will be possible (Duailibi 2006). Additionally, the recent identification of different mesenchymal stem cells (MSCs) residing in dental or craniofacial tissues expands the scope of potential clinical benefits in helping to regenerate the dental tissues such as dentin, cementum and periodontal ligament (PDL) (Shi 2005). Dental tissue progenitor cells present in the pulp tissue of deciduous and adult teeth can be used to regenerate dentin and alveolar bone (Shi 2005; Zhang 2005). Additionally, cells isolated from both rat and pig tooth buds can be used to bioengineer anatomically correct tooth crowns but with limited predictability (Duailibi 2004, Honda 2005, Young 2002, Young 2005).

The tooth/periodontal complexes are often referred to as an individual organ. Although this organ is considered relatively small, its structural and developmental complexity is well recognized. The tooth structure consists of three calcified tissue types—enamel, dentin and cementum, and dental pulp. Dentin occupies the bulk of the tooth, while enamel and cementum cover the coronal and apical portions, respectively. The periodontium has a supportive role to the teeth and consists of cementum, periodontal ligaments, alveolar bone and gingiva. Periodontal ligaments are connective tissues that attach the cementum to the alveolar bone via the Sharpey's fibers. Periodontal ligaments enable sensory perception and cushion mechanical forces during mastication.

Despite the tooth's structural complexity, the advancement of biomedical engineering techniques has given rise to two currently employed approaches for tooth regeneration. The first is based on tissue engineering, aiming to regenerate teeth by seeding stem cells in scaffolding biomaterials (Young 2002, Duailibi 2004, Honda 2005). This technique has shown promising results in regeneration of the periodontium (Nakahara 2006). The second approach attempts to reproduce or mimic the developmental processes of embryonic tooth formation (Nakahara 2006). This approach uses embryonic tissues (dental epithelium and dental mesenchyme) harvested from a mouse fetus and requires an understanding of the principles that regulate early tooth development in the embryo (Ohazama 2004, Hu 2006, Nakao 2007). Following these approaches, in many studies, biologically engineered tooth germs are transplanted into the bodies of animal hosts, usually rodents, where there is sufficient blood flow to provide the necessary nutrients and oxygen to optimize tissue formation (Nakahara 2006).

Use of stem cells in tissue regeneration and challenges encountered. Stem cells are quiescent cell populations present in normal tissue, which exhibit the distinct characteristic of asymmetric cell division, the formation two daughter cells—a new progenitor/stem cell, and another daughter cell capable of forming differentiated tissue (Hawkins 1998, Lin 1998). Dental mesenchymal progenitor cells have been identified and characterized in the dental pulp of both deciduous and adult human teeth (Gronthos 2000, Mooney 1996, Shi 2005). As previously mentioned, these postnatal epithelial and mesenchymal dental stem/progenitor cells present in immature tooth buds have demonstrated the ability to generate bioengineered and anatomically correct, but miniature-sized tooth crowns containing enamel, dentin, pulp, and alveolar bone (Shi 2005; Zhang 2005).

Periodontal ligament cells are known for their regenerative potential to give rise to the formation of lamina propria, cementum, bone, and periodontal ligament (Melcher 1985, McCulloh 1985). The capacity of periodontal ligament stem cells to form mineralized deposits in vitro has been demonstrated for a subpopulation of cells derived from primary explants of periodontal ligament (Arceo 1991, Cho 1992). It is believed that periodontal ligament stem cells require a suitable scaffold to induce the formation of bone, dentin and cementum in vivo (Gronthos 2000, Krebsbach 1998). When periodontal ligament stem cells were incorporated into a hydroxyapatite/tricalcium phosphate scaffolds and ectopically implanted in the subcutaneous regions of the mouse dorsum, a typical cementum/periodontal ligament-like structure formed (Seo 2004). Moreover, a type I collagen-positive periodontal ligament-like tissue within the transplants connecting with the newly formed cementum that is morphologically similar to Sharpey's fibers has been demonstrated (Seo 2004).

Recent advances in dental stem cell biotechnology and cell-mediated murine tooth regeneration have encouraged researchers to explore the potential for regenerating living teeth with appropriate functional properties (Duailibi 2004, Ohazama 2004, Shi 2005). Murine teeth can be regenerated using many different stem cells to collaboratively form dental structures in vivo (Duailibi 2004, Ohazama 2004, Young 2005). In addition, dentin/pulp tissue and cementum/periodontal complex have been regenerated by human dental pulp stem cells (DPSCs) and periodontal ligament stem cells (PDLSCs) respectively, when transplanted into immune-compromised mice (Gronthos 2000, Seo 2004). However, owing to the complexity of human tooth growth and development, the regeneration of a whole tooth structure including enamel, dentin/pulp complex, and periodontal tissues as a functional entity in humans is a challenge with the currently available regenerative biotechnologies (Sonomaya 2006).

The challenges with the use of stem cells in regeneration of dental tissues have been reported in previous studies (Duailibi 2004, Young 2002, Young 2005). It is acknowledged that, while formation of multiple miniature tooth crowns in the bioengineered tooth constructs is possible, real-size whole-tooth regeneration encounters a number of challenges. These challenges are attributed, again, to the complex nature of tooth development (Duailibi 2006, Tummers 2003).

Concepts of cell homing. As put forward, conventional approaches of stem cell-seeding within a scaffold aim to mimic cellular structure and recreate a functional tissue equivalent in vitro or in vivo. The cells are derived from end organs or from more undifferentiated sources such as the bone marrow (Schantz 2007). These approaches are limited by issues such as donor site morbidity from harvesting of cells and tissue formation of heterogeneous quality at the site of implantation of the cell-scaffold construct (Schantz 2007). Hence, the concept of cell homing is recently attracting more attention. Cell homing aims to induce the homing of desired cells to cytokine-impregnated scaffolds at specific anatomical sites (Schantz 2007). This approach attempts in vivo tissue regeneration without cell-seeding. Therefore, cell homing could provide enhancements in cellular methodology for tissue engineering and a novel, minimally invasive option for tissue regeneration (Schantz 2007).

### SUMMARY

Among the various aspects of the present disclosure is the provision an acellular mammalian tooth-shaped scaffold.

One aspect provides a tooth-shaped scaffold including a matrix material or a composition comprising stromal cell-derived factor-1 (SDF-1) and a bone morphogenetic protein-7 (BMP-7).

In some embodiments, the tooth-shaped scaffold includes a tooth-shaped scaffold, having the shape of a human incisor, a human cuspid, a human bicuspid, or a human molar.

In some embodiments, the tooth-shaped scaffold includes a composition including platelet-derived growth factor (PDGF), endothelial cell growth factor (ECGF), transforming growth factor-β (TGF-β), transforming growth factor-β1 (TGF-β1), epidermal growth factor (EGF), hepatocyte growth factor (HGF), a bone morphogenetic protein (BMP) other than BMP-7, a growth and differentiation factor (GDF), insulin-like growth factor-1 (IGF1), vascular endothelial growth factor (VEGF), fibroblast growth factor (FGF), a dentin matrix protein, a dentin sialoprotein, a bone sialoprotein, amelogenin, or an integrin. In some embodiments, the tooth-shaped scaffold including SDF-1 and BMP-7, where SDF-1 functions as a chemotactic growth factor is and BMP-7 functions as an osteogenic, dentinogenic, amelogenic, or cementogenic growth factor. In some embodiments, the tooth-shaped scaffold includes BMP-7 at about 10 ng/g to 1000 μg/g scaffold and SDF1 at about 10 ng/g to 1000 μg/g scaffold; or BMP-7 at about 100 μg/g scaffold and SDF1 at about 100 μg/g scaffold.

In some embodiments, the tooth-shaped scaffold includes a matrix material including an osteoconductive material. In some embodiments, the tooth-shaped scaffold includes hydroxyapatite. In some embodiments, the tooth-shaped scaffold includes a matrix material comprises a mixture of ε-polycaprolactone and hydroxyapatite; or a matrix material comprises a mixture of about 80 wt % ε-polycaprolactone and about 20 wt % hydroxyapatite.

In some embodiments, the tooth-shaped scaffold including microchannels having a diameter of between 50 and 500 μm or about 200 μm. In some embodiments, the tooth-shaped scaffold including a composition imbedded in a gel in the microchannels, or the composition is imbedded in a collagen gel in the microchannels. In some embodiments, the tooth-shaped scaffold including a composition imbedded in a gel in the microchannels and the scaffold further comprises a nonporous cap.

In some embodiments, the tooth-shaped scaffold including microchannels having a diameter of about 200 μm; BMP-7 is imbedded in the microchannels in a collagen gel at a concentration of about 100 ng/ml gel; SDF1 is imbedded in the microchannels in a collagen gel at a concentration of about 100 ng/ml gel; or the scaffold further comprises a nonporous cap.

In some embodiments, the tooth-shaped scaffold including a composition in a slow-release formulation. In some embodiments, the tooth-shaped scaffold includes a slow release formulation composition comprising a chemotactic growth factor of SDF1 and an osteogenic, dentinogenic, amelogenic, or cementogenic growth factor of BMP-7; an osteoconductive material comprising a mixture of about 80 wt % ε-polycaprolactone and about 20 wt % hydroxyapatite; microchannels in the osteoconductive material having a diameter of between 50 μm and 500 μm, the microchannels comprising a gel; or a nonporous cap.

In some embodiments, the tooth-shaped scaffold includes a 3D printed scaffold; the scaffold is the shape of a first molar from a human mouth; the matrix material comprises an osteoconductive material; the matrix material comprises hydroxyapatite; the matrix material comprises a mixture of ε-polycaprolactone and hydroxyapatite; the matrix material comprises a mixture of about 80 wt % ε-polycaprolactone and about 20 wt % hydroxyapatite; the scaffold comprises microchannels having a diameter of between about 50 and about 500 μm; the scaffold comprises microchannels having a diameter of about 200 μm; the composition is imbedded in microchannels in a collagen gel; the composition is imbedded in microchannels in a collagen gel, the collagen gel comprising SDF1 at a concentration of about 100 ng/ml gel, and BMP-7 at a concentration of about 100 ng/ml gel; or the scaffold comprises a nonporous cap

In some embodiments, the tooth-shaped scaffold includes collagen gel imbedded in the microchannels of the scaffold; BMP-7 at a concentration of about 100 ng/ml in the microchannels of the scaffold; or SDF-1 at a concentration of about 100 ng/ml in the microchannels of the scaffold.

In some embodiments, the tooth-shaped scaffold is shaped like a tooth that is absent in a mammal; the scaffold is shaped like a first molar from a human mouth; the matrix material comprises an osteoconductive material; the matrix material comprises hydroxyapatite; the matrix material comprises a mixture of ε-polycaprolactone and hydroxyapatite; the scaffold comprises microchannels having a diameter of between 50 μm and 500 μm; or the scaffold further comprises a nonporous cap.

Other objects and features will be in part apparent and in part pointed out hereinafter.

### BRIEF DESCRIPTION OF THE DRAWINGS

Those of skill in the art will understand that the drawings, described below, are for illustrative purposes only. The drawings are not intended to limit the scope of the present teachings in any way.

FIG. 1 is a flow chart showing the design of the study described in the Example.

FIG. 2A-FIG. 2G are a series of photographs showing scaffold fabrication using a 3D printing system (Bioplotter™). FIG. 2A shows the Bioplotter™ used to create the scaffolds; FIG. 2B shows a fabricated rat mandibular central incisor root (left) and human molar-shaped PCL-HA scaffold (right); FIG. 2C shows the ethylene oxide sterilizer used to sterilize the scaffolds; FIG. 2D shows scaffolds being treated with growth factors (SDF1 and BMP-7); FIG. 2E shows the scaffold incubated for collagen cross-linking in the scaffolds prior to implantation; FIG. 2F shows scaffolds being loaded by the growth factors and collagen gel; FIG. 2G show a rat implanted with scaffolds at the extraction socket and dorsum sites.

FIG. 3 is a series of photographs of fabricated human mandibular molar-shaped scaffold for implantation in a rat dorsum. The crown and root were fabricated separately and fused later. The microchannels are evident.

FIG. 4A-FIG. 4F are a series of photographs of the extraction of a mandibular central incisor followed by implantation of a root-form scaffold in the socket. FIG. 4A shows the retraction of the lower lip; FIG. 4B shows incision and reflection of the gingival flap; FIG. 4C shows atraumatic extraction of the left mandibular central incisor showing preserved bony walls of the socket; FIG. 4D shows the extracted incisor and root-form scaffold in comparison; FIG. 4E shows the scaffold implanted in the extraction socket; FIG. 4F shows the gingival flap sutured and primarily closed.

FIG. 5A-FIG. 5D are a series of photographs of the subcutaneous implantation of a human mandibular molar-shaped scaffold in a rat dorsum site. FIG. 5A shows a 2-cm incision being made; FIG. 5B shows the creation of a subcutaneous pouch; FIG. 5C shows the implantation of a scaffold into the pouch; FIG. 5D shows the primary closure.

FIG. 6A-FIG. 6C are a series of photographs showing en bloc harvest of the mandibular central incisor scaffold. FIG. 6A shows complete wound healing which was evident before the harvest; FIG. 6B shows an incision made to access the scaffold; FIG. 6C shows the en bloc harvest of the scaffold (right) and the adjacent incisor (left).

FIG. 7A-FIG. 7D are is a series of photographs showing the procedure for implanted scaffold harvest at the dorsum site. FIG. 7A shows complete wound healing prior to the harvest; FIG. 7B shows the incision made to access the scaffold; FIG. 7C shows fascial encapsulation of the scaffold; FIG. 7D shows retrieved scaffolds.

FIG. 8A-FIG. 8B are a series of micrographs of stained scaffold sections showing the regions selected for histological analyses. FIG. 8A shows three regions selected in the mandibular central incisor scaffold; FIG. 8B shows four regions selected in the human mandibular molar scaffold.

FIG. 9A-FIG. 9C are a series of micrographs of stained scaffold sections showing the tissue-scaffold interface of an incisor root-form scaffold within the extraction socket (test). FIG. 9A shows a von Kossa (VK)-stained slide depicting bony ingrowth at the interface; FIG. 9B shows a hematoxylin and eosin (H&E)-stained section showing close adaptation and integration of the scaffold to the socket wall; FIG. 9C shows a higher magnification view demonstrating evident angiogenesis and soft tissue ingrowth between the PCL-HA strands.

FIG. 10A-FIG. 10B are a series of micrographs of stained scaffold sections showing the tissue-scaffold interface of a human mandibular molar-shaped scaffold from a dorsum site (test and control groups). FIG. 10A shows angiogenesis and ingrowth of tissues around and between the strands; FIG. 10B shows a higher magnification view showing integration between the scaffold and the encapsulating tissues.

FIG. 11A-FIG. 11B are a series of micrographs of stained scaffold sections showing representative views of scaffolds from extraction sockets showing differences in cellular density of a test scaffold (FIG. 11A) vs. a control scaffold without growth factors (FIG. 11B).

FIG. 12A-FIG. 12B are a series of micrographs of stained scaffold sections showing representative views of scaffolds from dorsum sites showing differences in cellular density of a test scaffold (FIG. 12A) vs. a control scaffold without growth factors (FIG. 12B).

FIG. 13 is a graph showing differences in cellular density between experimental groups and implantation sites. GF+: test; GF−: control. “*”: p<0.05.

FIG. 14A-FIG. 14B are a series of micrographs of stained scaffold sections showing representative views of scaffolds from extraction sockets showing differences in vessel density of a test scaffold (FIG. 14A) vs. a control scaffold without growth factors (FIG. 14B).

FIG. 15A-FIG. 15B are a series of micrographs of stained scaffold sections showing representative views of scaffolds from dorsum sites showing differences in vessel density of a test scaffold (FIG. 15A) vs. a control scaffold without growth factors (FIG. 15B).

FIG. 16 is a graph showing differences in vessel density between experimental groups and implantation sites. GF+: test; GF−: control. “*”: p<0.05.

FIG. 17A-FIG. 17B are a series of micrographs of stained scaffold sections showing representative views showing differences in vessel diameter of scaffolds from an extraction socket (FIG. 17A) vs. a dorsum site (FIG. 17B).

FIG. 18 is a graph showing differences in vessel diameter between experimental groups and implantation sites. GF+: test; GF−: control. “*”: p<0.05.

FIG. 19A-FIG. 19B are a series of micrographs of VK-stained scaffold sections showing representative views of test group scaffolds from the extraction sockets showing mineralization.

FIG. 20A-FIG. 20B are a series of micrographs of VK-stained scaffold sections showing representative views of test group scaffolds from dorsum sites showing mineralization.

FIG. 21A-FIG. 21G are a series of images of the three-dimensional (3D) printed seamless scaffold with region-specific microstructure and spatial delivery of proteins.

FIG. 21A is a photograph of a three dimensional (3D) printed seamless scaffold with region-specific microstructure and spatial delivery of proteins.

FIG. 21B is a photograph of the phase with the 100 μm microchannels with 2.5 mm in width (Phase A).

FIG. 21C is a photograph of the phase with the 600 μm micro-channels with 500 μm in width (Phase B).

FIG. 21D is a photograph of the phase with the 300 μm microchannels with 2.25 mm in width (Phase C).

FIG. 21E is a photograph of Poly(lactic-co-glycolic acid) micro-spheres encapsulating amelogenin, connective tissue growth factor (CTGF), and bone morphogenetic protein-2 (BMP2) were spatially tethered to Phases A.

FIG. 21F is a photograph of Poly(lactic-co-glycolic acid) micro-spheres encapsulating amelogenin, connective tissue growth factor (CTGF), and bone morphogenetic protein-2 (BMP2) were spatially tethered to Phases B.

FIG. 21G is a photograph of Poly(lactic-co-glycolic acid) micro-spheres encapsulating amelogenin, connective tissue growth factor (CTGF), and bone morphogenetic protein-2 (BMP2) were spatially tethered to Phases C.

FIG. 22A-FIG. 22L2 are a series of micrographs showing amelogenin, CTGF, and BMP2 induced region-specific tissue phenotype by three dental stem/progenitor cells in vitro—Dental pulp stem/progenitor cells (DPSCs) (FIG. 22A-FIG. 22L), periodontal ligament stem/progenitor cells (PDLSCs) (FIG. 22A1-FIG. 22L1), and alveolar bone stem/progenitor cells (ABSCs) (FIG. 22A2-FIG. 22L2). Amelogenin was delivered in Phase A, CTGF in Phase B, and BMP2 in Phase C. The (+) sign indicates that these samples were contacted with protein encapsulated microspheres. The (−) sign indicates the samples were contacted with empty microspheres without proteins.

FIG. 23A-FIG. 23I are a series of micrographs of DPSC-seeded scaffolds that have been treated with protein encapsulated microspheres (FIG. 23A, FIG. 23B, and FIG. 23C), with empty microspheres without proteins (FIG. 23D, FIG. 23E, and FIG. 23F), and with an IgG control (FIG. 23G, FIG. 23H, and FIG. 23I). Amelogenin was delivered in Phase A, CTGF in Phase B, and BMP2 in Phase C.

FIG. 24A-FIG. 24M are a series of micrographs of DPSC-seeded scaffolds, demonstrating the mineralization patterns at 1 week (FIG. 24A, FIG. 24B, and FIG. 24C), at 2 weeks (FIG. 24D, FIG. 24E, FIG. 24F, FIG. 24J, and FIG. 24K), and at 3 weeks (FIG. 24G, FIG. 24H, FIG. 24I, FIG. 24L, and FIG. 24M). Amelogenin was delivered in Phase A (FIG. 24A, FIG. 24D, and FIG. 24G), CTGF in Phase B (FIG. 24B, FIG. 24E, and FIG. 24H), and BMP2 in Phase C (FIG. 24C, FIG. 24F, and FIG. 24I). Amelogenin was delivered in Phase C (FIG. 24J and FIG. 24L), and BMP2 in Phase A (FIG. 24K and FIG. 24M).

FIG. 25A-FIG. 25D are a series of graphs plotting mRNA expression of Col-1 (FIG. 25A), DSPP (FIG. 25B), BSP (FIG. 25C), and CEMP-1 (FIG. 25D) in DPSCs cultured in multiphase scaffolds in vitro. The (+) sign indicates that these samples were contacted with protein encapsulated microspheres. The (−) sign indicates the samples were contacted with empty microspheres without proteins. Amelogenin was delivered in Phase A, CTGF in Phase B, and BMP2 in Phase C.

FIG. 26A-FIG. 26O are a series of micrographs demonstrating the formation of collagen fibers inserting into mineralized dentin/cementum-like tissue and bone-like tissue in vivo. Amelogenin was delivered in Phase A (FIG. 26A, FIG. 26D, FIG. 26G, FIG. 26J, and FIG. 26M), CTGF in Phase B (FIG. 26B, FIG. 26E, FIG. 26H, FIG. 26K, and FIG. 26L), and BMP2 in Phase C (FIG. 26C, FIG. 26F, FIG. 26I, FIG. 26L, and FIG. 26O). The (+) sign indicates that these samples were contacted with protein encapsulated microspheres. The (−) sign indicates the samples were contacted with empty microspheres without proteins.

FIG. 27A-FIG. 27J are a comparative diagram of the process of using a dental implant and an engineered scaffold.

FIG. 27A shows a photograph of the site of an extracted tooth on Day 1 of a dental implant procedure.

FIG. 27B is a photograph of the site of an extracted tooth approximately three months later, where the bone fills the extraction socket.

FIG. 27C shows an image of a bone grafting procedure.

FIG. 27D shows a photograph of the implant fixture.

FIG. 27E shows the abutment connected to support a clinical crown.

FIG. 27F shows a CT scan of the contralateral tooth. In certain embodiments, when a patient is scheduled to have the tooth extracted, a CT scan can be readily obtained.

FIG. 27G shows a 3D construction and fabrication of an anatomically correct tooth scaffold. The CT scan from FIG. 27F can be sent via a secure server to a laboratory for 3D construction and fabrication of an anatomically correct tooth scaffold. This could potentially take 20-40 minutes.

FIG. 27H is an image of the tooth scaffold. The scaffold can be sterilized, packaged, and shipped to a dental office by an express mail service.

FIG. 27I is an image of a tooth extraction site. Upon tooth extraction the anatomically correct tooth scaffold is implanted in the tooth extraction socket.

FIG. 27J shows that, following the regeneration of the root, periodontal ligament, and alveolar bone (which may take 2-3 months), the clinical crown is connected.

FIG. 28A-FIG. 28H are a series of images showing the development of the 3D printed biomaterial scaffolds.

FIG. 28A is a reconstruction of the root of a natural tooth obtained by cone-beam CT or MRI scans.

FIG. 28B is a 3D tooth root printed layer-by-layer using a broad range of biomaterials with resolution in the range of 10-100 μm.

FIG. 28C shows a rat mandibular incisor extracted atraumatically.

FIG. 28D is the rat mandibular incisor.

FIG. 28E is a 3D printed, anatomically correct biomaterial scaffold.

FIG. 28F shows a tooth root regenerated in 8 weeks in vivo.

FIG. 28G is a diagrammatic representation of the characteristics of 3D printed scaffold.

FIG. 28H is a diagrammatic representation of the features of the 3D printed scaffold that can be modified, such as the strand diameter, the pore size, and the layer thickness.

FIG. 29A-FIG. 29P are a series of images showing an analysis of the tooth root and periodontium regeneration.

FIG. 29A is a micrograph showing a regenerated tooth root and periodontium from 3D printed biomaterial scaffold, showing existing alveolar bone (b), newly formed alveolar bone (nb) adjacent to a periodontal ligament-like structure (pdl), and remaining scaffold material undergoing degradation (s).

FIG. 29B is a micrograph showing the interface between regenerated PDL and alveolar bone, with PDL consisting of fibroblast-like cells, and collagen fibers.

FIG. 29C is a micrograph showing von Kossa staining of the regenerated tooth root and periodontium.

FIG. 29D is a micrograph showing recruitment of abundant cells from host endogenous sources into microchannels of 3D-printed scaffolds, even without growth factor (GF) delivery.

FIG. 29E is a micrograph showing recruitment of host endogenous cells, when sample is treated with growth factors (GF), namely BMP7 that was delivered in 3D printed scaffolds.

FIG. 29F is a graphical representation of cells recruited into 3D printed scaffolds with and without the delivery of growth factors.

FIG. 29G and FIG. 29H are micrographs showing vascularization of newly formed bone with and without growth factor delivery.

FIG. 29I is a graphical representation of vascularization of newly formed bone with and without growth factor delivery.

FIG. 29J is a micrograph showing sections of coronal, apex and midroot samples taken for analysis.

FIG. 29K show Alizarin red staining of mineralization in 3D printed tooth-root scaffold with no microchannels.

FIG. 29L show Alizarin red staining of mineralization in 50 μm microchannels of 3D printed tooth-root scaffold.

FIG. 29M show Alizarin red staining of mineralization in 100 μm microchannels of 3D printed tooth-root scaffold.

FIG. 29N, FIG. 29O, and FIG. 29P show dentin sialophosphoprotein (DSPP) was robustly expressed with 100 μm channel diameter scaffolds, suggesting that biophysical properties of scaffolds alone, such as channel diameter, enable and affect biomineralization, without delivery of growth factors or cells.

FIG. 30A-FIG. 30I are a set of images and a bar graph of analysis showing periodontal bone regeneration in a large animal (dog) model by biomaterial scaffold.

FIG. 30A is a photograph of periodontal bone defects (5×7 mm) created in dog mandible. Scale bar: 5 mm.

FIG. 30B is a photograph of biphasic calcium phosphate (proprietary formulation) particulates placed in defects. Scale bar: 5 mm.

FIG. 30C is a photograph of primary closure following placing the BCP particulates.

FIG. 30D is a photograph of the regenerated bone completely filling the defect.

FIG. 30E is a representative μCT scan showing mineralized bone (green), remaining graft material undergoing degradation (yellow) and soft tissues (bone marrow and gingiva (red).

FIG. 30F shows a histologic image showing trabecular bone formation with bone marrow, which is critical for long-term homeostasis of regenerated bone. Scale bar: 500 μm.

FIG. 30G shows a histologic image showing trabecular bone formation with bone marrow, which is critical for long-term homeostasis of regenerated bone. Scale bar: 250 μm.

FIG. 30H shows a histologic image showing trabecular bone formation with bone marrow, which is critical for long-term homeostasis of regenerated bone. Scale bar: 200 μm.

FIG. 30I is a graphical representation of the analysis of the μCT scans.

### DETAILED DESCRIPTION

The present invention is based in part on the surprising discovery that a tooth-shaped or a tooth root shaped scaffold, when implanted into a tooth socket, will attract or recruit cells that colonize the scaffold to provide a living tooth, even without exogenously providing cells with the scaffold.

Scaffold

In some embodiments, an acellular mammalian tooth-shaped (e.g., whole tooth-shaped, tooth root-shaped) scaffold is provided. A tooth-shaped scaffold (see e.g., Example 4) can serve as an alternative to or replacement of titanium dental implants. The tooth-shaped scaffold (e.g., Bio-Root) can be produced by 3D printing scaffolds, with or without small molecules or stem/progenitor cell fractions. As described herein, an off-the-shelf regenerative product was developed for clinical applications that can translate tissue engineering into dental therapeutics that benefit millions of patients with missing teeth.

As used herein, a “scaffold” is a structure that provides a matrix material for the growth of cells or the formation of tissue. Useful properties of a scaffold can be porosity, biocompatibility, biodegradability, the ability to support cell growth, or its use as a controlled gene- or protein-delivery vehicle (Murphy 1999). The three-dimensional macromolecular structure provided by the scaffold can be to guide the final shape of bioengineered tissues (Murphy 1999).

The scaffolds of these embodiments can have the shape of any mammalian tooth. In some of these embodiments, the scaffold has the shape of a human incisor, a human cuspid, a human bicuspid, or a human molar.

In some embodiments, the scaffold can be a multiphase scaffold. For example, the multiphase scaffold can mimic multiphase periodontium tissues. As described herein, the multiphase scaffold can have two or more microstructures, three or more microstructures, or four or more microstructures.

In some embodiments, the scaffold microstructure can mimic periodontal tissue. For example, the scaffold microstructure can mimic dentin, cementum, PDL, or alveolar bone.

The scaffolds of these embodiments can be fabricated with any material recognized as useful by the skilled artisan. Suitable matrix materials are discussed in, for example, Ma and Elisseeff, ed. (2005) Scaffolding in Tissue Engineering, CRC, ISBN 1574445219; Saltzman (2004) Tissue Engineering: Engineering Principles for the Design of Replacement Organs and Tissues, Oxford ISBN 019514130X. Nonlimiting examples of potentially useful materials for all or part of the scaffold include poly(ethylene) glycol, poly(lactide), poly(glycolic acid), poly(lactide-co-glycolide), poly(caprolactone), polyanhydride, polyglactin, polycarbonates, polyamides, polyanhydrides, polyamino acids, polyortho esters, polyacetals, polycyanoacrylates), polyphosphazene, degradable polyurethanes, polyacrylates, ethylene-vinyl acetate polymers and other acyl substituted cellulose acetates and derivatives thereof, polyurethanes, polystyrenes, polyvinyl chloride, polyvinyl fluoride, polyvinyl pyrrolidone, poly(vinylimidazole), chlorosulphonated polyolifins, polyethylene oxide, polyvinyl alcohol, teflon®, nylon, agarose, alginate (e.g., calcium alginate gel), fibrin, fibrinogen, fibronectin, collagen (e.g., a collagen gel), gelatin, hyaluronic acid, chitin, and other suitable polymers and biopolymers, or analogs, mixtures, combinations, and derivatives of the above.

In some embodiments, the scaffold can be fabricated from a composition that comprises an osteoconductive material. A nonlimiting example of an osteoconductive material is hydroxyapatite (HA). HA has been used as a bone substitute for many years because of its excellent biocompatibility and high bioactivity.

In other embodiments, the scaffold can be fabricated from a composition that comprises an osteoconductive material. As discussed above, an example of a useful osteoconductive material can be hydroxyapatite. A further example is a mixture of ε-polycaprolactone and hydroxyapatite as discussed above.

Although HA has good bioactivity and osteoconductivity, it can be very brittle and has poor inherent tensile properties. Therefore, in some embodiments, the HA can be combined with ε-polycaprolactone (PCL). PCL can be a good bone scaffold material because it takes several years to degrade in vivo and is biocompatible, relatively inexpensive, and available in large quantities (Rich 2002, Kim 2004). The combination of PCL and HA (PCL-HA) provides a desirable combination of bioactivity, biodegradability, and strength. The material of composite PCL-HA has been deemed to possess the optimal scaffold properties of biocompatibility, cell-adhesion, proliferation, and differentiation (Zhao 2008). In some embodiments, the scaffold comprises a mixture of about 80 wt % polycaprolactone and about 20 wt % hydroxyapatite. In other embodiments, the scaffold comprises anywhere from about 60 wt % polycaprolactone and about 40 wt % hydroxyapatite to about 95 wt % polycaprolactone and about 5 wt % hydroxyapatite. For example, the scaffold can comprise about 70 wt % polycaprolactone and about 30 wt % hydroxyapatite. As another example, the scaffold can comprise about 90 wt % polycaprolactone and about 10 wt % hydroxyapatite.

In various embodiments, the scaffold further comprises a nonporous cap. Such a cap provides further strength to the scaffold and prevents infection. The nonporous cap can be simply the same material of the rest of the scaffold except without pores. Alternatively, the nonporous cap can be a different material, e.g., typical dental cap material, such as porcelain or gold, or a crown.

Several methods can be used for fabrication of porous scaffolds, including particulate leaching, gas foaming, electrospinning, freeze drying, foaming of ceramic from slurry, and the formation of polymeric sponge. However, scaffolds prepared by using these methods have some shortcomings in controlling the structure and interconnectivity of pores, which may limit their application in terms of cell penetration in tissue engineering.

In some embodiments, the methods further comprise making a model of the absent tooth by computer aided design (CAD) and synthesizing the scaffold with a bioplotter. Such methods can provide scaffolds with high porosity and good interconnectivity. As described in the Examples, three-dimensional (3D) scaffolds with controllable and reproducible porosity and well-defined 3D microstructures can be made. Rapid prototyping (RP) methods such as fused deposition modeling, selective laser sintering, 3D printing, multiphase jet solidification, and 3D plotting have been proposed

A key feature of rapid prototyping is the solid freeform fabrication (SFF) process: 3D computer models can be cut into sequences of layers which can be used to construct complex objects layer-by-layer. The layers can be produced via solidification of melts, layer photopolymerization or bonding of particles using either laser beam induced sintering (selective laser sintering) or special binders. Recently, a specialized rapid prototyping system (Bioplotter™, EnvisionTec, Germany) has been introduced, enabling the design and fabrication of anatomically shaped scaffolds with varying internal architectures, thereby allowing precise control over pore size, porosity, permeability, and stiffness. The prototyping process using the Bioplotter™ for fabricating a tissue-specific PCL-HA scaffold requires 3D morphological information of the target tissue or tissue defect, which can be obtained by computer tomography (CT) or magnetic resonance imaging (MRI). When an absent tooth has a counterpart on the other side of the mouth, that counterpart can be used as a model to design the scaffold for the missing tooth.

Information obtained above can then be used to design a functional scaffold by CAD and is transferred to the Bioplotter™ system. In that system, the Bioplotter™ machine melts and dispenses the scaffold material (e.g., PCL-HA) in layer-by-layer on a collecting plate. Pores, for example microchannels, can be created as part of the design. The fabricated 3D scaffolds through the RP system result in significant cell penetration, and thus possess the properties of ideal scaffolds (Heo 2007). These 3D scaffolds may have potential for clinical application by providing patient tissue-specific anatomical shape as well as an optimized internal microstructure for the nutrient transportation and vascularization. Further details of these methods are provided in PCT Publication WO2009006558, incorporated by reference.

A method of making a tooth scaffold is additionally provided. The method comprises synthesizing an acellular scaffold in the shape of a mammalian tooth and adding at least one composition that is chemotactic, osteogenic, dentinogenic, amelogenic, or cementogenic. In some embodiments of these methods, the tooth can be shaped like a tooth that is absent in a mammal, and the method further comprises making a model of an absent tooth by computer aided design (CAD), and synthesizing the scaffold with a bioplotter. Where the absent tooth has a counterpart in the mouth, e.g., a molar, the method further comprises making a CT scan of the analogous molar, for example on the other side of the mouth, where the CAD utilizes CT scan data of the second molar to design the scaffold.

Pores and Microchannels

In some embodiments, the scaffold has a high porosity. Such a porous structure provides space for cell migration, adhesion, and the ingrowth of new bone tissue.

In various embodiments of these methods, the scaffold comprises microchannels having a diameter of between 50 and 500 μm. In additional embodiments, the scaffold further comprises a nonporous cap.

Pores and channels of the scaffold can be engineered to be of various diameters. For example, the pores of the scaffold can have a diameter range from micrometers to millimeters. In some embodiments, the pores of the matrix material include microchannels. Microchannels generally have an average diameter of about 0.1 μm to about 1,000 μm, e.g., about 50 μm to about 500 μm (for example about 100 μm, 150 μm, about 200 μm, about 250 μm, about 300 μm, about 350 μm, about 400 μm, about 450 μm, about 500 μm, or about 550 μm). It is understood that recitation of the above discrete values includes a range between each recited value. One skilled in the art will understand that the distribution of microchannel diameters can have any distribution including a normal distribution or a non-normal distribution. In some embodiments, microchannels can be a naturally occurring feature of the matrix material(s). In other embodiments, microchannels can be engineered to occur in the matrix materials.

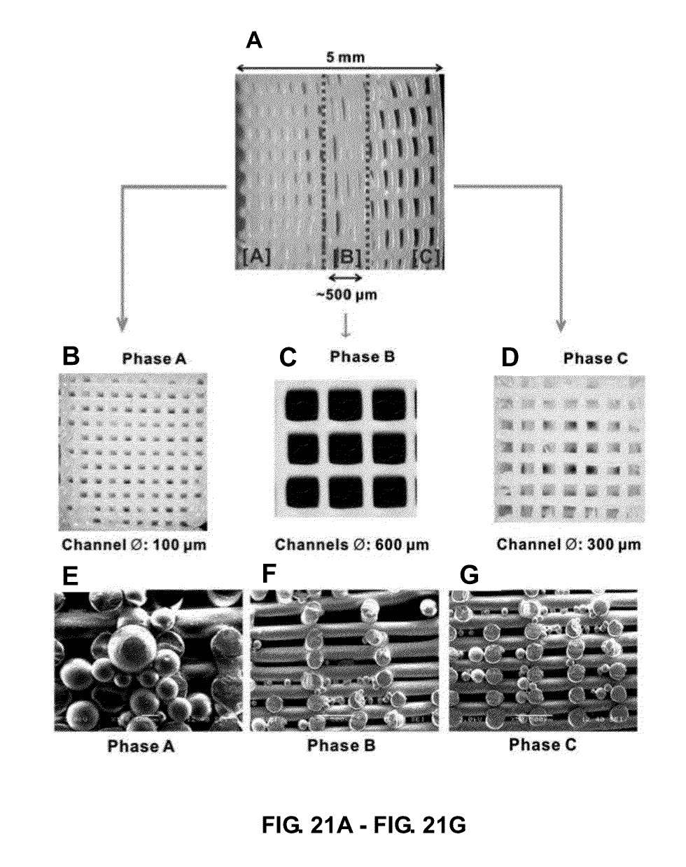

In some embodiments, the microchannel can be, for example, about 0.1 μm to about 1000 μm. For example, the microchannel can be about 0.1 μm, about 10 μm, about 20 μm, about 30 μm, about 40 μm, about 50 μm, about 60 μm, about 70 μm, about 80 μm, about 90 μm, about 100 μm, about 110 μm, about 120 μm, about 130 μm, about 140 μm, about 150 μm, about 160 μm, about 170 μm, about 180 μm, about 190 μm, about 200 μm, about 210 μm, about 220 μm, about 230 μm, about 240 μm, about 250 μm, about 260 μm, about 270 μm, about 280 μm, about 290 μm, about 300 μm, about 310 μm, about 320 μm, about 330 μm, about 340 μm, about 350 μm, about 360 μm, about 370 μm, about 380 μm, about 390 μm, about 400 μm, about 410 μm, about 420 μm, about 430 μm, about 440 μm, about 450 μm, about 460 μm, about 470 μm, about 480 μm, about 490 μm, about 500 μm, about 510 μm, about 520 μm, about 530 μm, about 540 μm, about 550 μm, about 560 μm, about 570 μm, about 580 μm, about 590 μm, about 600 μm, about 610 μm, about 620 μm, about 630 μm, about 640 μm, about 650 μm, about 660 μm, about 670 μm, about 680 μm, about 690 μm, about 700 μm, about 710 μm, about 720 μm, about 730 μm, about 740 μm, about 750 μm, about 760 μm, about 770 μm, about 780 μm, about 790 μm, about 800 μm, about 810 μm, about 820 μm, about 830 μm, about 840 μm, about 850 μm, about 860 μm, about 870 μm, about 880 μm, about 890 μm, about 900 μm, about 910 μm, about 920 μm, about 930 μm, about 940 μm, about 950 μm, about 960 μm, about 970 μm, about 980 μm, about 990 μm, about 900 μm, about 910 μm, about 920 μm, about 930 μm, about 940 μm, about 950 μm, about 960 μm, about 970 μm, about 980 μm, about 990 μm, or about 1000 μm. It is understood that recitation of the above discrete values includes a range between each recited value. One skilled in the art will understand that the distribution of transverse microchannel lengths can have any distribution including a normal distribution or a non-normal distribution. For example, a microchannel can have a transverse length of about 100 μm, about 300 μm, or 600 μm (see e.g., FIG. 21, Example 3).

In some embodiments, the microchannel width or diameter can be, for example, about 10 μm to about 5000 μm. For example, the microchannel width or diameter can be about about 10 μm, about 50 μm, about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, about 1000 μm, about 1050 μm, about 1100 μm, about 1150 μm, about 1200 μm, about 1250 μm, about 1300 μm, about 1350 μm, about 1400 μm, about 1450 μm, about 1500 μm, about 1550 μm, about 1600 μm, about 1650 μm, about 1700 μm, about 1750 μm, about 1800 μm, about 1850 μm, about 1900 μm, about 1950 μm, about 2000 μm, about 2050 μm, about 2100 μm, about 2150 μm, about 2200 μm, about 2250 μm, about 2300 μm, about 2350 μm, about 2400 μm, about 2450 μm, about 2500 μm, about 2550 μm, about 2600 μm, about 2650 μm, about 2700 μm, about 2750 μm, about 2800 μm, about 2850 μm, about 2900 μm, about 2950 μm, about 3000 μm, about 3050 μm, about 3100 μm, about 3150 μm, about 3200 μm, about 3250 μm, about 3300 μm, about 3350 μm, about 3400 μm, about 3450 μm, about 3500 μm, about 3550 μm, about 3600 μm, about 3650 μm, about 3700 μm, about 3750 μm, about 3800 μm, about 3850 μm, about 3900 μm, about 3950 μm, about 4000 μm, about 4050 μm, about 4100 μm, about 4150 μm, about 4200 μm, about 4250 μm, about 4300 μm, about 4350 μm, about 4400 μm, about 4450 μm, about 4500 μm, about 4550 μm, about 4600 μm, about 4650 μm, about 4700 μm, about 4750 μm, about 4800 μm, about 4850 μm, about 4900 μm, about 4950 μm, or about 5000 μm. It is understood that recitation of the above discrete values includes a range between each recited value. One skilled in the art will understand that the distribution of microchannel width or diameter can have any distribution including a normal distribution or a non-normal distribution. For example, a microchannel width can be about 200-700 μm, about 500 μm, 2250 μm, or about 2500 μm (see e.g., FIG. 21, Example 3).

Where the scaffold is a multiphase scaffold, each phase can have a different microchannel mean diameter. The microchannel mean diameter of a phase can be independently selected from any value or range described above. A scaffold can have a first phase optimized for regeneration of cementum. Exemplary microchannel mean diameter of such first phase can be about 50 μm to about 200 μm (e.g., 100 μm). A scaffold can have a second phase optimized for regeneration of periodontal ligament (PDL). Exemplary microchannel mean diameter of such second phase can be about 200 μm to about 700 μm (e.g., 600 μm). A scaffold can have a third phase optimized for regeneration of alveolar bone. Exemplary microchannel mean diameter of such third phase can be about 200 μm to about 400 μm (e.g., 300 μm).

Compositions

The scaffold, as described herein, can comprise a composition that is chemotactic, osteogenic, dentinogenic, amelogenic, or cementogenic. These scaffolds can be thus implanted without exogenously applied cells. As established in the examples, colonization of the implanted scaffolds proceeds adequately by native cells that migrate into the scaffold. The colonization can be further encouraged by the chemotactic, osteogenic, dentinogenic, amelogenic, or cementogenic composition incorporated into the scaffold.

A composition can be of any structure including but not limited to a protein, oligopeptide, small organic molecule (i.e., less than about 2000 mw, or about 1000 mw or about 500 mw), metal ion-containing molecule, carbohydrate, or lipid. As used herein, a chemotactic composition can be a composition that attracts cells. An osteogenic composition can be a composition that encourages new bone synthesis. A dentinogenic composition can be a composition that encourages new dentin synthesis. An amelogenic composition can be a composition that encourages tooth enamel synthesis. A cementogenic composition can be a composition that encourages cementum synthesis.

In some embodiments of the methods and constructs, as described herein, a composition can be platelet-derived growth factor (PDGF), endothelial cell growth factor (ECGF), transforming growth factor-β1 (TGF-β1), epidermal growth factor (EGF), hepatocyte growth factor (HGF), stromal cell-derived factor-1 (SDF1), a bone morphogenetic protein (BMP), a TGF-β, a growth and differentiation factor (GDF), insulin-like growth factor-1 (IGF1), vascular endothelial growth factor (VEGF), fibroblast growth factor (FGF), a dentin matrix protein, a dentin sialoprotein, a bone sialoprotein, amelogenin, or an integrin.

A composition in these embodiments can be any composition that is chemotactic, osteogenic, dentinogenic, amelogenic, or cementogenic. Nonlimiting examples include connective tissue growth factor (CTGF), platelet-derived growth factor (PDGF), endothelial cell growth factor (ECGF), transforming growth factor-β1(TGF-β1), epidermal growth factor (EGF), hepatocyte growth factor (HGF), stromal cell-derived factor-1 (SDF1), a bone morphogenetic protein (BMP), bone morphogenic protein 2 (BMP2), a TGF-β, a growth and differentiation factor (GDF), insulin-like growth factor-1 (IGF1), vascular endothelial growth factor (VEGF), fibroblast growth factor (FGF), a dentin matrix protein, a dentin sialoprotein, a bone sialoprotein, amelogenin, or an integrin.

In some embodiments, the composition can be SDF1, which has chemotactic properties. SDF1 is a chemokine that is believed to be essential in stem and progenitor cell recruitment for tissue repair after injury (Kollet 2003). SDF1 can also induce migration of hematopoietic progenitor cells within a chemotaxis chamber (Kim 1998). Additionally, SDF1 is important for the migration of marrow stromal cells to bone marrow, as shown by the dose-dependent migration of mesenchymal stem cells (MSCs) in response to stimulation with SDF1 (Win 2004). SDF1 also has anti-apoptotic properties, protecting hematopoietic stem cells directly from the apoptotic effects of γ-irradiation in the presence of other growth factors (Herodin 2003). Further, mesenchymal stem cells (MSCs) derived from bone marrow can be directed to migrate toward SDF1 (Schantz 2007).

In other embodiments, the composition can be a BMP. BMP2, 6, and 9 were shown to be the most potent agents for osteogenic differentiation of MSCs, while the rest of the BMPs are more effective in promoting the terminal differentiation of committed osteoblastic precursors and osteoblasts (Cheng 2003).

In some aspects of these embodiments, the BMP can be BMP-7. BMP-7 plays a key role in the transformation of mesenchymal cells into bone and cartilage. BMP-7 treatment can be sufficient to induce all of the genetic markers of osteoblast differentiation in various cell types (Chen 2004). It is noted that BMP-7 has received Food and Drug Administration (FDA) approval for human clinical uses.

Many studies have investigated the role and action of exogenous growth factors in a carrier to deliver the growth factor to an implantation site. Although the carrier may not contribute any additional factors necessary for tissue formation, it can still be an important component of the growth process (Wozney 1990). One of the carrier functions can be to maintain the factor at the site of implantation and thus enhance its local concentration. The carrier also serves as an environment in which tissue can form and therefore helps to define the region in which new tissue can be formed (Whang 1998). Collagenous or synthetic carriers have been used as delivery vehicles, and their physicochemical properties, together with the microenvironment they create, play a role in the inductive outcome. Carriers can be solid xenogenic (e.g., hydroxyapatite) (Kuboki 1995, Murata 1998), solid alloplastic (polyethylene polymers) materials (Saito 1998, Isobe 1999), or gels of autogenous (Sweeney 1995, Schwartz 1998), allogenic (Bax 1999, Viljanen 1997), or alloplastic origin (Santos 1998), and combinations of the above (Alpaslan 1996).

One of the carrier functions can be to maintain the factor at the site of implantation and thus enhance its local concentration. A collagen matrix retains up to 65% of BMPs during initial impregnation and releases it in two phases: an initial phase within hours of implantation and a second phase that depends on the nature of the carrier and its geometrical characteristics (Uludag 1999). It is believed that BMPs do not bind to the carrier (Uludag 1999), but rather become physically entrapped in its structure which makes certain designs more favorable for osteoinduction over others (Tsuruga 1997). In the case of collagen sponge carriers, mass, collagen cross-linking and sterilization methods affect BMP precipitation and subsequent resistance of sponge degradation by collagenase (Friess 1999). A collagen carrier can also result in increased bone density of the regenerate compared to the polymeric matrix (Cochran 1997).

BMP-7 plays a key role in the transformation of mesenchymal cells into bone and cartilage. BMP-7 treatment is sufficient to induce all of the genetic markers of osteoblast differentiation in various cell types (Chen 2004). It is also worthwhile to note that BMP-7 has received the Food and Drug Administration (FDA) approval for human clinical uses.

In some of these scaffolds, a chemotactic growth factor as well as a growth factor that is osteogenic, dentinogenic, amelogenic, or cementogenic can be present. In particular embodiments, the chemotactic growth factor can be SDF1 and the osteogenic, dentinogenic, amelogenic, or cementogenic growth factor can be BMP-7.

The scaffolds of these embodiments can further comprise any other bioactive molecule, for example an antibiotic or an additional chemotactic growth factor or another osteogenic, dentinogenic, amelogenic, or cementogenic growth factor. In some embodiments, the scaffold can be strengthened, through the addition of, e.g., human serum albumin (HSA), hydroxyethyl starch, dextran, or combinations thereof. Suitable concentrations of these compositions for use in the compositions of the application are known to those of skill in the art, or can be readily ascertained without undue experimentation.

The concentration of composition in the scaffold will vary with the nature of the composition, its physiological role, and desired therapeutic or diagnostic effect. A therapeutically effective amount can be generally a sufficient concentration of therapeutic agent to display the desired effect without undue toxicity. In some embodiments, the scaffold comprises BMP-7 in the scaffold at about 10 ng/g to 1000 μg/g scaffold and SDF1 in the scaffold at about 10 ng/g to 1000 μg/g scaffold. In more specific embodiments, the BMP-7 can be in the scaffold at about 100 μg/g scaffold and the SDF1 can be in the scaffold at about 100 μg/g scaffold.

Composition Delivery

A composition comprising one or more compositions can be incorporated into the scaffold by any known method. In some embodiments, the composition is imbedded in a gel, e.g., a collagen gel incorporated into the pores of the scaffold, as described in the Example.

Alternatively, chemical modification methods may be used to covalently link a composition on a surface of the scaffold. The surface functional groups of the scaffold can be coupled with reactive functional groups of the composition to form covalent bonds using coupling agents well known in the art such as aldehyde compositions, carbodiimides, or the like. Additionally, a spacer molecule can be used to gap the surface reactive groups and the reactive groups of the biomolecules to allow more flexibility of such molecules on the surface of the matrix. Other similar methods of attaching biomolecules to the interior or exterior of a matrix will be known to one of skill in the art.

The composition can alternatively be introduced into or onto the matrix via a carrier based system, such as an encapsulation vehicle. Such vehicles can be useful as slow release compositions. For example, growth factors can be micro-encapsulated to provide for enhanced stability or prolonged delivery. Encapsulation vehicles include, but are not limited to, microparticles, liposomes, microspheres, or the like, or a combination of any of the above to provide the desired release profile in varying proportions. Other methods of controlled-release delivery of agents will be known to the skilled artisan. Moreover, these and other systems can be combined or modified to optimize the integration/release of agents within the matrix.

Polymeric microspheres can be produced using naturally occurring or synthetic polymers and can be particulate systems in the size range of 0.1 to 500 μm. Polymeric micelles and polymeromes can be polymeric delivery vehicles with similar characteristics to microspheres and can also facilitate encapsulation and matrix integration of the compositions described herein. Fabrication, encapsulation, and stabilization of microspheres for a variety of payloads are within the skill of the art (see e.g., Varde & Pack (2004) Expert Opin. Biol. 4(1) 35-51). The release rate of the microspheres can be tailored by type of polymer, polymer molecular weight, copolymer composition, excipients added to the microsphere formulation, and microsphere size. Polymer materials useful for forming microspheres include PLA, PLGA, PLGA coated with DPPC, DPPC, DSPC, EVAc, gelatin, albumin, chitosan, dextran, DL-PLG, SDLMs, PEG (e.g., ProMaxx), sodium hyaluronate, diketopiperazine derivatives (e.g., Technosphere), calcium phosphate-PEG particles, or oligosaccharide derivative DPPG (e.g., Solidose). Encapsulation can be accomplished, for example, using a water/oil single emulsion method, a water-oil-water double emulsion method, or lyophilization. Several commercial encapsulation technologies are available (e.g., ProLease®, Alkerme).

Liposomes can also be used to integrate compositions with the scaffolds. The agent carrying capacity and release rate of liposomes can depend on the lipid composition, size, charge, drug/lipid ratio, and method of delivery. Conventional liposomes can be composed of neutral or anionic lipids (natural or synthetic). Commonly used lipids are lecithins such as phosphatidylcholines, phosphatidylethanolamines, sphingomyelins, phosphatidylserines, phosphatidylglycerols, and phosphatidylinositols. Liposome encapsulation methods are commonly known in the arts (Galovic et al. (2002) Eur. J. Pharm. Sci. 15, 441-448; Wagner et al. (2002) J. Liposome Res. 12, 259-270). Targeted liposomes and reactive liposomes can also be used in combination with the agents and matrix. Targeted liposomes have targeting ligands, such as monoclonal antibodies or lectins, attached to their surface, allowing interaction with specific receptors or cell types. Reactive or polymorphic liposomes include a wide range of liposomes, the common property of which is their tendency to change their phase and structure upon a particular interaction (e.g., pH-sensitive liposomes). See, e.g., Lasic (1997) Liposomes in Gene Delivery, CRC Press, FL).

In some embodiments, the composition can be imbedded in a gel in the microchannels. Any gel can be used for this purpose. In some embodiments, the gel can be a collagen gel.

Tooth Replacement or Implant

Methods of replacing a tooth in the mouth of a mammal are also provided herein. In these embodiments, the tooth can be absent and a tooth socket can be present in the mouth at the position of the absent tooth. The methods can include implanting an acellular scaffold described herein having the same or similar shape of the missing tooth into the tooth socket.

Progenitor Cells

In some embodiments, dental stem/progenitor cells from various anatomical entities can be used for the regeneration of tooth or periodontal tissues. Cotransplantation of embryonic tooth germ cells in collagen gel in an extraction socket can lead to tooth morphogenesis, followed by eruption. For example, postnatal dental stem/progenitor cells can include DPSCs, PDLSCs, and ABSCs. DPSCs, PDLSCs, and ABSCs can have potential for regenerating multiple periodontal tissues. Postnatal dental stem/progenitor cells, despite their inability to generate complete tooth organs, can retain the potency to differentiate into fibroblastic lineages and into mineralized tissues that express dentin-like and bone-like markers. Some dental stem/progenitor cells can be present in tooth extraction sockets (e.g., PDLSCs and ABSCs) or can be readily isolated from dental tissues without undue trauma to the patient (e.g., PDLSCs and DPSCs). Host endogenous PDL cells or alveolar bone cells, including PDLSCs and ABSCs, can be recruited into scaffolds and instructed for regenerating periodontal tissues. Recruitment and directed differentiation of host endogenous cells can circumvent some of cell delivery-related translational hurdles.

As described herein, orthotopic regeneration in the same biochemical/physical environment as the native tissue that is to be replaced, can further improve the quality and functionality of regenerating root and periodontal tissues. Together, multiphase periodontium tissues can regenerate by spatiotemporal delivery of multiple proteins and multiphase microstructure. A single stem/progenitor cell population can differentiate into putative dentin/cementum, PDL, or alveolar bone complex by the scaffold's biophysical properties and specific bioactive cues. Optimal combination of microstructure and bioactive cues in consideration of a target cell type can lead to desirable periodontal tissues regeneration.

Kits

Also provided are kits. Such kits can include an agent or composition described herein and, in certain embodiments, instructions for administration. Such kits can facilitate performance of the methods described herein. When supplied as a kit, the different components of the composition can be packaged in separate containers and admixed immediately before use. Components include, but are not limited to a tooth scaffold or protein cue, optionally in a delivery vehicle such as a microsphere. Such packaging of the components separately can, if desired, be presented in a pack or dispenser device which may contain one or more unit dosage forms containing the composition. The pack may, for example, comprise metal or plastic foil such as a blister pack. Such packaging of the components separately can also, in certain instances, permit long-term storage without losing activity of the components.

Kits may also include reagents in separate containers such as, for example, sterile water or saline to be added to a lyophilized active component packaged separately. For example, sealed glass ampules may contain a lyophilized component and in a separate ampule, sterile water, sterile saline or sterile each of which has been packaged under a neutral non-reacting gas, such as nitrogen. Ampules may consist of any suitable material, such as glass, organic polymers, such as polycarbonate, polystyrene, ceramic, metal or any other material typically employed to hold reagents. Other examples of suitable containers include bottles that may be fabricated from similar substances as ampules, and envelopes that may consist of foil-lined interiors, such as aluminum or an alloy. Other containers include test tubes, vials, flasks, bottles, syringes, and the like. Containers may have a sterile access port, such as a bottle having a stopper that can be pierced by a hypodermic injection needle. Other containers may have two compartments that are separated by a readily removable membrane that upon removal permits the components to mix. Removable membranes may be glass, plastic, rubber, and the like.

In certain embodiments, kits can be supplied with instructional materials. Instructions may be printed on paper or other substrate, or may be supplied as an electronic-readable medium, such as a floppy disc, mini-CD-ROM, CD-ROM, DVD-ROM, Zip disc, videotape, audio tape, and the like. Detailed instructions may not be physically associated with the kit; instead, a user may be directed to an Internet web site specified by the manufacturer or distributor of the kit.

In some embodiments, numbers expressing quantities of ingredients, properties such as molecular weight, reaction conditions, and so forth, used to describe and claim certain embodiments of the invention are to be understood as being modified in some instances by the term “about.” In some embodiments, the term “about” is used to indicate that a value includes the standard deviation of the mean for the device or method being employed to determine the value. In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. The recitation of ranges of values herein is merely intended to serve as a shorthand method of referring individually to each separate value falling within the range. Unless otherwise indicated herein, each individual value is incorporated into the specification as if it were individually recited herein.

In some embodiments, the terms “a” and “an” and “the” and similar references used in the context of describing a particular embodiment (especially in the context of certain of the following claims) can be construed to cover both the singular and the plural, unless specifically noted otherwise. In some embodiments, the term “or” as used herein, including the claims, is used to mean “and/or” unless explicitly indicated to refer to alternatives only or the alternatives are mutually exclusive.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

Citation of a reference herein shall not be construed as an admission that such is prior art to the present invention.

Having described the invention in detail, it will be apparent that modifications, variations, and equivalent embodiments are possible without departing the scope of the invention defined in the appended claims. Furthermore, it should be appreciated that all examples in the present disclosure are provided as non-limiting examples.

### EXAMPLES

The following non-limiting examples are provided to further illustrate the present invention. It should be appreciated by those of skill in the art that the techniques disclosed in the examples that follow represent approaches the inventors have found function well in the practice of the invention, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the invention.

### Example 1

### Regeneration of Anatomically Correct Tooth by Cell Homing

One of the fundamental missions of dentistry is the restoration of diseased, missing and lost dental structures. Currently, conventional treatment of tooth loss includes prosthodontic management with or without surgically placed dental implants. Dental implants, despite their reported high success rates, are not without complications such as loosening, infection, and bone loss. Recently, there has been a common aspiration among practitioners and scientists that separate tooth structures or an entire tooth can be regenerated using biomedical engineering cues. This emerging area, however, has encountered several obstacles, not the least of which is the complexity of regeneration and the morphology of tooth structures. The present study proposes to establish the regeneration of an entire tooth organ with bioengineered tooth scaffolds and by delivery of growth factors known to be important in tooth development. Full size human tooth scaffolds were first fabricated by rapid prototyping with layer deposition of hybrid of ε-polycaprolactone and hydroxyapatite (PCL-HA) using the Bioplotter™ machine. In parallel, scaffolds in the shape of mandibular central incisor root of Sprague Dawley rats were also constructed in 3D. The scaffolds were then infused with stromal cell derived factor-1 (SDF1) and bone morphogenetic protein 7 (BMP-7). There were 22 Sprague Dawley rats—11 each in the test and control groups. In each of the rats, a human mandibular molar shaped scaffold was subcutaneously implanted in the dorsum site, and a rat mandibular incisor root shaped scaffold was implanted into the extraction socket after surgical extraction of one of the two mandibular central incisors. The test group scaffolds were impregnated with SDF1 and BMP-7 while the control group scaffolds contained no growth factors. All implanted scaffolds were harvested at 9-week post-implantation and histologically evaluated for tissue ingrowth, cellular penetration, angiogenesis and mineralization.

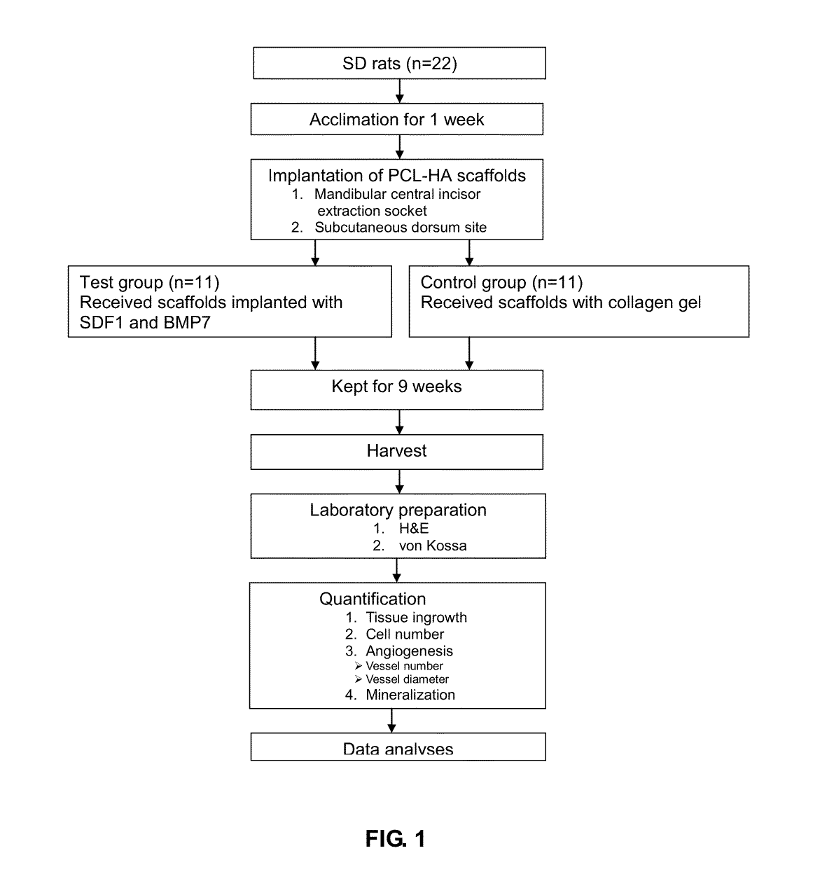

Materials and Methods. This study used the mandibular central incisor extraction sockets and subcutaneous dorsum sites of twelve-week old male Sprague Dawley rats (Charles River, N.Y.). All sites received PCL-HA scaffolds. There were a total of twenty-two SD rats randomly divided into two groups of eleven rats in each of two groups: a test group and a control group. As shown in FIG. 1, each rat was given an identification number—#1 to #11, and #12 to #22—test and control groups, respectively. The rats were maintained in pairs during the one-week acclimation period after purchase, in a twelve-hour light/dark cycle and were fed rat chow (Rodent Laboratory Chow 5001, Ormond Veterinary Supply, Ontario, Canada) and water ad labium before the surgical procedures for scaffold implantation. Table 1 summarizes the study groups and number of scaffolds implanted.

TABLE 1
Study groups and number of scaffolds implanted. E = extraction
socket site implantation; D = subcutaneous dorsum implantation.

| | Test | | Control | |
|---|---|---|---|---|
| Total Subject Number | 11 | | 11 | |
| Implantation Sites | E | D | E | D |
| | n = 11 | n = 11 | n = 11 | n = 11 |

Each experimental site per rat—mandibular central incisor extraction socket and subcutaneous dorsum—surgically received one PCL-HA scaffold. The extraction socket site received a scaffold that resembled the root of the mandibular central incisor. The dorsum site received a scaffold that was in the shape of the human mandibular molar. The scaffolds implanted in the test group rats were impregnated with SDF1 and BMP-7, while the control group received the scaffolds with collagen gel only. All rats were kept for nine weeks post-surgery prior to the harvest of scaffolds for laboratory analyses and quantification.

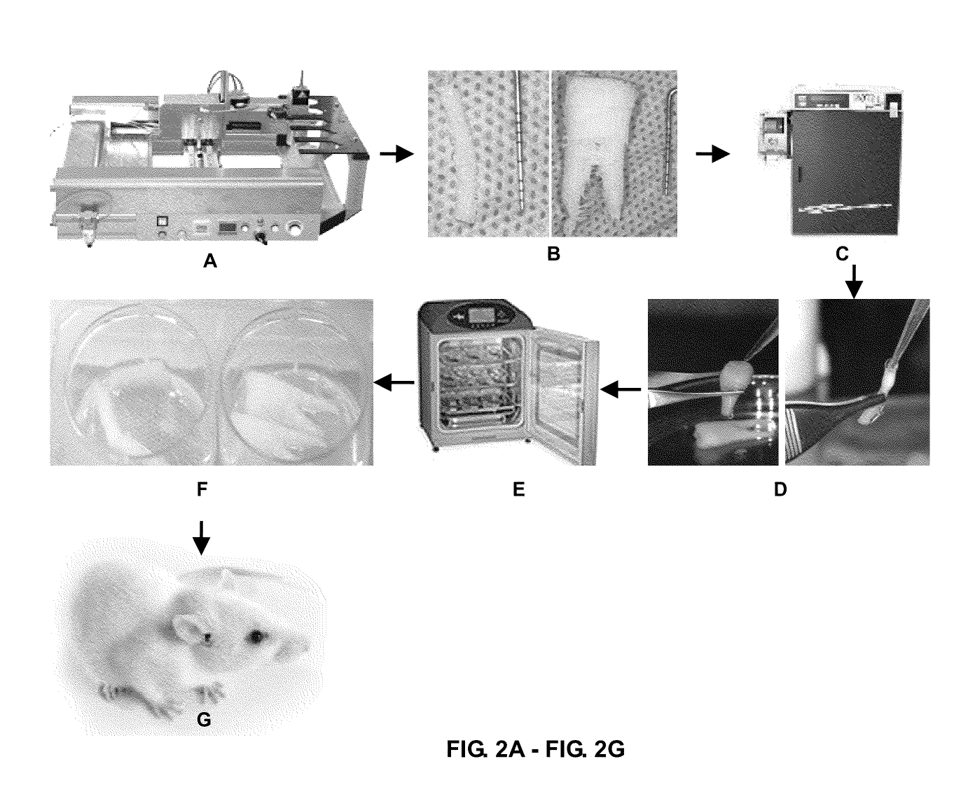

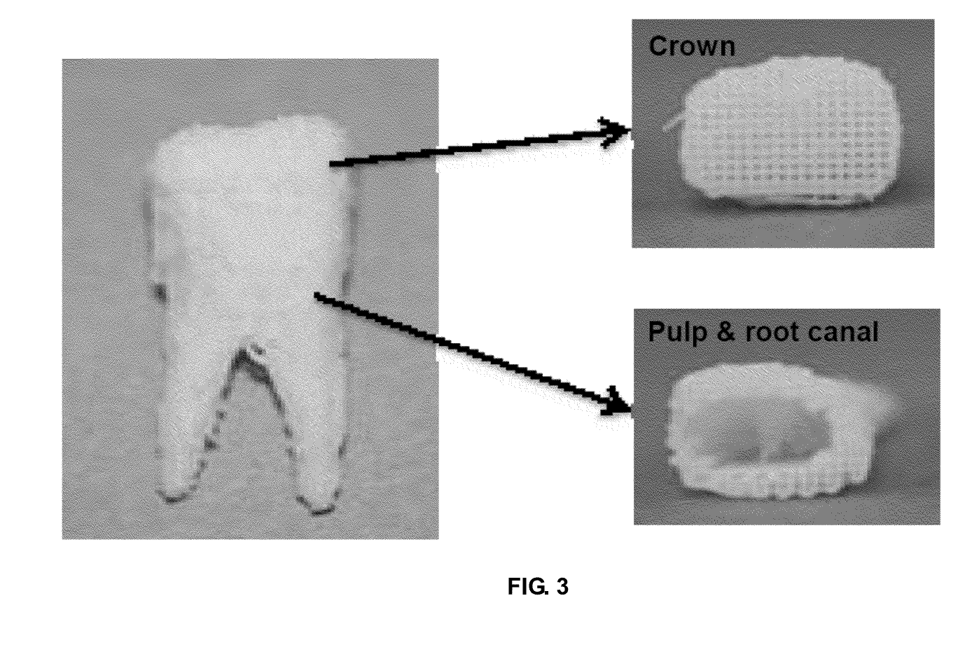

Scaffold preparation. The rat mandibular central incisor root shaped and human mandibular molar shaped PCL-HA scaffolds were fabricated by layer-by-layer deposition using a 3D printing system (Bioplotter™, Envision TEC, Gladbeck, Germany) (see e.g., FIGS. 2A, B). The composite consisted of 80 wt % polycaprolactone (PCL) (Mw ˜65,000, Sigma, St. Louis, Mo.) and 20 wt % of hydroxyapatite (HA) (Sigma, St. Louis, Mo.). PCL-HA was molten in the chamber at 120° C. and dispensed through a 27-gauge metal needle (DL technology, Haverhill, Mass.) to create interlaid strands and interconnected microchannels (see e.g., FIG. 3). The crown and root structures of the human mandibular molar-shaped scaffolds were produced individually and later fused to form the whole tooth due to difficulties encountered in its continuous fabrication as a one piece (see e.g., FIG. 3). All scaffolds included microchannels of 200 μm in diameter created by the interlocking structure of the PCL-HA strands of 200 μm in diameter (see e.g., FIG. 3). The macromolecular 3D structure of the scaffold was meant to contribute to formation of the outer morphology of the final outcome while the internal architecture with microchannels aimed to provide room for cellular occupation and tissue ingrowth. All fabricated scaffolds were sterilized in an ethylene oxide sterilizer for twenty-four hours prior to treatment with collagen gel containing SDF1 and BMP-7 (test group), and collagen gel without a growth factor (control group) (see e.g., FIG. 2C). The treatment of the scaffolds was performed in a laminar flow hood using sterile laboratory techniques.

For the test group, 100 ng/ml stromal cell-derived factor-1 (SDF1) (R&D systems, MN) and 100 ng/ml bone morphogenic protein-7 (BMP-7) (R&D systems, MN) were combined in 2 mg/ml neutralized bovine type I collagen (Cultrex®, R&D Systems, Minneapolis, Minn.). The growth factor-collagen solution was then infused into microchannels in the PCL-HA scaffold and cross-linked for 1 hr in a humidified incubator at 37° C. Collagen gel loaded with SDF1 and BMP-7 was prepared in the mixture of PBS, 10× PBS, NaOH as summarized in Table 2. The dose of SDF1 and BMP-7 were selected based on previous works. Chemotaxis assays have shown that mesenchymal stem cells grow toward an SDF1 stimulus with maximal chemotaxis at a concentration of 100 ng/ml (Schantz 2007). The BMP-7 concentration of 100 ng/ml has been shown to be effective in promoting osteoblast growth on the collagen carrier (Laflamme 2008). The control group scaffolds were not loaded with any growth factor after sterilization. Rather, empty collagen gel was infused into the microchannels in the same manner as described for the test group prior to the surgery.

TABLE 2
Details of the growth factor solution delivered into the
test group scaffolds.

| Contents | Amount (ml) | |
|---|---|---|
| 10X PBS | 1 | |
| 1N NaOH | 0.14 | |
| PBS | 4.86 | |
| Collagen I | 2 | (5 mg/ml) |
| BMP7 | 1 | (100 ng/ml) |
| SDF1 | 1 | (100 ng/ml) |
| Total Volume | 10 | |

Surgical procedures. Twelve-week old Sprague Dawley rats (Charles River, N.Y.) were purchased and were allowed to acclimate for approximately one week. All rats were anesthetized with the cocktail of ketamine (80 mg/kg, IP) and xylazine (5 mg/kg, IP). Depth of anesthesia was monitored during the procedure by toe-pinch; and when required, ketamine (⅓ of full dose: 25 mg/kg, IP) alone was given to maintain anesthesia depth as necessary. A pulse-oximeter device was used during the surgery to monitor the pulse rate and the oxygen saturation level.

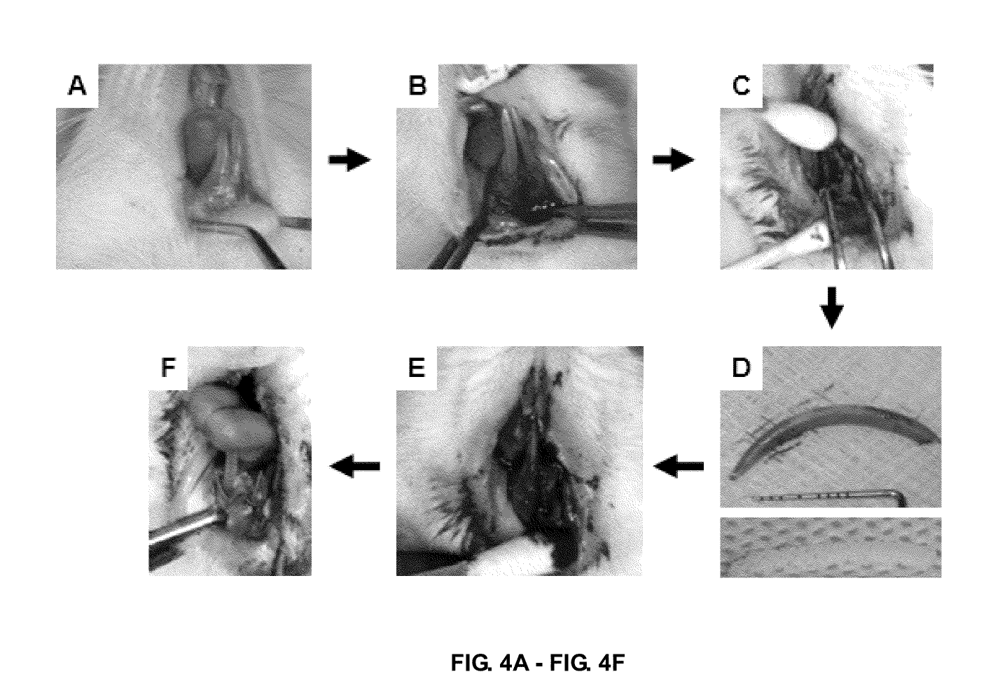

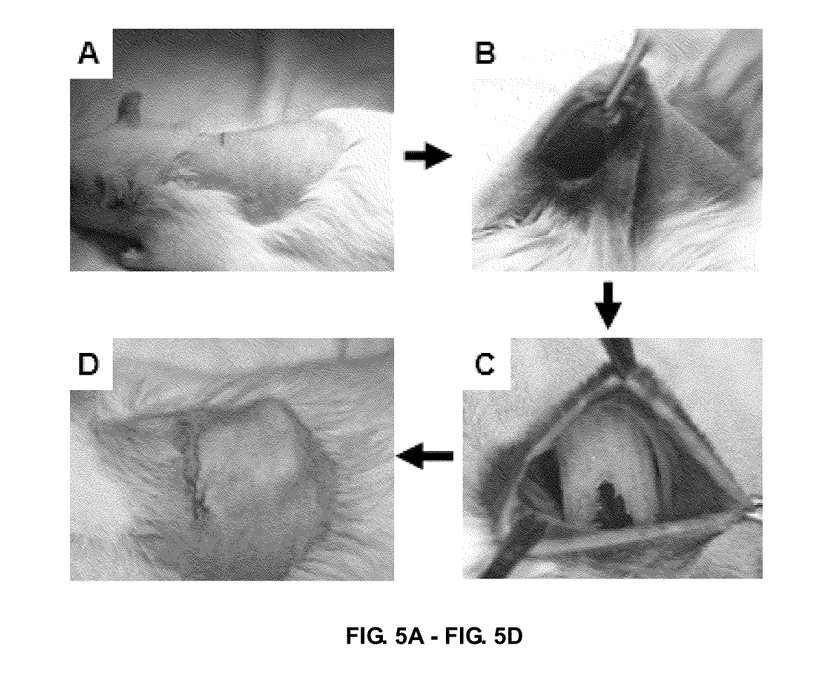

The surgical techniques were identical between the two groups (see e.g., FIG. 4, FIG. 5). Careful, atraumatic surgical extraction of a mandibular central incisor was performed followed by immediate implantation of the root-form scaffold into the extraction socket (see e.g., FIG. 4C, FIG. 4D, FIG. 4E). The extraction procedure was done as atraumatically as possible using periotomes, taking care to preserve the bony walls of the socket (see e.g., FIG. 4C). During the implantation of the construct, care was taken to preserve the labial walls by passive fitting of the construct (see e.g., FIG. 4E). After implantation, the flap was advanced for primary closure and each socket was closed with one or two single-interrupted sutures, using the polyglylactin suture material (Vicryl 5-0, Johnson and Johnson, NJ) (see e.g., FIG. 4F).

At the dorsum site of the same rat, subcutaneous implantation of the prepared human mandibular molar-shaped scaffold was performed (see e.g., FIG. 5). A 2-cm long horizontal incision was placed and the subcutaneous area was relieved and pouched using a sharp surgical scissor (see e.g., FIG. 5B). A human mandibular molar-shaped scaffold was implanted in the pouch created subcutaneously (see e.g., FIG. 5C). The site was closed with polyglylactin suture material (Vicryl 5-0, Johnson and Johnson, NJ) making sure that there was no entrapped air bubble before closure (see e.g., FIG. 5D). Multiple single-interrupted sutures were placed for primary closure.

Upon completion of the implantation procedures, buprenorphine (0.05 mg/kg, IP) was given for analgesia prior to relocating to the animal intensive care unit. The rats were monitored closely by veterinary technicians during the recovery period of three to five days and kept in single occupancy cages in a twelve-hour light/dark cycle and fed rat chow (Rodent Laboratory Chow 5001, Ormond Veterinary Supply, Ontario, Canada) and water ad libitum for nine weeks before being euthanized. During the nine-week period, the rats were closely monitored on a regular basis for any sign of infection or illness. Proper management was carried out when such a sign was observed. The remaining incisors were monitored for their continual growth to avoid malocclusion and resultant malnutrition. When indicated, the teeth were clipped for ease of mastication. At the ninth week post-surgery, each rat was humanely euthanized immediately before the harvest using overdose of pentobarbital injection IP.

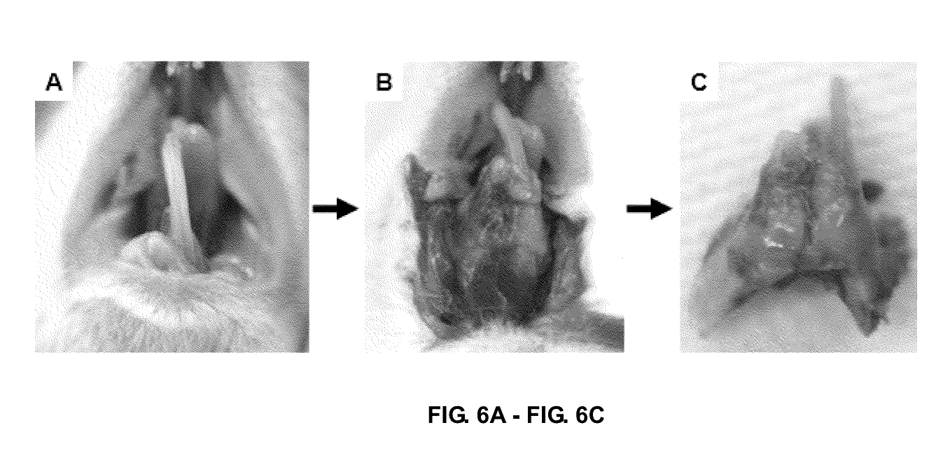

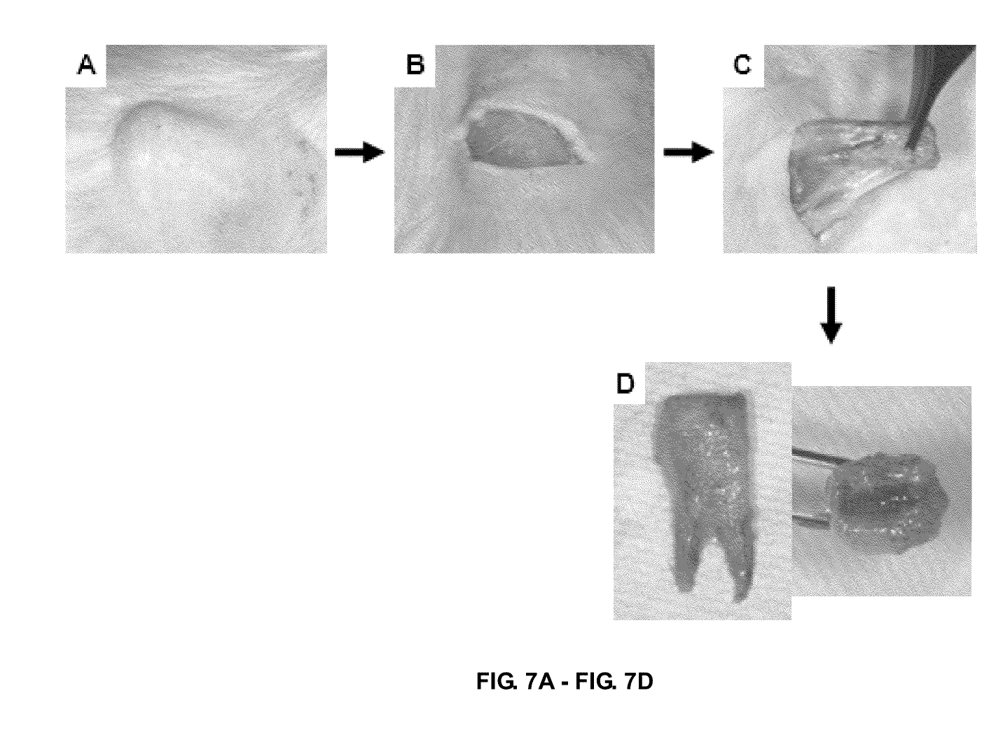

Harvest and laboratory procedures. Prior to the harvest, it was evident that the gingival tissues over the mandibular central incisor extraction socket had been maintained without exposure of the scaffolds (see e.g., FIG. 6A). The dorsum sites also showed its optimal wound healing (see e.g., FIG. 7A).

The scaffolds in the mandible were harvested en bloc including the remaining adjacent central incisor and alveolar bone (see e.g., FIG. 6). The dorsum scaffolds were retrieved with the surrounding fascia encapsulating the scaffolds (see e.g., FIG. 7). All harvested constructs were stored in 10% formalin prior to transportation to the histology lab for 5 μm-thick slide preparations and hematoxylin and eosin (H&E) and von Kossa (VK) staining of each specimen.

Quantification of cell homing, vascularization and mineralization. Quantification of cell homing, vascularization and mineralization was based on any observed differences in cellular density, angiogenesis (blood vessel number and diameter), and presence of mineralization between the study groups and implantation sites.

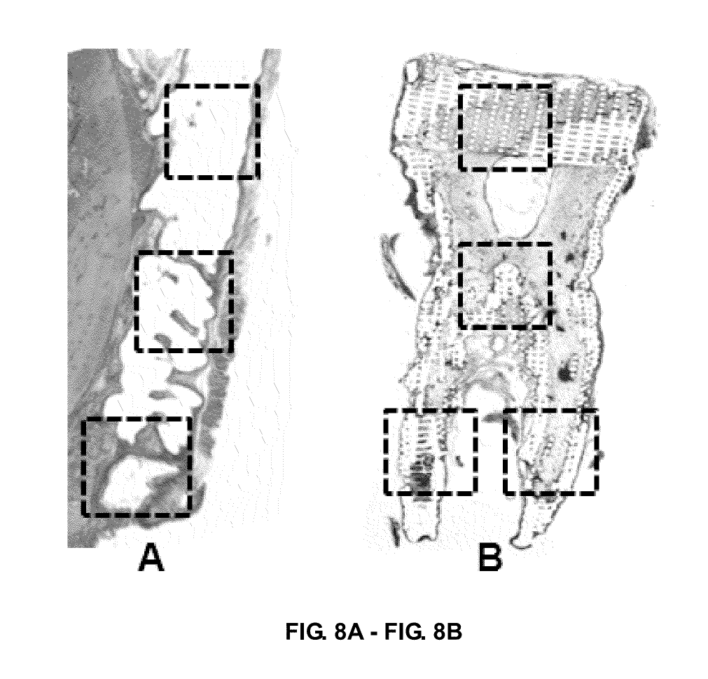

The quantification procedures were performed by a blinded examiner who was not aware which rat belonged to which group. Prior to examining the slides of each scaffold, a decision was made as to which areas would contribute to the histological data analysis. It was agreed to look at the mid-regions of coronal third, middle third, and apical third of the scaffolds prepared on the slides as shown in FIG. 8. Hence, the scaffold harvested from the extraction socket had three regions evaluated (see e.g., FIG. 8A), while the scaffold from the dorsum site had four regions evaluated due to the presence of the two roots (see e.g., FIG. 8B). Each slide was examined thoroughly using a digital research microscope (Leica DM6000, Leica, Switzerland) at 100× magnification. The slide photos were taken digitally. The software program provided with the microscope, Leica Application Suite (LAS), was used to carry out quantification of cells and blood vessels within the agreed regions. The counts were later converted into number/mm². The blood vessel diameter was measured using a computer software program (Photoshop CS) and converted into millimeters (mm). Presence or absence of mineralization was evaluated also.

Statistical analyses. All statistical analyses were carried out using a computer program (Microsoft Office Excel 2007). For each variable previously mentioned, mean average and standard deviation values were calculated. Student t-tests were carried out to determine the level of significance between the two experimental groups and between the implantation sites. A p-value<0.05 was considered significant.

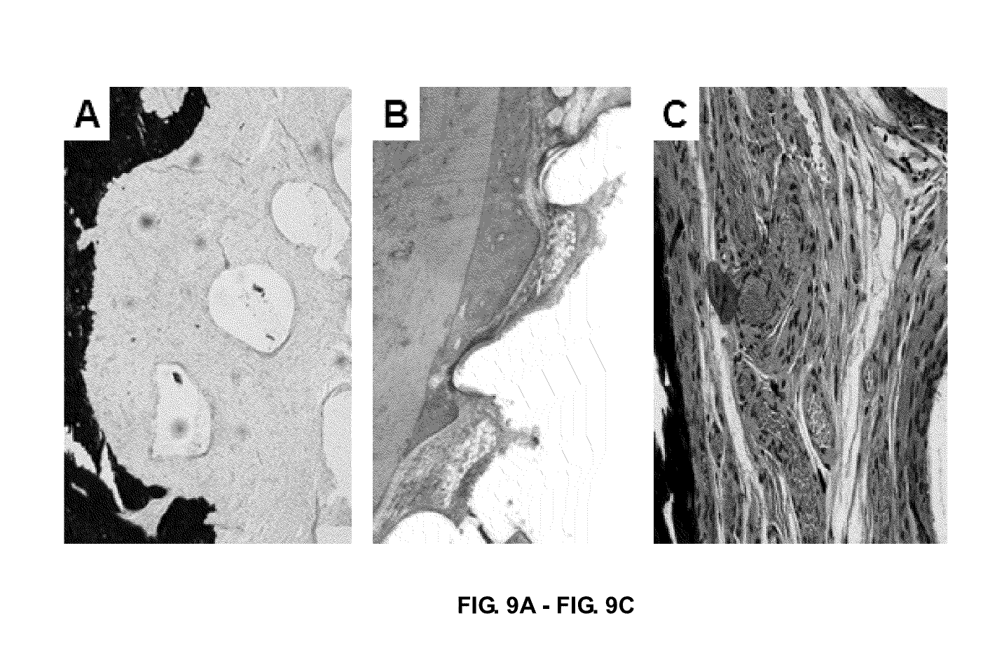

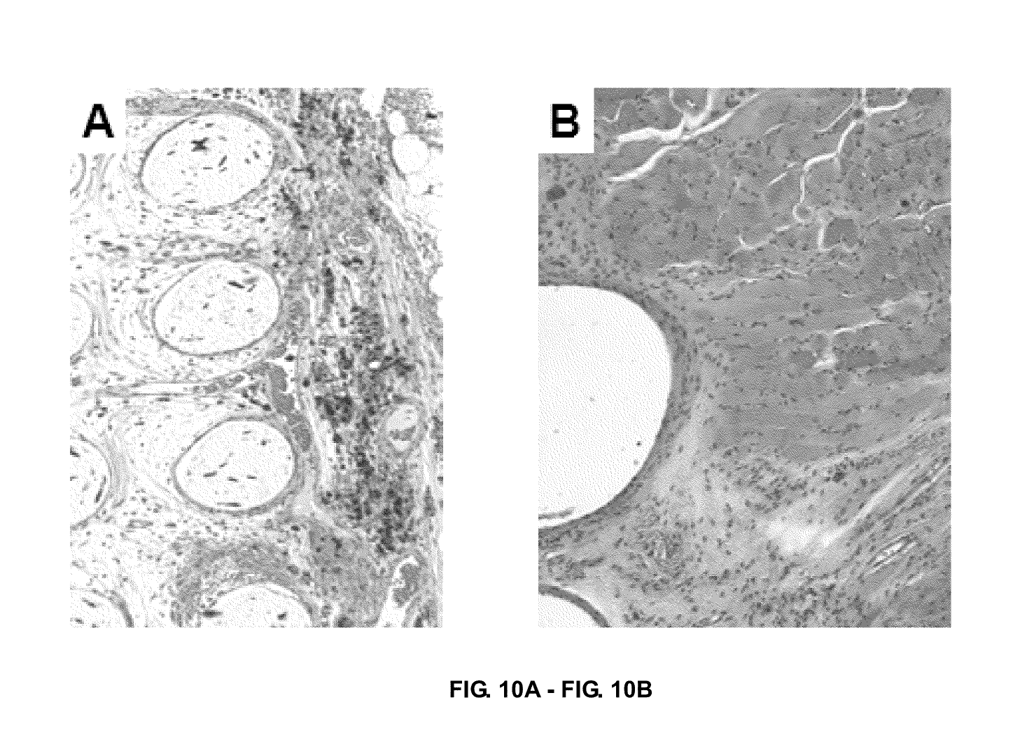

Tissue integration with the PCL-HA scaffolds. As evident in FIG. 9 and FIG. 10, all scaffolds from both implantation sites of both groups showed that the tissue-scaffold interface regions demonstrated comparably tight tissue-to-scaffold adaptation. It did not appear that there was any noticeable difference between the two groups regardless of the implantation sites. However, the microscopic characteristics of integration appeared to be different between the two implantation sites. With the scaffolds within the extraction sockets, the interface was characterized by noticeable bone-to-scaffold adaptation, possibly with fibrous lining. Some interfaces exhibited bony ingrowth between the strands of the scaffold (see e.g., FIG. 9A, FIG. 9B). Also, there was a definite evidence of angiogenesis and soft tissue ingrowth at the interface of the scaffold and the socket wall (see e.g., FIG. 9C). It appeared that the tissue grew around and between the PCL-HA strands (see e.g., FIG. 9C). Tissue was also along the bony socket walls (see e.g., FIG. 9C). The dorsum sites showed that the interface had soft tissue ingrowth well into the internal areas of the scaffolds (see e.g., FIG. 10A, FIG. 10B).

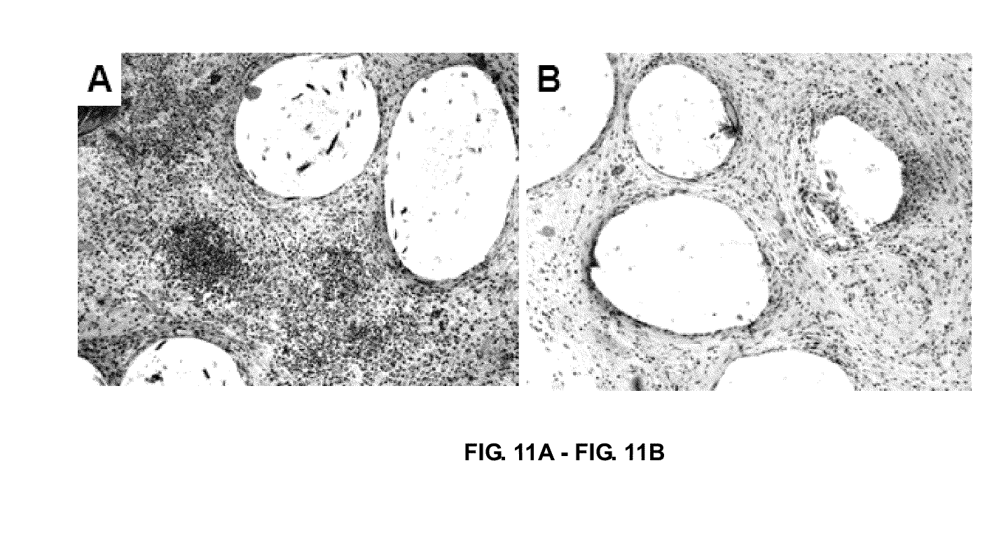

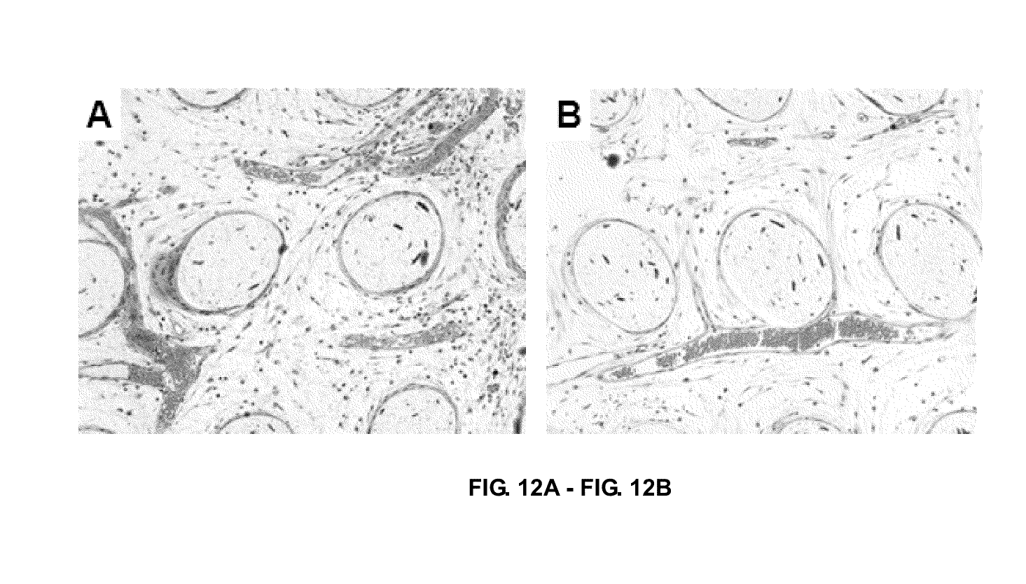

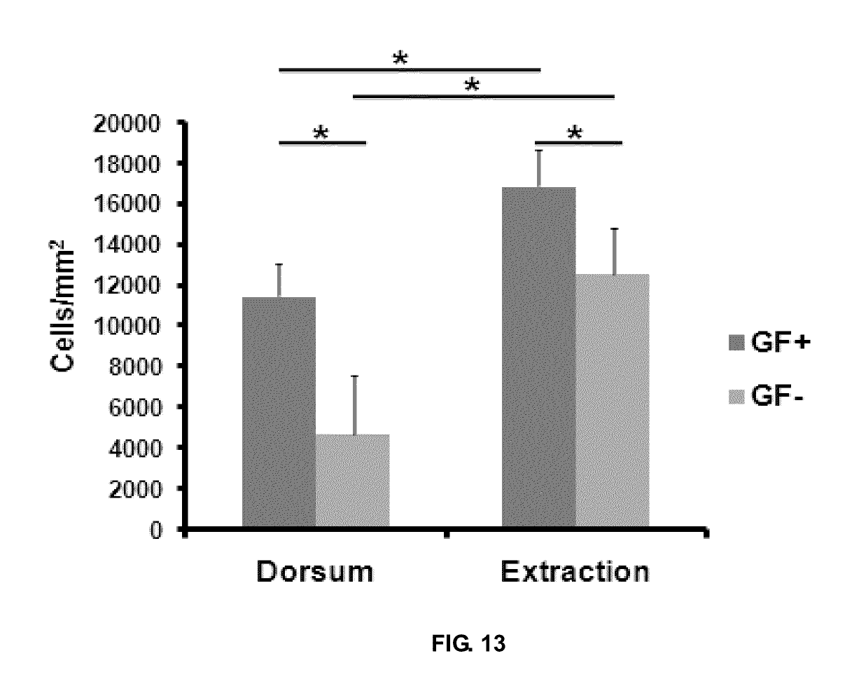

Cell penetration and density. Previous studies utilizing PCL-HA scaffolds have demonstrated cellular penetration and proliferation around strands comprising the PCL-HA scaffold (Heo 2007). As shown in FIGS. 11 and 12, there was a noticeable difference in cell density (cells/mm²) levels between the test and control groups of each implantation site. FIG. 11 depicts representative regions of the scaffolds retrieved from the extraction sockets while FIG. 12 represents the regions from the dorsum site scaffolds, test and control groups, respectively. The cellular density observed from the test group scaffolds was far greater than the one from the control group—p=0.049 and p=0.001, extraction socket site and dorsum site, respectively. The scaffolds retrieved from the extraction sockets had denser cellular populations than the ones from the dorsum sites—p=0.016 and p=0.002, test and control groups, respectively (see e.g., FIG. 13).

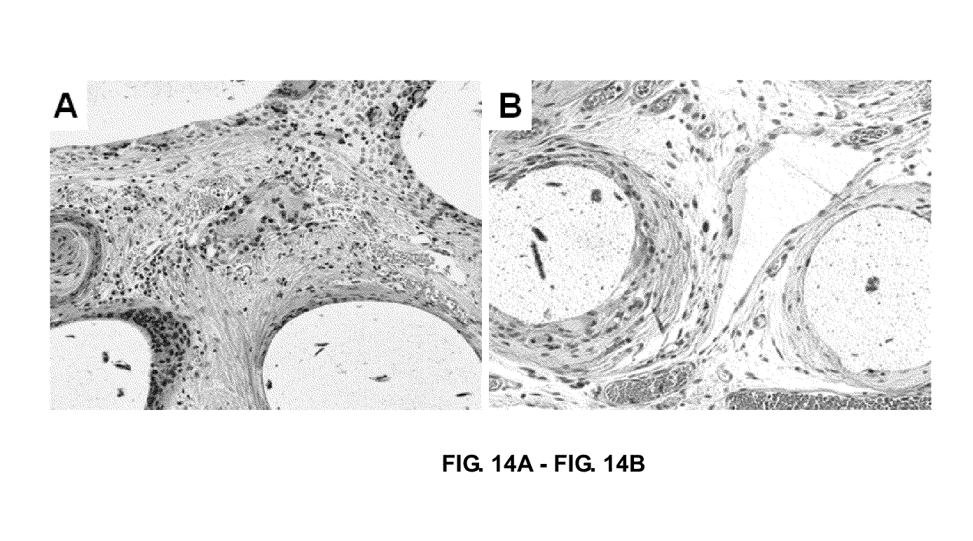

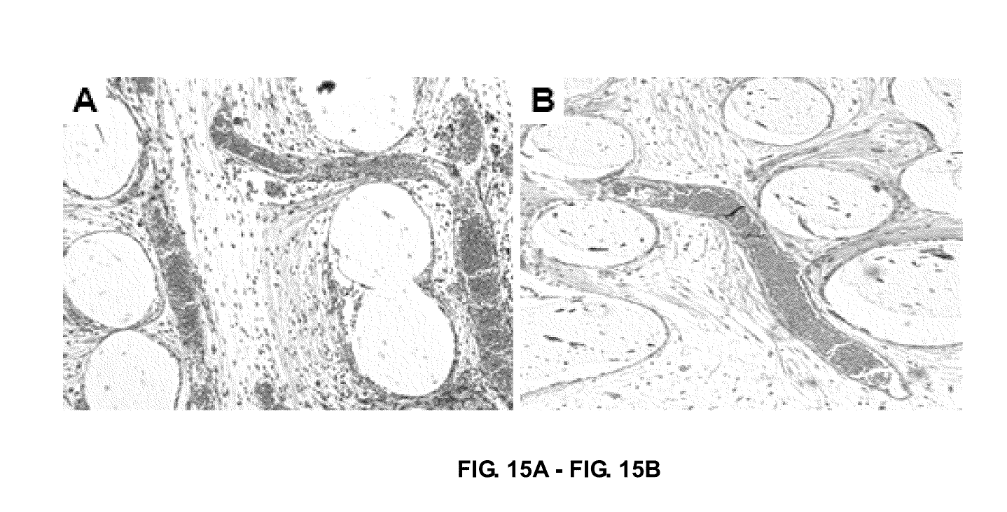

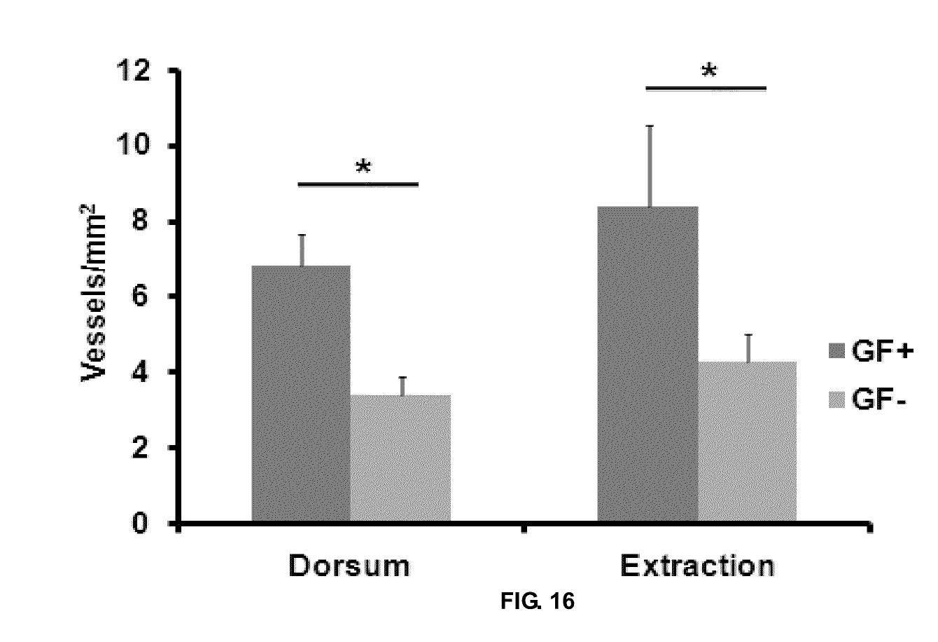

Angiogenesis. Angiogenesis was evident within all of the harvested scaffolds from the both experimental groups (see e.g., FIG. 14, FIG. 15). In general, there was a greater extent of angiogenesis observed (vessels/mm²) in the test group scaffolds than in the control, regardless of the implantation sites—p=0.011 and p=0.002, extraction socket and dorsum site, respectively (see e.g., FIG. 16). However, the density observed in the scaffolds from the extraction sockets was seemingly greater overall despite of its statistical insignificance between the groups—p=0.222 and p=0.095, test and control groups, respectively (see e.g., FIG. 16).

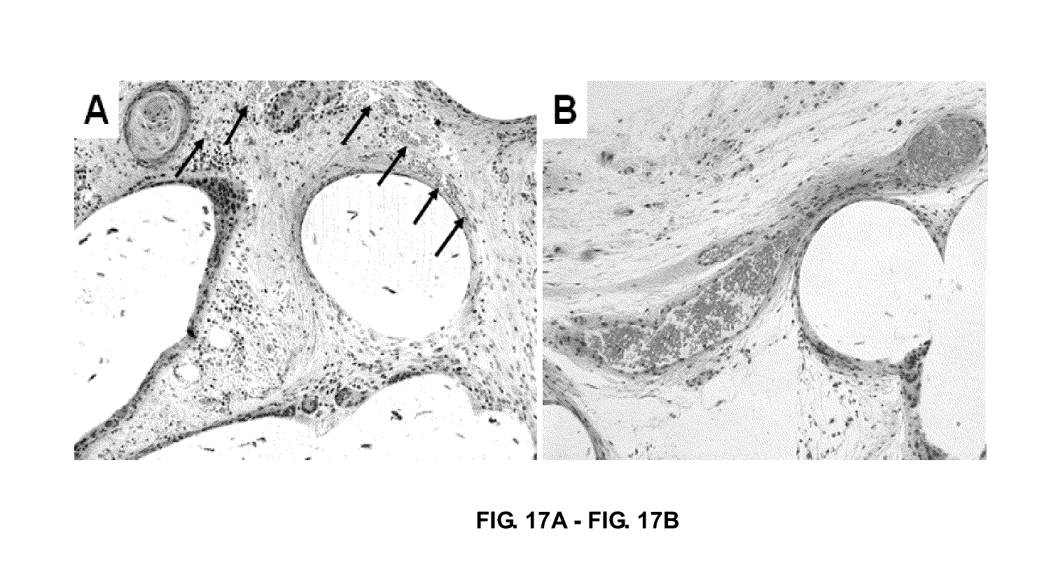

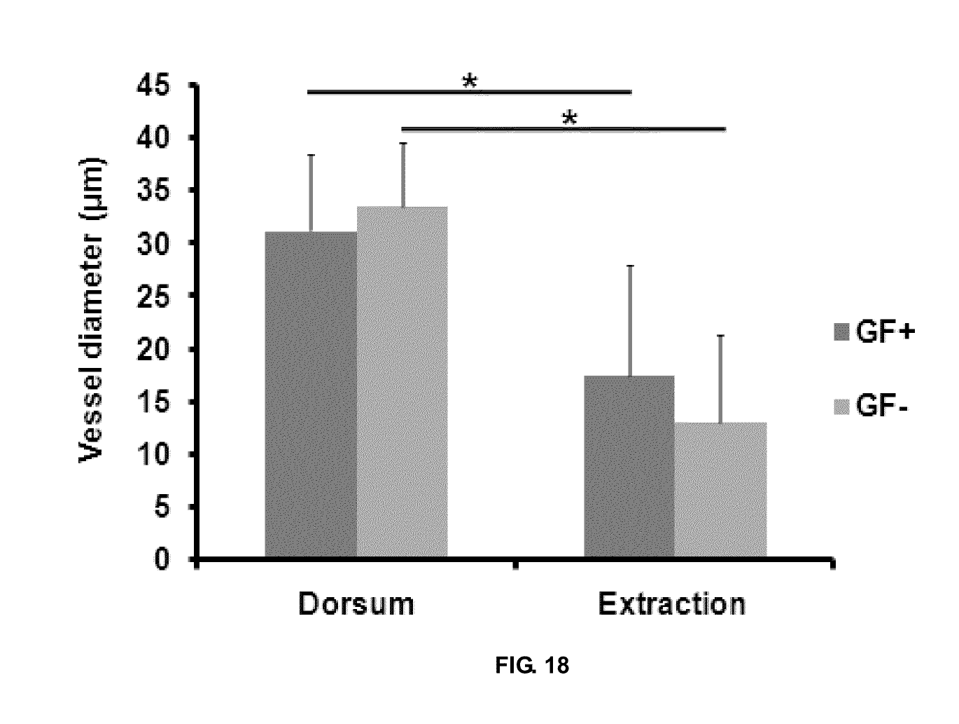

The blood vessel diameter (μm) in the dorsum implantation site was greater than in the extraction socket—p=0.028 and p=0.022, test and control groups, respectively (see e.g., FIG. 18). However, there was no statistical difference between the experimental groups—p=0.426 and p=0.732, extraction socket and dorsum site, respectively (see e.g., FIG. 18). The representative photos of the slides showed that the vessel diameter appeared much greater in the scaffolds harvested from the dorsum sites than from the extraction sockets (see e.g., FIGS. 17A, B). As shown FIG. 18, within the dorsum scaffolds there was an apparent greater mean value of vessel diameter within the control groups, although the difference did not reach statistical significance (p=0.732).

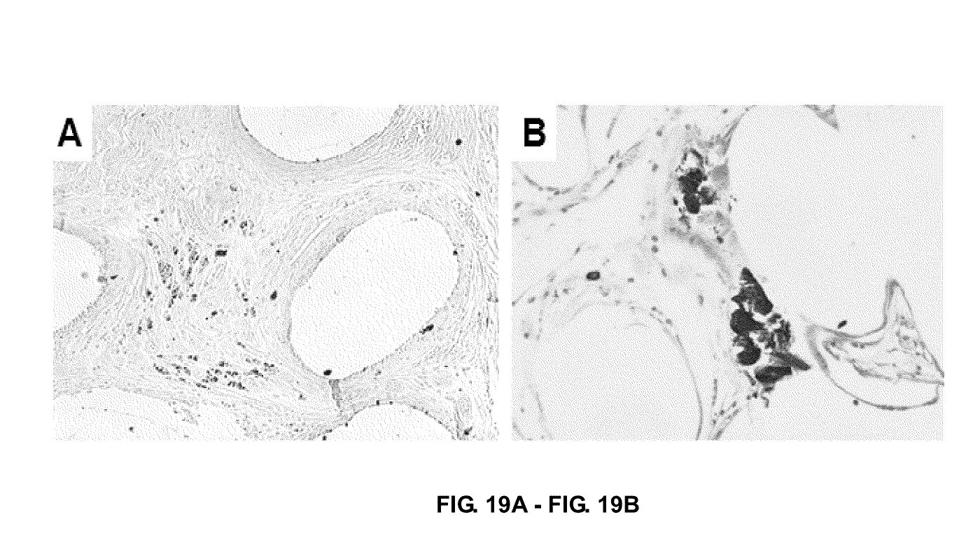

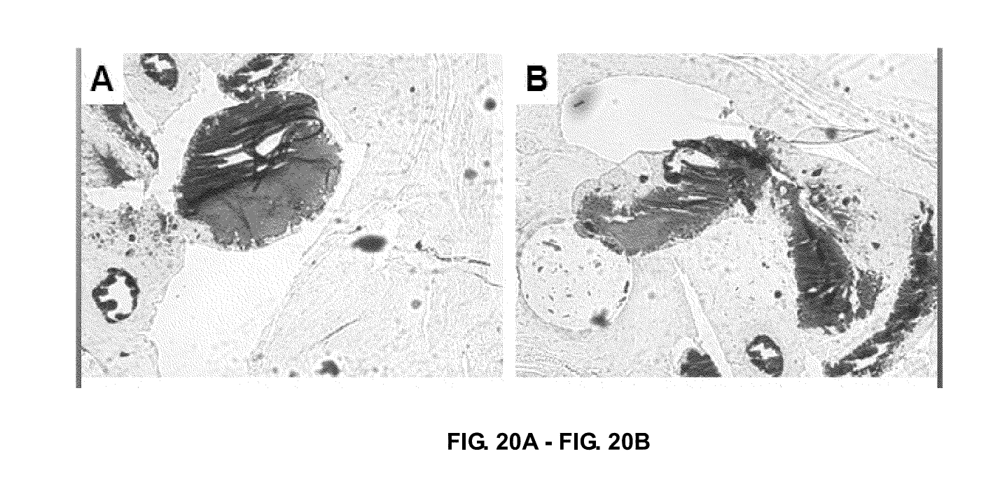

Mineralization. Mineralization regions were observed in the test group scaffolds only (FIGS. 19, 20). Scaffolds from test group extraction socket and test group dorsum implantation site showed regions of mineralization in the von Kossa (VK) slides. At both implantation sites, mineralization was seen well into the scaffolds, and not at the tissue-to-scaffold interface areas.

Cell transplantation is the default strategy of cell based therapies which includes transplantation or injection of culture-expanded or modified tissue progenitors, or fully formed tissue. However, therapeutic transplantation of culture-expanded adult cells has several critical barriers, including limited life-span, slow proliferation, and loss of cell phenotype during elongated culture period. Accordingly, technological and economic viability of cell delivery approaches, especially for those require substantial cell manipulation ex vivo, has been questioned. Recently, there has been a growing interest to regenerate tissues by cell homing, often followed by orchestrating the morphogenesis of the innate cells. Cell homing refers to active recruitment of endogenous cells into predetermined anatomic compartment, and represents an under-studied approach in tissue regeneration. Cell homing is site-directed homing of native stem cells to induce tissue formation within cytokine-loaded scaffolds. In many adult tissues, stem cells homing and migration are critical for the ongoing replacement of mature cells and regeneration of damaged cells.

The instant results suggest the internal architecture of interconnected microchannels (200 μm dia.) created by the layer-by-layer deposition of PCL-HA (200 μm dia.) contributed to the intimate tissue-to-scaffold adaptation at the interface areas, followed by the successful homing of host cellular and vascular ingrowth into the large scale (˜17 mm) scaffolds. The scaffolds with SDF1 and BMP-7 promoted host cell penetration.

Stromal cell—derived factor-1 (SDF-1), which is secreted by stromal cells in the bone marrow microenvironment, plays an essential role in promoting cell homing by recruitment of progenitor cells that express its cognate receptor, CXC chemokine receptor 4 (CXCR4). CXCR4+ positive cells include CD34+ hematopoietic stem cells (HSGs) and mesenchymal stem cells (MSCs) in bone marrow. Since these cells are essential for vascularization and bone regeneration, it is presently thought that SDF-1 incorporated in the 3D scaffolds recruited not only local cells but also hematopoetic stem cells and MSCs.

In addition to SDF1, BMP-7 was delivered with the scaffold. Since BMP-7 plays a central role in the transformation of mesenchymal cells into osteoblasts, it is speculated that the ectopic or orthotopic mineralization observed in the cell-free scaffolds was achieved by BMP-7-mediated osteogenic differentiation of stem/progenitor cells, which were recruited by SDF1. However, the results show that there has been little and inconsistent mineralization evident in scaffolds with SDF1 and BMP-7, in both implantation sites. Suboptimal osteogenesis may be because of rapid release of BMP-7, for collagen degrades in vivo quickly.

Interestingly, less mineralized area was observed in the extraction socket implantation site compared to the dorsum, despite of abundance of the blood and the bone marrow cells. This may be because the healing in the extraction socket after removal of a mandibular central incisor possibly was delayed due to the implantation of the scaffold. Extended surgical duration may have also led the paper-thin labial wall more prone to post-operative resorption. The atraumatic extraction procedure of the rat mandibular incisor is known to be extremely technically demanding as the tooth and the surrounding tissues are both extremely fragile. The handling of small rat mandible further complicates the procedure as well.

The histological evaluation confirms in this study that many of the sockets have lost their labial bony plates. This may be due to the extreme thinness of the remaining labial walls. During this process of labial resorption and simultaneous socket remodeling, it is presently thought that there could have been increased osteoclastic activities. It has been established previously that the healing process of the rat molar extraction sockets is divided into three phases: an early phase (1-5 days) during which organization of the blood clot is completed and the socket is partially covered by epithelium; a bone formation phase (5-20 days); and a bone remodeling phase (20-60 days) when the young bone matures and the alveolar ridge is remodeled. Histomorphometric analysis has shown that the edentulous mandible undergoes a significant reduction in size as a result of reduction in both height and width up to 112 days post-extraction. Considering the fact that the harvesting procedures took place at the 9^{th} week post-implantation, it might be possible that the remodeling and shrinkage had been actively taking place at the time of the harvest.

In summary, the present findings demonstrated in the in vivo rat model that innate cells could be induced to migrate into the PCL-HA scaffold with simultaneous angiogenesis and vascularization. This study underscored the exaggerated cellular penetration and angiogenesis in the PCL-HA scaffolds impregnated with SDF1 and BMP-7 than in the scaffolds of the control group. The greater extent of cellular ingrowth and angiogenesis was demonstrated in the extraction socket sites compared to the subcutaneous dorsum sites. Scaffolds impregnated with SDF1 and BMP-7 in the extraction socket sites exhibit the greatest proliferative potential. Thus, by demonstrating the rich cellular and vascular density observed in the extraction socket in presence of SDF1 and BMP-7, the potential for the orthotopic regeneration of a tooth using the cell homing techniques has been shown.

### Example 2

### Regeneration by Chemotaxis; PDGF Induced Recruitment of Alveolar Stem/Progenitor Cells

Stem/progenitor cells have been isolated from numerous tissues. Bone marrow is known as one of rich sources of stem/progenitor cells including both hematopoietic stem cells (HSCs) and mesenchymal stem/stromal cells (MSCs). Whereas fibroblast-like MSCs were first discovered in the marrow of long bones in 1970s, marrow of alveolar bone of the face was later found to contain cells analogous to long-bone MSCs, but perhaps with greater potency towards at least osteogenic differentiation. Since alveolar MSCs derive from neural crest/mesenchymal cells, different in embryonic origin from mesoderm-derived appendicular MSCs, the present example explored a novel model for tissue regeneration by chemotaxis of MSCs. Dental pulp is the only soft tissue of a tooth and maintains homeostasis of tooth as an organ. Root canal therapy is one of the most common dental treatments in which viable dental pulp tissue is extirpated and replaced with a bioinert thermoplastic material. Post-root canal teeth are deprived of biological viability and therefore susceptible to re-infection, fracture and trauma. Since dental pulp connects to alveolar bone marrow, it was thought by the inventors that alveolar MSCs can be recruited to regenerate dental pulp tissue.

Small alveolar bone samples were obtained from multiple healthy patients who underwent medically necessary tooth extraction. Mononucleated and adherent cells were slightly culture-expanded. Early-passage MSCs (p3) were first screened and found to express Stro-1, CD105, CD73, CD44 and CD90, but negative to CD34 by immunocytochemistry and flow cytometry. Alveolar MSCs differentiated into osteogenic, adipogenic, chondrogenic and myogenic cells in respective, chemically defined media. Migration of alveolar MSCs was studied in transwell insert system under the influence of multiple cytokines and growth factors.

PDGFββ at 50 ng/ml was most significant in elaborating cell migration at multiple time points. Receptor expression was confirmed.

Together, these findings demonstrate inducing the recruitment of endogenous or transplanted stem/progenitor cells towards tissue regeneration.

### Example 3

### Multiphase Scaffolds for Regeneration of Periodontium Complex

This Example shows the generation of a region-specific scaffold with three phases of microstructures, preoptimized for the regeneration of dentin/cementum, PDL, and alveolar bone from dental stem/progenitor cells.

Three-dimensional (3D) layer-by-layer fabrication enables precise control of the scaffold's microarchitecture in different regions, in conjunction with spatiotemporal delivery of amelogenin as a stimulant for mineralized dentin/cementum formation, connective tissue growth factor (CTGF) to stimulate bone marrow stromal/stem cells toward fibroblasts for PDL regeneration, and BMP2 as an osteoinductive agent to stimulate alveolar bone regeneration. These three recombinant human proteins were microencapsulated in poly(lactic-co-glycolic acid) (PLGA) microspheres (μS) and time-released in Phases A, B, and C (see e.g., FIG. 21) with different pore/channel scales of an integrated multiphase PCL/HA scaffold. In vitro and in vivo data collectively demonstrated that dental stem/progenitor cells were stimulated by spatiotemporally delivered bioactive cues and produced type I collagen (COL-I) fibers that inserted into dentin sialophosphoprotein-positive (DSPP⁺)/cementum matrix protein 1-positive (CEMP1+) mineralized matrix on one side and bone sialoprotein-positive (BSP⁺) bone-like tissue on another side, which together recapitulated a putative periodontium complex.

Tooth-supporting periodontium forms a complex with multiple tissues, including cementum, periodontal ligament (PDL), and alveolar bone. This example demonstrates the development of multiphase region-specific microscaffolds with spatiotemporal delivery of bioactive cues for integrated periodontium regeneration. Polycarprolactionehydroxylapatite (90:10 wt %) scaffolds were fabricated using three-dimensional printing seamlessly in three phases: 100-mm microchannels in Phase A designed for cementum/dentin interface, 600-mm microchannels in Phase B designed for the PDL, and 300-mm microchannels in Phase C designed for alveolar bone. Recombinant human amelogenin, connective tissue growth factor, and bone morphogenetic protein-2 were spatially delivered and time-released in Phases A, B, and C, respectively. Upon 4-week in vitro incubation separately with dental pulp stem/progenitor cells (DPSCs), PDL stem/progenitor cells (PDLSCs), or alveolar bone stem/progenitor cells (ABSCs), distinctive tissue phenotypes were formed with collagen I-rich fibers especially by PDLSCs and mineralized tissues by DPSCs, PDLSCs, and ABSCs. DPSC-seeded multiphase scaffolds upon in vivo implantation yielded aligned PDL-like collagen fibers that inserted into bone sialoprotein-positive bone-like tissue and putative cementum matrix protein 1-positive/dentin sialophosphoprotein-positive dentin/cementum tissues. This example illustrates a strategy for the regeneration of multiphase periodontal tissues by spatiotemporal delivery of multiple proteins. A single stem/progenitor cell population appears to differentiate into putative dentin/cementum, PDL, and alveolar bone complex by the scaffold's biophysical properties and spatially released bioactive cues.

Fabrication of Multiphase Scaffolds with Spatiotemporal Delivery of Bioactive Cues.

PCL/HA scaffolds were fabricated (5×5×3 mm³) by layer-by-layer deposition using 3D printing (Bioplotter; EnvisionTec) as discussed previously. Briefly, PCL and HA (90:10 wt %) was comolten at 120° C. and dispensed through a 28-gauge metal needle (DL Technology) to create interlaid strands (diameter 100 μm) and interconnected microchannels (see e.g., FIG. 21). To construct integrated multiphase microstructures, dispensing parameters including distance in between interlaid microstrands were varied. The fabricated scaffold consisted of three phases: (Phase A) 100-μm transverse microchannels with 2.25 mm in width designed for cementum/dentin interface, (Phase B) 600-μm transverse microchannels with 0.5 mm in width designed for the PDL, and (Phase C) 300-μm transverse microchannels with 2.25 mm in width designed for alveolar bone (see e.g., FIGS. 21B-D). These design parameters were selected with reference to microscopic scales in the literature and also experience in the regeneration of fibro-osseous tissues.

To direct cell differentiation, PLGA-μS encapsulating recombinant human amelogenin, CTGF, and BMP2 were incorporated in Phases A, B, and C of the scaffold, respectively (see e.g., FIG. 21E, FIG. 21F, FIG. 21G). Amelogenin is a secreted protein by ameloblasts and participates in mineralization. CTGF was selected for its potency to stimulate fibroblastic differentiation. BMP2 was selected for its ability to promote osteogenesis. Natively, amelogenin is expressed by ameloblasts and was selected to simulate odontogenesis or cementogenesis, and for its effect in promoting differentiation of odontoblasts and cementoblasts. Consistently, amelogenin promotes DPSC's differentiation into odontoblast-like cells (data not shown). PLGA-μS-encapsulating these bioactive cues were prepared using double-emulsion technique as previously described. In vitro release kinetics showed timed extrusion of the encapsulated cues up to the tested 6 weeks. Then, a total of 10-mg PLGA μS encapsulating recombinant human amelogenin (10 μg), CTGF (5 μg), or BMP2 (2.5 μg) were suspended in 1 mL ethanol, air-dried 1 h for ethanol evaporation, and then delivered into the scaffold's microchannels in Phases A, B, and C, respectively. Microspheres-suspended in ethanol with preoptimized volume was pipetted through microchannels in each phase of scaffold to achieve phase-specific μS incorporation. Scaffold's microstructures and μS incorporation were imaged with scanning electronic microscopy (S-4700; Hitachi High Technologies). The PLGA μS-incorporated scaffolds were sterilized in ethylene oxide (ETO) for 24 h before cell seeding. There was minimal loss of protein potency following ETO sterilization in comparison to other methods. Identical scaffolds with empty PLGA μS (no proteins) were used as controls for in vitro and in vivo experiments.

For dentin/cementum formation, a study was conducted to obtain optimal size or pattern of micro-channels that promote the differentiation of dental stem/progenitor cells into odontoblasts or cementoblasts. The data showed that 100-μm channels in 3D-printed scaffolds are superior in promoting odontoblastic differentiation than other channel sizes tested.

Cell Preparation and Delivery.

Human DPSCs, PDLSCs, and alveolar bone stem/progenitor cells (ABSCs) were isolated from 18- to 39-year-old patients as per previously described methods. Briefly, tooth pulp and PDL samples were minced and digested with collagenase (3 mg/mL) and dispase (4 mg/mL) for 1 h at 37° C. for DPSC and PDLSC isolation, respectively. Mononucleated and adherent cells were isolated by single-cell suspension and passage through a 70-mm strainer (BD). The isolated cells were cultured in DMEM supplemented with 10% fetal bovine serum (Atlanta Biological) and 1% antibiotics at 37° C. and 5% CO₂ with the medium change twice a week. To isolate ABSCs, alveolar bone samples were cultured to allow the migration of mononucleated and adherent cells out of bone marrow. Previously isolated and expanded, DPSCs, PDLSCs, and ABSCs were allowed to differentiate into osteo-/odontoblastic, chondrogenic, and adipogenic lineages.

Passage 2-4 DPSCs, PDLSCs, or ABSCs were suspended at a density of 1×10⁵ cells/scaffold in a neutralized COL-I solution (2 mg/mL). Cell-suspended collagen solution was then infused into scaffold's microchannels and incubated for 1 h at 37° C. Cell-seeded multiphase scaffolds were cultured in 12-well plates for 2 days before in vivo implantation or cultured for 4 weeks in vitro in chemically defined media, a 1:1 mixture of osteo-/odontogenic supplements and fibroblastic differentiation supplements as previously described. Total 10 samples per group were cultured for in vivo experiments.

In Vivo Implantation of Cell-Delivered Scaffolds.

10-week-old immunodeficient mice (Harlan) were anesthetized with 1-5% isofluorane. Upon disinfection with 10% povidone iodine and 70% ethanol, a 15-mm incision was made in the dorsum's mid-sagittal plane. Following creation of subcutaneous pouches, DPSC-seeded multiphase scaffolds with spatiotemporal delivery of BMP2, CTGF, and amelogenin were implanted, followed by wound closure (n=10). DPSC-seeded scaffolds with empty μS were implanted as control (n=10). The rationale for delivery of DPSCs, as opposed to PDLSCs or ABSCs, in the present in vivo experiment is that DPSCs have been more thoroughly characterized and are readily available in extracted teeth that are currently discarded as medical waste. Following 6-week in vivo implantation, all constructs were retrieved from mice following euthanasia by CO₂ inhalation.

Gene Expression.

Total RNA was isolated from each phase of the cultured scaffolds using Trizol as previously described. All isolated RNA samples were reverse-transcribed using a kit (Applied Biosystems). For mRNA quantification, real-time quantitative polymerase chain reaction (PCR) with the cDNA samples were performed using ViiA™ 7 Real-Time PCR System and TaqMan® gene expression assays (Applied Biosystems). Commercially available primers and probes for human COL-I, CEMP1, DSPP, and BSP were used with GAPDH as a housekeeping gene.

Histomorphometric and Immunohistochemical Analyses.

The harvested samples were imbedded in paraffin and sectioned at 5 μm thickness. Randomly selected sections were stained with H&E, Masson's Trichrome, and Alizarin Red (AR) as previously described. Immunofluorescence for COL-I (ab90395; Abcam), DSPP (ab122321), CEMP1 (ab134231), and BSP (ab52128) was performed as previously described. Confocal microscopy was used to evaluate multiphase tissue formation in scaffolds without sectioning.

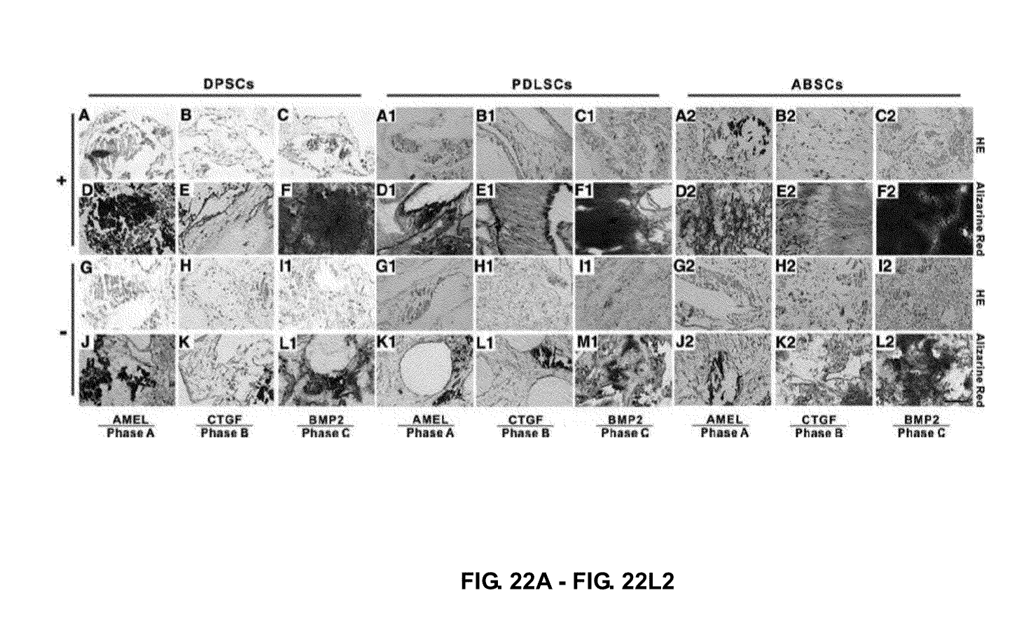

Scaffolds with spatiotemporal delivery of bioactive cues formed distinctive multiphase tissues consisting of primitive PDL-like collagen fibers in Phase B that interfaced between mineralized bone-like tissues of Phases A and C that simulated dentin/cementum following 4-week in vitro incubation with DPSCs, PDLSCs, or ABSCs, respectively (see e.g., FIG. 22). Remarkably, dense and polarized mineralized tissue was formed under amelogenin stimulation of DPSCs (see e.g., FIG. 22A) in Phase A that was designed to simulate dentin/cementum formation. Spindle-shaped fibroblast-like cells in a non-mineralized matrix were present in CTGF-stimulated Phase B that was designed to simulate the PDL (see e.g., FIG. 22B, FIG. 22E). Mineralized tissue was also formed in BMP2-stimulated Phase C that was seeded with DPSCs and designed for alveolar bone (see e.g., FIG. 22C, FIG. 22F). Interestingly, scaffolds with empty μS also showed multiple tissues structures: mineralized tissues in Phases A and C (see e.g., FIG. 22J, FIG. 22L) but nonmineralized tissue in Phase B (see e.g., FIG. 22K), although mineralized tissue formation was not as robust as in amelogenin- or BMP2-delivered samples (see e.g., FIG. 22D, FIG. 22F). Strikingly, collagen fiber-like structures were formed by PDLSCs under CTGF stimulation in Phase B, reminiscent of the native PDL (see e.g., FIG. 22B1, FIG. 22E1). Dense mineralization was observed in Phase C with BMP2 stimulation of PDLSCs (see e.g., FIGS. 22C1, 22F1), but not as robust as in Phase A with amelogenin stimulation (see e.g., FIG. 22D1). ABSCs yielded similar multitissue patterns with somewhat modest mineralization in Phase A (see e.g., FIG. 22A2, FIG. 22D2) and robust mineralization in Phase C (see e.g., FIGS. 22C2, 22F2). Collagen fiber-like structures were formed by PDLSCs under CTGF stimulation in Phase B, reminiscent of the native PDL (see e.g., FIG. 22B1, FIG. 22E1).

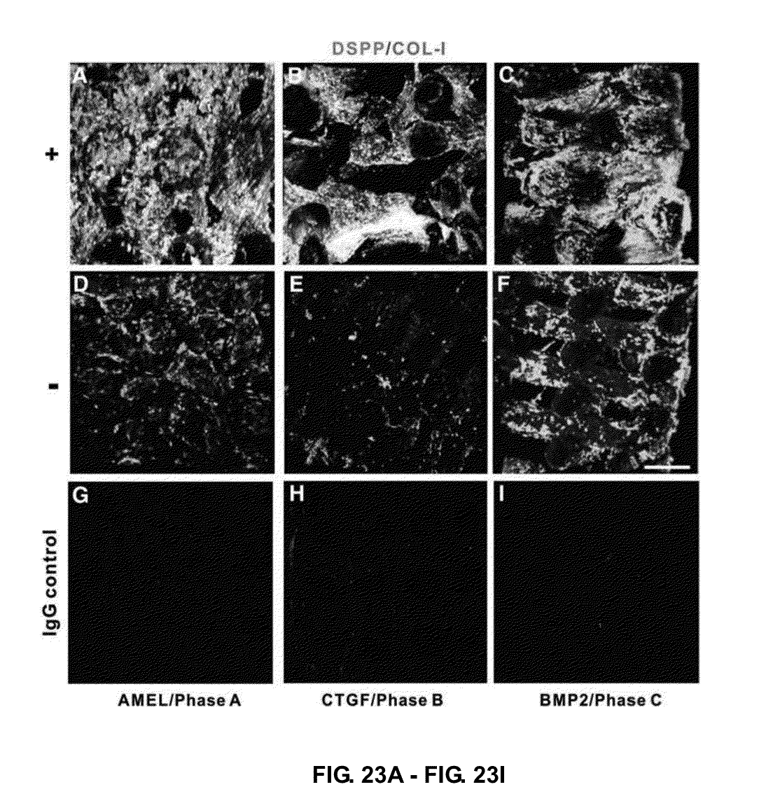

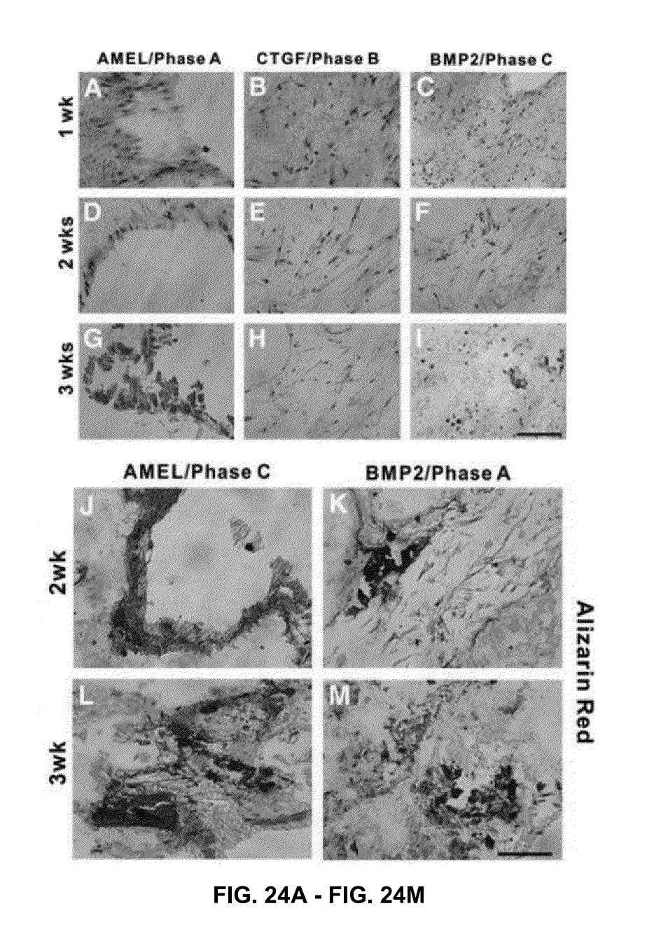

Confocal microscopy demonstrated COL-I-rich non-mineralized soft tissue under CTGF stimulation in Phase B (see e.g., FIG. 23B) that interfaced between DSPP+mineralized matrix in Phases A and C under amelogenin and BMP2 stimulations (see e.g., FIG. 23A, FIG. 23C respectively) and culture with DPSCs for 4 weeks. In contrast, scaffolds with empty μS yielded scattered mineralization and modest COL-I (see e.g., FIGS. 23D-23F). Samples harvested at multiple time points (1, 2 and 3 weeks) demonstrated different mineralization patterns in Phase A than those in Phase C. In Phase A, polarized cell alignment was observed on scaffold's microstrand surface by 1 week and mineralized matrix was deposited along with the aligned cells by 3 weeks to form polarized dense mineral structures (see e.g., FIG. 24A, FIG. 24D, FIG. 24H, FIG. 24K, FIG. 24M). In contrast, mineral deposition in Phase C was relatively scattered and isolated from 1 to 3 weeks (see e.g., FIG. 24C, FIGS. 24F, 24J, FIG. 24L, FIG. 24N). Spindle-shaped cells were observed as early as 2 weeks in Phase B (see e.g., FIG. 24B, FIG. 24E, FIG. 24I).

Multiphase Expression of mRNA Markers.

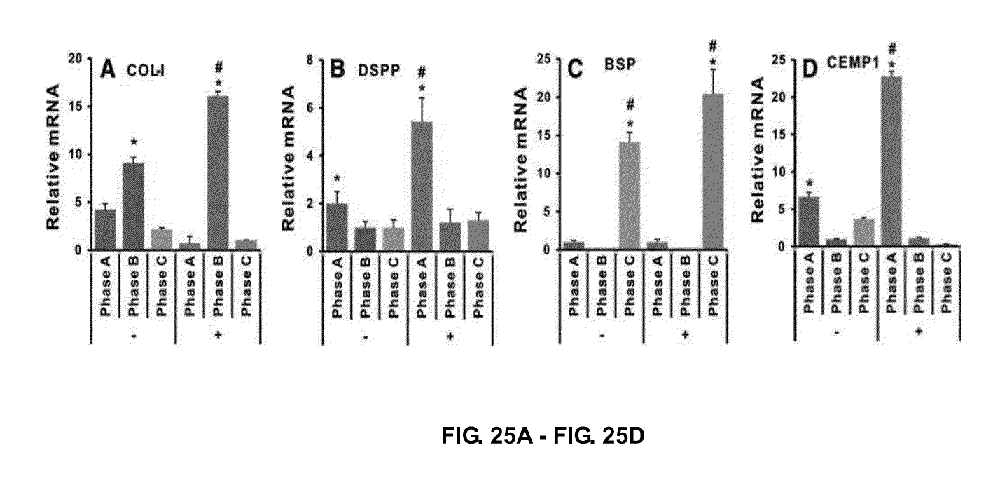

Real-time quantitative PCR showed that COL-I mRNA expression was significantly higher in Phase B than in Phases A and C (see e.g., FIG. 25A). COL-I mRNA level was elevated by the delivery of bioactive cues (see e.g., FIG. 25A). DSPP and CEMP1 mRNA expression was significantly higher in Phase A than in Phases B and C (see e.g., FIG. 25B, FIG. 25D). BSP mRNA Expression was significantly highly in Phase C than in Phases A and B (see e.g., FIG. 25C). The expression of DSPP, CEMP1, and BSP mRNA was further enhanced in bioactive cues-delivered group than scaffolds with empty μS (see e.g., FIG. 25B-FIG. 25D) (n=5 per group; p<0.01).

In Vivo Generation of Multiphase Tissues Mimicking Periodontium Complex.

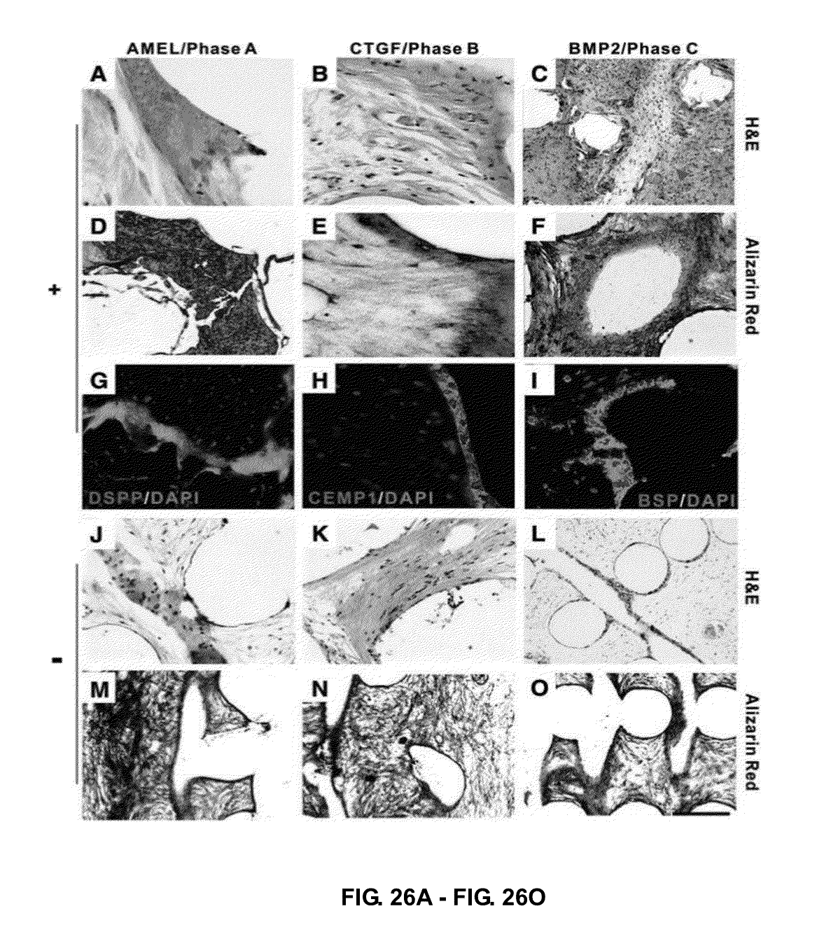

After 4-week in vivo implantation, distinctive and yet integrated multiphase tissues were generated in DPSC-seeded scaffolds with spatiotemporal delivery of bioactive cues (see e.g., FIG. 26). In Phase A, dense mineralized tissue was formed (see e.g., FIG. 26A) and was positive to both AR (see e.g., FIG. 26D) and DSPP (FIG. 26G). Unmineralized connective tissue was formed in Phase B not only with fibroblast-like cells and blood vessels (see e.g., FIG. 26B) but also inserted into mineralized tissue that was positive to both AR (see e.g., FIG. 26D) and CEMP (see e.g., FIG. 26G), reminiscent of dental cementum. Phase C showed mineralized connective tissue (see e.g., FIG. 26C), positive to AR (see e.g., FIG. 26F), and also BSP (see e.g., FIG. 26I), indicating mineralized bone-like tissue formation. Strikingly, Phase A seeded with DPSCs and stimulated with amelogenin (see e.g., FIG. 26A, FIG. 26D, FIG. 26G) showed different tissue phenotype from that in Phase C containing the same population of DPSCs but stimulated with BMP2 (see e.g., FIG. 26C, FIG. 26F, FIG. 26I), suggesting that amelogenin and BMP2 have differential effects on DPSCs. Immunofluorescence demonstrated that mineralized matrix in Phases A and C are positive for DSPP and BSP, respectively (see e.g., FIG. 26G, FIG. 26I). Remarkably, aligned collagen fiber-like structures inserted into CEMP1⁺ mineralized tissue, reminiscent of Sharpey's fibers at the interface between Phases B and C (see e.g., FIG. 26B, FIG. 26E, FIG. 26H). Similar to the in vitro finding, scaffolds with empty μS showed similar tendency with suboptimal tissue formation (see e.g., FIGS. 26D-26F, FIGS. 26J-26L).

Summary.

Periodontium are complex and integrated anatomical structures with multiple region-specific tissue phenotypes, playing important roles in tooth function. These findings suggest de novo formation of putative dentin/cementum-like structures and a PDL-like tissue interface both in vitro and in vivo by multiphase scaffolds with three distinctive microstructures and spatiotemporal delivery of BMP2, CTGF, and amelogenin. Multiple tissues consisting of BSP⁺ bone-like tissue, Col-I⁺ collagen fibers, and CEMP1⁺/DSPP⁺⁺ dentin/cementum-like structures derive a single population of dental stem/progenitor cells in vivo. Previous periodontal tissues regeneration models have primarily adopted the approach of staggering multiple layers of biomaterials. Although staggering of multiple biomaterial sheets is convenient for cell seeding, potential delamination of multiple layers is a concern. Continuous 3D printing is used to construct a seamless biomaterial scaffold and with different region-specific pore/channel sizes that are specifically designed for integrated regeneration of multiple periodontal tissues. The design of 100 μm transverse microchannels in Phase A is to serve as a module for cementum/dentin interface. The rationale for 600 μm transverse microchannels in Phase B is to simulate the width of the native PDL in the range of 200 to 700 μm. Furthermore, the design of 300 μm transverse microchannels in Phase C with a width of 2.25 mm for alveolar bone is to provide sufficient space in a pore size that is consistent with osteogenesis. Cell seeding is convenient by hydrogel infusion in microchanneled scaffolds. Sharpey fiber-like structures inserting into DSPP⁺ and CEMP1⁺ mineralized cementum-like tissue on one side and BSP⁺ bone-like tissue on the other side in vivo indicates the formation of a putative periodontium including putative dentin/cementum, PDL, and alveolar bone. This putative periodontium, in conjunction with DSPP⁺ mineralized dentin-like tissue in vivo, arguably serves as a prototype for additional work for orthotopic regeneration of tooth root—periodontium complex. The pattern and size of microchannels/microstrands are readily adjustable while maintaining physical integration, consequently leading to the generation of integrated multiple tissues.

Microchannels were designed with biophysical parameters specifically for the regeneration of multitissue periodontium. A distinctive microarchitecture consists of interconnectivity and surface tomography in layer-deposited scaffolds and serves as pivotal cues for odontoblastic differentiation together with microchannel size. Microstructures with 100 μm microchannels in layer-deposited scaffolds appear to provide an appropriate biophysical configuration to the deposition of polarized dense mineralized structure, reminiscent of dentin. The 100 μm channels in 3D-printed scaffolds are superior in promoting odontoblastic differentiation than other channel sizes tested. Channel sizes bigger than 100 μm (200-300 μm) failed to yield odontoblastic differentiation (data not shown). Although microstructures on native dentin surface with 2-3 μm dentinal tubules is presumably appropriate to induce odontoblastic differentiation of DPSCs, DSPP⁺ tissue formation in 100-μm channels may allow putative odontoblasts to extend their processes and form multiple units of 2-3 μm dentinal tubules.

### Example 4

### Regeneration of Tooth Root with Supporting Periodontium

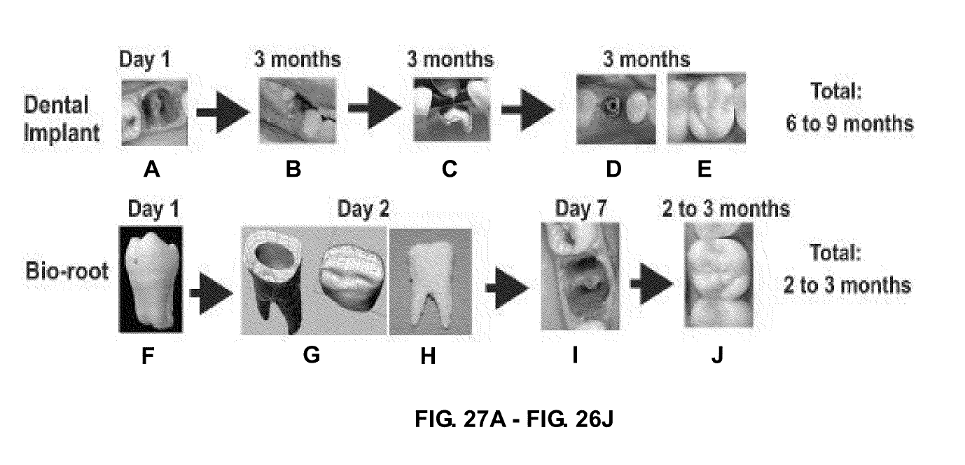

A tooth root-shaped scaffold (e.g., Bio-Root) was produced. Bio-Root was shown to regenerate tooth root with supporting periodontium in one stage. Bio-Root has the following distinctive advantages over titanium dental implants. First, Bio-Root regenerates tooth root (e.g., dentin, cementum) and alveolar bone all in one stage so treatment time is substantially reduced (see e.g., FIG. 27, Table 3). Second, Bio-Root can be 3D-printed specifically for a given patient so that surgical complexity is minimized. Third, Bio-Root can grow in the alveolar bone of a growing child (e.g., adolescent) and provide proprioceptive sensation without which bone resorption and trauma occur. Titanium dental implants have been contra-indicated in a child because the implant can become submerged in the growing alveolar bone (see e.g., Table 3). Fourth, Bio-Root is vascularized and innervated with nociception and proprioception without which bone resorption and trauma may occur, as with titanium dental implants. Finally, Bio-Root will likely cost less than current titanium implants and ancillary procedures such as bone grafting which is required in ˜50% of patients.

TABLE 3
Advantages of Bio-Root over titanium dental implants.

| | Titanium | |
|---|---|---|
| | dental implant | Bio-root |
| Materials | Titanium or alloys | Degradable biomaterials |
| Fabrication process | Weeks | 20-30 min per 3D printed |
| | | Bio-root scaffold |
| Biological vitality | No | Yes |
| Bone grafting | Separate procedures | One-stage procedure |
| In a growing patient | Contra-indicated | Designed to grow and |
| (e.g., child) | | remodel with host bone |
| Patient specific | No | Yes |
| Esthetic issues | Titanium showing | No |
| | through thin | |
| | labial plate | |
| Metal allergy | Yes | No |
| Self-defense | None | Yes (with angiogenesis) |
| Total # of surgical | 3-Feb | 1 |
| procedures | | |
| Cost | ~$1,250 to $3,500 | ~$18 for biomaterials per Bio- |
| | per implant | Root scaffold |
| Overall duration of | ~6-9 months | 2-3 months |
| therapy | | |

FIG. 27 shows a comparative diagram of the process of using a dental implant and an engineered scaffold. Currently following tooth extraction (see e.g., FIG. 27A) on Day 1 of a patient undergoing a dental implant procedure, the patient waits for approximately three months for the bone to fill the extraction socket (see e.g., FIG. 27B). About 50% of the patients require bone grafting of some kind (see e.g., FIG. 27C), which can a separate surgical procedure. The bone grafts may take approximately another three months to heal sufficiently before placing an implant fixture (see e.g., FIG. 27D). After approximately another three months, an abutment is connected to support a clinical crown (see e.g., FIG. 27E). Instead, in certain embodiments, when a patient is scheduled to have the tooth extracted, CT scans of the contralateral tooth can be readily obtained (see e.g., FIG. 27F). These CT scans can be sent via a secure server to a laboratory for 3D construction and fabrication (see e.g., FIG. 27G) of an anatomically correct tooth scaffold. This could potentially take 20-40 minutes. The scaffold (see e.g., FIG. 27H) can be sterilized, packaged, and shipped to a dental office by an express mail service. Upon tooth extraction (see e.g., FIG. 27I), the anatomically correct tooth scaffold is implanted in the tooth extraction socket. Regeneration of the root, periodontal ligament, and alveolar bone may take 2-3 months (see e.g., FIG. 27J), followed by connection of a clinical crown.

Regeneration of Tooth Root and Periodontium in 3D Printed Scaffolds with Induction of Endogenous Stem/Progenitor Cell Homing.

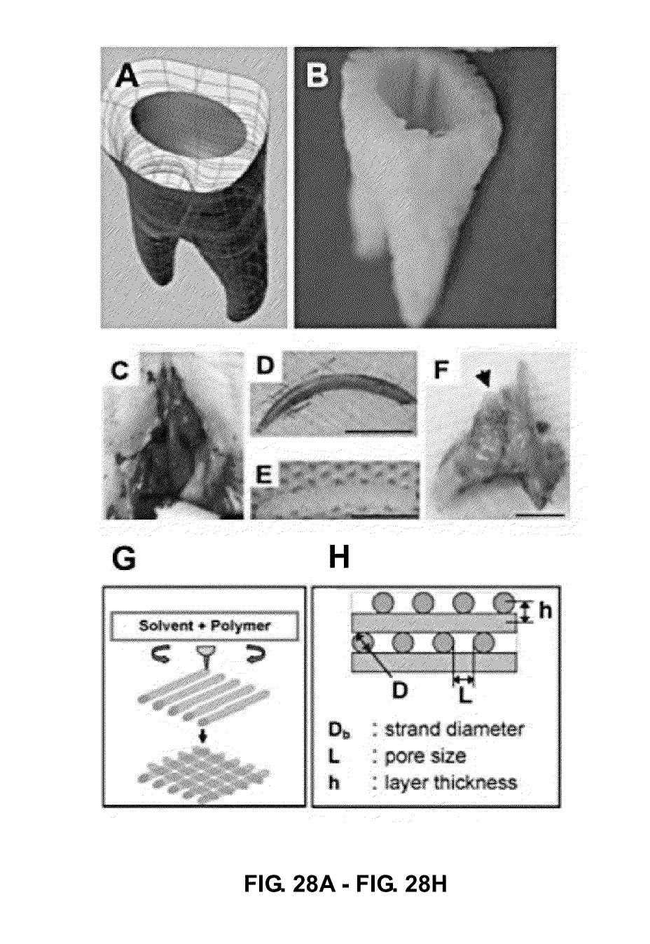

3D printed biomaterial scaffolds, either patient-specific or generic, for tooth root and periodontium regeneration was developed from poly-ε-caprolactone (PCL) and hydroxyapatite (see e.g., FIG. 28). Volumetric characteristics of the root of a natural tooth can be readily obtained by cone-beam CT or MRI scans and reconstructed. A 3D tooth root can be faithfully printed layer-by-layer using a broad range of biomaterials with resolution in the range of 10-100 μm. A pulp chamber and root canal can be 3D-printed and this can be readily replaced with thread for connection of a prosthetic clinical crown. Biophysical characteristics of 3D printing can be readily manipulated for optimal in vivo regeneration of tooth roots and periodontium, as well as other tissues, including polymer type, surface properties, strand diameter, pore size, and layer thickness. A multiphase periodontium scaffold was 3D-printed with cementum as Phase a (see e.g., FIG. 21B), periodontal ligament (PDL) as Phase b (see e.g., FIG. 21B) and alveolar bone as Phase c (see e.g., FIG. 21C), each phase with different channel diameters optimized for regeneration of the cementum, PDL, and alveolar bone. Recombinant human amelogenin, connective tissue growth factor, and bone morphogenetic protein-2 were microencapsulated in PLG microspheres and delivered to Phases a, b, and c, respectively to induce regeneration of the cementum, PDL, and alveolar bone (see e.g., FIG. 21).

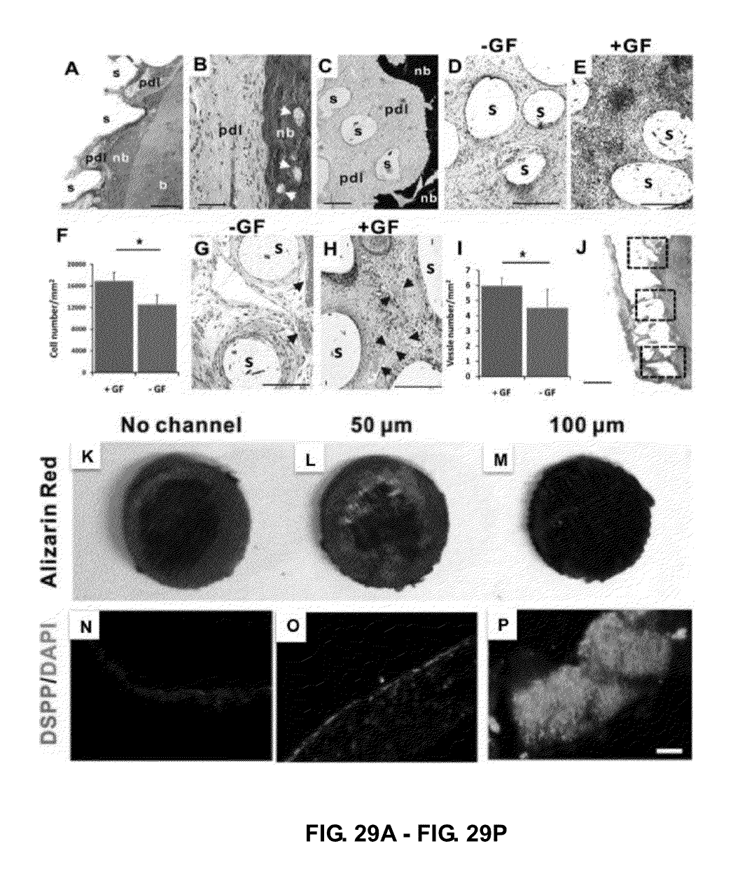

Certain 3D printed anatomically correct biomaterial scaffolds were developed for the regeneration of craniofacial and musculoskeletal structures in small and large animal models. FIG. 28 shows 3D printed biomaterial scaffolds from a composite of two FDA approved materials, poly-ε-caprolactone (PCL) and hydroxyapatite, either patient-specific or generic, for tooth root and periodontium regeneration. Volumetric characteristics of the root of a natural tooth and periodontium can be readily obtained by clinically available cone-beam CT or MRI scans and reconstructed (see e.g., FIG. 28A). A 3D tooth root can be faithfully printed layer-by-layer using a broad range of biomaterials with resolution in the range of 10-100 μm (see e.g., FIG. 28B). A pulp chamber and root canal was 3D-printed in this case (see e.g., FIG. 28B) but can be readily replaced with mechanisms for connecting a prosthetic clinical crown. Rat mandibular incisors were extracted atraumatically (see e.g., FIG. 28C, FIG. 28D), and replaced by 3D printed, anatomically correct biomaterial scaffolds (see e.g., FIG. 28E). A tooth root regenerated in 8 weeks in vivo (see e.g., arrow in FIG. 28F) with specific histologic features as described in FIG. 29. Biophysical characteristics of 3D printed biomaterial scaffolds can be readily manipulated for optimal in vivo regeneration of tooth roots and periodontium including polymer type, surface properties, strand diameter, pore size, and layer thickness (see e.g., FIG. 28G). A multiphase periodontium scaffold was 3D-printed with intended cementum portion as Phase a (see e.g., FIG. 21A), intended periodontal ligament (PDL) portion as Phase b (see e.g., FIG. 21B) and the intended alveolar bone portion as Phase c (see e.g., FIG. 21C), each phase with different channel diameters optimized for regeneration of the cementum, PDL and alveolar bone. Recombinant human amelogenin, connective tissue growth factor, and bone morphogenetic protein-2 were encapsulated in PLG microspheres and delivered to Phases a, b, and c, respectively to induce regeneration of the cementum, PDL and alveolar bone (see e.g., FIG. 21).

Regenerated tooth root and periodontium in 3D printed biomaterial scaffold are characterized by existing alveolar bone (b), and newly formed alveolar bone (nb) adjacent to a periodontal ligament-like structure (pdl) (see e.g., FIG. 29A). The regenerated PDL consisted of fibroblast-like cells and collagen fibers (see e.g., FIG. 29B). The newly regenerated alveolar bone is mineralized with lacunae and osteocytes, whereas the regenerated PDL is not mineralized (see e.g., FIG. 3B), which is further confirmed by von Kossa staining (see e.g., FIG. 29C). Abundant cells from host endogenous sources were recruited into microchannels of 3D-printed scaffolds, even without growth factor (GF) delivery (see e.g., FIG. 29D). Marked recruitment of host endogenous cells was induced by growth factors (GF), namely BMP7 that was delivered in 3D printed scaffolds (see e.g., FIG. 29E). Quantitatively, more cells were recruited into 3D printed scaffolds upon growth factor delivery than without (see e.g., FIG. 29F). The newly formed bone is vascularized with or without growth factor delivery, although growth factor delivery induced more blood vessels (see e.g., FIG. 29H), further confirmed quantitatively by blood vessel numbers (see e.g., FIG. 29I). Multiple tissue samples were harvested and analyzed from coronal, apex and mid-root levels to minimize bias (see e.g., FIG. 29J). Alizarin red staining of mineralization in microchannels of 3D printed tooth-root scaffold showed remarkably robust mineralization in scaffolds with 100 μm channel diameter, relative to scaffolds with no microchannels or 10 μm channels, suggesting that microchannel diameter alone can affect mineralization outcome (see e.g., FIG. 29K, FIG. 29L, and FIG. 29M). Dentin sialophosphoprotein (DSPP) was robustly expressed with 100 μm channel diameter scaffolds (see e.g., FIG. 29P) relative to scaffolds with no microchannels or 10 μm channel diameter (see e.g., FIG. 29N, FIG. 29O), suggesting that scaffold's biophysical properties alone, such as channel diameter, affect de novo dentin formation and biomineralization without delivery of growth factors or cells. Together, these findings provide original evidence of tooth root and periodontium regeneration by 3D printed biomaterial scaffolds.

Induction of Periodontal Regeneration in a Preclinical, Large Animal Model.

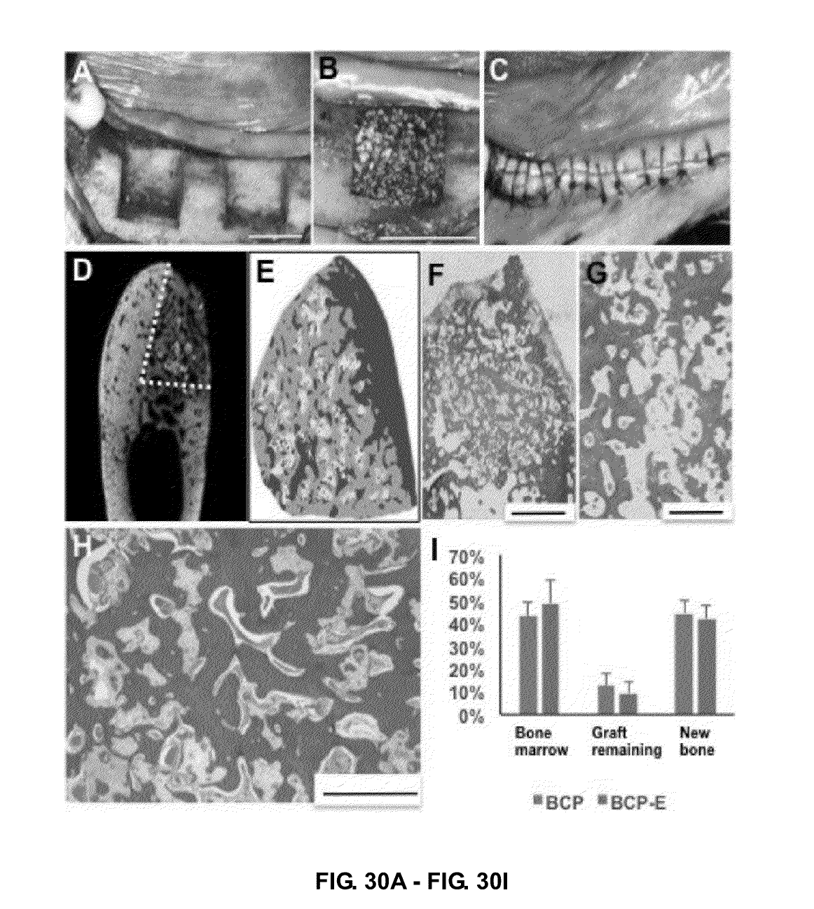

Novel biomaterial formulations induced periodontal regeneration in a preclinical, large animal model. Tissue regeneration experiments were performed in several preclinical, large animal models including pigs, sheep, and dogs. For example, the efficacy of biphasic calcium phosphate (BCP), a classic bone graft material but with a proprietary formulation, was compared in periodontal regeneration with or without delivery of enamel matrix derivatives (EMD) (see e.g., FIG. 30E) in critical-size periodontal bone defects in dentally and skeletally mature dogs (see e.g., FIG. 30).

Critical-size periodontal bone defects (5×7 mm) were created in the alveolar bone of the mandible for two months to simulate clinical conditions. Two months later, BCP particulates were delivered to the defects, followed by primary closure. Following 3 months, bone regenerated and completely filled the defect. Representative μCT scans showed mineralized bone, remaining graft material undergoing degradation, and soft tissues (bone marrow and gingiva in red) (see e.g., FIG. 30E). Histologic images of BCP alone samples showed robust trabecular bone regenerated with bone marrow, which is crucial for long-term homeostasis of healthy or regenerated bone. Quantitative μCT analysis showed that BCP alone and BCP with EMD delivery yielded approximately equal volumes of bone and bone marrow (no statistically significant differences with or without EMD) (see e.g., FIG. 30I), suggesting that BCP alone may have sufficient clinical efficacy without the need of delivery of any biologics including growth factors or cells. 3D printing of BCP powder into anatomically correct structures has been performed in preparation of a large animal study.

FIG. 30 shows periodontal bone regeneration in a large animal (dog) model by biomaterial scaffold alone (no growth factor or stem cell delivery). FIG. 30A shows that critical-size periodontal bone defects (5×7 mm) created in dog mandible. FIG. 30B shows biphasic calcium phosphate, with proprietary formulation, particulates were placed in defects, followed by primary closure (see e.g., FIG. 30C). FIG. 30D shows that regenerated bone completely filled the defect. FIG. 30E shows a representative μCT scan showing mineralized bone (green), remaining graft material undergoing degradation (yellow) and soft tissues (bone marrow and gingiva (red). FIG. FIG. 30F, FIG. 30G, and FIG. 30H are histologic images of increasing power showing trabecular bone formation with bone marrow, which is critical for long-term homeostasis of regenerated bone. FIG. 30I demonstrates the quantitative outcome from consecutive μCT scans and analysis. BCP with or with enamel matrix derivatives (E) induced the regeneration of approximately equal volume of bone and bone marrow, both significantly larger than the amount of graft material undergoing degradation. Importantly, BCP showed bone regeneration efficacy that lacked statistically significant differences from BCP with EMD, suggesting that in certain instances, BCP alone may have sufficient clinical efficacy.

Summary.

The above examples described discoveries that tooth root and periodontium structures, including periodontal ligament and alveolar bone, regenerated in 3D printed biomaterial scaffolds. In some cases, biomaterial scaffolds alone were sufficient to have regenerated new bone and filled periodontal defects without delivery of growth factors, and without the need for cell delivery. Multiple tooth root and periodontium regeneration studies were performed in multiple species including mice, rats, rabbits, dogs, pigs, and sheep. The examples have shown regeneration of vascularized and innervated tooth root and periodontium structures in large animal models. Several biomaterial scaffolds were formulated with or without imbedded growth factor proteins.

Conditions for shipping, handling, storage, bioactivity loss/compensation and shelf life of protein cues have been determined.

### REFERENCES

Alberektsson T and Johansson C 2001 Osteoinduction, osteoconduction and osseointegration Eur. Spine J. 10 Suppl. 2 S96-101.

Alhadlaq, A. and Mao, J. (2004). “Adult stem cell driven genesis of human-shaped articular condyle.” Ann Biomed Eng 32(7):911-23.

Alhadlaq, A. and Mao, J. (2005). “Tissue-engineered osteochondral constructs in the shape of an articular condyle.” J Bone Joint Surg Am 87(5): 936-44.

Alhadlaq, A., Elisseeff, J. H., Hong, L., Williams, C. G., Caplan, A. I., Sharma, B., et al. Adult stem cell driven genesis of human-shaped articular condyle. Ann Biomed Eng 32, 911, 2004.

Alpaslan C, Irie K, Takahashi K, Ohashi N, Sakai H, Nakajima T, Ozawa H (1996) Long-term evaluation of recombinant human bone morphogenetic protein-2 induced bone formation with a biologic and synthetic delivery system. Br J of Oral Maxillofac Surg 34, 414-418.

Amar S, Han X. The impact of periodontal infection on systemic diseases. Med Sci Monit 2003; 9: RA291-RA299.

Amar S. Implications of cellular and molecular biology advances in periodontal regeneration. Anat Rec 1996: 245: 361-373.

Aoki H, Fujii M, Imamura T, Yagi K, Takehara K, Kato M and Miyazono K (2001) Synergistic effects of different bone morphogenetic protein type I receptors on alkaline phosphatase induction J. Cell. Sci. 114 1483-9.

Aono A, Hazama M, Notoya K, Taketomi S, Yamasaki H, Tsukuda R, Sasaki S and Fujisawa Y (1995) Potent ectopic bone-inducing activity of bone morphogenetic protein-4/7 heterodimer Biochem. Biophys. Res. Commun. 210 670-7.

Arceo N, Saulk J J, Moehring J, Foster R A, Somerman M J. Human periodontal cells initiate mineral like nodules in vitro. J Periodontol 1991: 62: 499-503.

Artico M, Ferrante L, Pastore F S, Ramundo E O, Cantarelli D, Scopelliti D and Iannetti G (2003) Bone autografting of the calvaria and craniofacial skeleton: historical background, surgical results in a series of 15 patients, and review of the literature Surg. Neural 60 71-9.

Arzate H, Chimal-Monroy J, Hernandez-Iagunas L, Diaz de Leon L. Human cementum protein extract promotes chondrogenesis and mineralization in mesenchymal cells. J Periodontal Res 1996: 31: 144-148.

Arzate H, Olsen S W, Page R C, Goan A M, Narayanan A S. Production of a monoclonal antibody to an attachment protein derived from human cementum. FASEB J 1992: 6: 2990-2996.

Ashman A, LoPinto J, Rosenlicht J. Ridge augmentation for immediate postextraction implants: eight year retrospective study. Pract Periodontics Aesthet Dent 1995: 7: 85-94.

Astrand P, Carlsson G, Changes in the alveolar process after extractions in the white rat. A histologic and fluorescence microscopic study. Acta Odontol. Scand. 27 1 (1969), pp. 113-127.

Atala A, Bauer S B, Soker S, Yoo J J, Retik A B. Tissueengineered autologous bladders for patients needing cystoplasty. Lancet 2006; 367: 1241-6.

Bae, C. H., Kim, T. H., Chu, J. Y., and Cho, E. S. New pop-ulation of odontoblasts responsible for tooth root formation. Gene Expr Patterns 13, 197, 2013.

Bai, Y., Matsuzaka, K., Hashimoto, S., Fukuyama, T., Wu, L., Miwa, T., et al. Cementum- and periodontal ligament-like tissue formation by dental follicle cell sheets co-cultured with Hertwig's epithelial root sheath cells. Bone 48, 1417, 2011.

Balic A, Mina M. Analysis of developmental potentials of dental pulp in vitro using GFP transgenes. Orthod Craniofac Res 2005: 8: 252-258.

Bansal, A. K., Shetty, D. C., Bindal, R., and Pathak, A. Amelogenin: a novel protein with diverse applications in genetic and molecular profiling. Journal of oral and max-illofacial pathology: JOMFP 16, 395, 2012.

Bartold P M, McCulloch C A, Narayanan A S, Pitaru S. Tissue engineering: a new paradigm for periodontal regeneration based on molecular and cell biology. Periodontol 2000 2000: 24: 253-269.

Bartold P M, Narayanan A S. Molecular and cell biology of healthy and diseased periodontal tissues. Periodontol 2000 2006: 40: 29-49.

Bax B E, Wozney J M, Ashhurst D E (1999) Bone morphogenetic protein-2 increases the rate of callus formation after fracture of the rabbit tibia. Calcif Tissue Int 65, 83-89

Becker W, Becker B E. Periodontal regeneration: a contemporary evaluation. Periodontol 2000 1999: 19: 104-114.

Berkovitz B K B, Holland G R, Moxham B J. Microscopic anatomy of oro-dental tissues. In: Berkovitz B K B, Holland G R, Moxham B J, eds. Color Atlas and Textbook of Oral Anatomy, Histology and Embryology. London: Mosby-Wolfe, 1992; 109-228.

Berry J E, Zhao M, Jin Q, Foster B L, Viswanathan H, Somerman M J. Exploring the origins of cementoblasts and their trigger factors. Connect Tissue Res 2003: 44 (Suppl. 1): 97-102.

Bleul et al. A highly efficacious lymphocyte chemoattractant, stromal cell-derived factor 1 (SDF-I). J. Exp. Med. 184: 1101-1109, 1996.

Bohl K S, Shon J, Rutherford B, Mooney D J. Role of synthetic extracellular matrix in development of engineered dental pulp. Biomater Sci Polymer Ed 1998: 9: 749-764.

Bosshardt D D, Zalzal S, McKee M D, Nanci A. Developmental appearance and distribution of bone sialoprotein and osteopontin in human and rat cementum. Anat Rec 1988: 250: 13-33.

Bosshardt D D. Are cementoblasts a subpopulation of osteoblasts or a unique phenotype? J Dent Res 2005: 84: 390-406.

Boyne P J 2001 Application of bone morphogenetic proteins in the treatment of clinical oral and maxillofacial osseous defects J. Bone Joint Surg. Am. 83A S 146-50.

Braut A, Kollar E J, Mina M. Analysis of the odontogenic and osteogenic potentials of dental pulp in vivo using a collal-2.3-GFP transgene. Int J Dev Biol 2003: 47: 281-292.

Brown A, Stock G, Patel A A, Okafor C and Vaccaro A 2006 Osteogenic protein-1: a review of its utility in spinal applications Biodrugs 20 243-51.

Burns J S, Abdallah B M, Guldberg P, Rygaard J, Schroder H D, Kassem M. Tumorigenic heterogeneity in cancer stem cells evolved from long-term cultures of telomeraseimmortalized human mesenchymal stem cells. Cancer Res 2005: 65: 3126-3135.

Carlisle E and Fischgrund J S 2005 Bone morphogenetic proteins for spinal fusion. Spine J. 55 240-9.

Carlo Reis, E. C., Borges, A. P., Araujo, M. V., Mendes, V. C., Guan, L., and Davies, J. E. Periodontal regeneration using a bilayered PLGA/calcium phosphate construct. Biomaterials 32, 9244, 2011.

Carlson N E, Roach R B. Platelet-rich plasma: clinical applications in dentistry. J Am Dent Assoc 2002: 133: 1383-1386.

Castro-Malaspina H, Gay R E, Resnick G, Kapoor N, Meyers P, Chiarieri D, McKenzie S, Broxmeyer H E, Moore M A. Characterization of human bone marrow fibroblast colonyforming cells (CFU-F) and their progeny. Blood 1980: 56: 289-301.

Castro-Malaspina H, Rabellino E M, Yen A, Nachman R L, Moore M A. Human megakaryocyte stimulation of proliferation of bone marrow fibroblasts. Blood 1981: 57: 781-787.

Causa F, Netti A, Ambrosio G, Ciapetti G, Baldini N, Pagani S, Martini D, Giunti Poly-B-caprolactone/hydroxyapatite composites for bone regeneration: In vitro characterization and human osteoblast response, 2005, Journal of Biomedical Materials Research Part A 76A(I): 151-162.

Chai Y, Jiang X, Ito Y et al. Fate of the mammalian cranial neural crest during tooth and mandibular morphogenesis. Development 2000; 127: 1671-9.

Chai Y, Slavkin H C. Prospects for tooth regeneration in the 21st century: a perspective. Microsc Res Tech 2003; 60: 469-79.

Chen D, Harris M A, Rossini G, Dunstan C R, Dallas S L, Feng J Q, Mundy G R and Harris S E 1997 Bone morphogenetic protein 2 (BMP-2) enhances BMP-3, BMP-4, and bone cell differentiation marker gene expression during the induction of mineralized bone matrix formation in cultures of fetal rat calvarial osteoblasts Calcif. Tissue Int. 60 283-90.

Chen, D., Zhao, M., and Mundy, G. R. Bone morphogenetic proteins. Growth Factors 22, 233, 2004.

Cheng, H., Jiang, W., Phillips, F. M., Haydon, R. C., Peng, Y., Zhou, L., Luu, H. H., An, N., Breyer, B., Vanichakarn, P., Szatkowski, J. P., Park, J. Y., and He, T. C. Osteogenic activity of the fourteen types of human bone morphogenetic proteins (BMPs). J. Bone. Joint. Surg. Am. 85 A, 1544, 2003.

Chim, H., and Schantz, J. T. Human circulating peripheral blood mononuclear cells for calvarial bone tissue engineering. Plast. Reconstr. Surg. 116, 1726, 2006.

Chim, H., Hutmacher, D. W., Chou, A. M., Oliveira, A. L., Reis, R. L., Lim, T. C, and Schantz, J. T. A comparative analysis of scaffold material modifications for load-bearing applications in bone tissue engineering. Int. J. Oral Maxillofac. Surg. 35, 923, 2006.

Chim, H., Ong, J. L., Schantz, J. T., Hutmacher, D. W., and Agrawal, C M. Efficacy of glow discharge gas plasma treatment as a surface modification process for three-dimensional poly (D/L-lactide) scaffolds. J. Biomed. Mater. Res. A 65, 327, 2003.

Cho M I, Matsuda N, Lin W L, Moshier A, Ramakrishnan P R. In vitro formation of mineralized nodules by periodontal ligament cells from the rat. Calcif Tissue Int 1992: 50: 459-467.

Choi R S, Riegler M, Pothoulakis C, Kim B S, Mooney D, Vacanti M, Vacanti J P. Studies of brush border enzymes, basement membrane components, and electrophysiology of tissue-engineered neointestine, J. of Ped. Surg. 33(7):991-996.

Chopp M, Zhang X H, Li Y, Wang L, Chen J, Lu D, Lu M, Rosenblum M. Spinal cord injury in rat: treatment with bone marrow stromal cell transplantation. Neuroreport 2000: 11: 3001-3005.

Claveau I, Mostefaoui Y and Rouabhia M 2004 Basement membrane protein and matrix metalloproteinase deregulation in engineered human oral mucosa following infection with Candida albicans Matrix Biol. 23 477-86.

Crane, G. M., Ishaug, S. L., and Mikos, A. G. Bone tissue engineering. Nat. Med. 12, 1322, 1995.

Dangaria, S. J., Ito, Y., Yin, L., Valdre, G., Luan, X., and Diekwisch, T. G. Apatite microtopographies instruct sig-naling tapestries for progenitor-driven new attachment of teeth. Tissue Eng Part A 17, 279, 2011.

De Wynter E A, Emmerson A J, Testa N G. Properties of peripheral blood and cord blood stem cells. Baillieres Best Pract Res Clin Haematol 1999: 12: 1-17.

Deans R J, Moseley A B. Mesenchymal stem cells: biology and potential clinical uses. Exp Hematol 2000: 28: 875-884.

Denizot F and Lang R 1986 Rapid colorimetric assay for cell growth and survival. Modifications to the tetrazolium dye procedure giving improved sensitivity and reliability J. Immunol. Methods 89 271-7.

D'Errico J A, Ouyang H, Berry J E, MacNeil R L, Strayhorn C, Imperiale M J, Harris N L, Goldberg H, Somerman M J. Immortalized cementoblasts and periodontal ligament cells in culture. Bone 1999: 25: 39-47.

Desbois C and Karsenty G 1995 Osteocalcin cluster: implications for functional studies J. Cell. Biochem. 57 379-83.

Dua H S, Azuara-Blanco A. Limbal stem cells of the corneal epithelium. Sury Ophthalmol 2000: 44: 415-425. [0168] Duailibi et al. Long-term case history reports. J Oral Implantol 2000: 26: 276-290.

Duailibi M T, Duailibi S E, Young C S, Bartlett J D, Vacanti J P, Yelick P C. Bioengineered teeth from cultured rat tooth bud cells. J Dent Res 2004: 83: 523-528.

Duailibi S E, Duailibi M T, Vacanti J P, Yelick P C. Prospects for tooth regeneration. Periodontology 2000. 2006; 41: 177-87.

Elsubeihi E, Heersche J, Quantitative assessment of post-extraction healing and alveolar ridge remodelling of the mandible in female rats, Archives of Oral Biology 2004, 49:5, p 401-412.

Emerton, K. B., Drapeau, S. J., Prasad, H., Rohrer, M., Roffe, P., Hopper, K., et al. Regeneration of periodontal tissues in non-human primates with rhGDF-5 and beta-tri-calcium phosphate. J Dent Res 90, 1416, 2011

Engler, A. J., Sen, S., Sweeney, H. L., and Discher, D. E. Matrix elasticity directs stem cell lineage specification. Cell 126, 677, 2006.

Eppley B L, Pietrzak W S and Blanton M W 2005 Allograft and alloplastic bone substitutes: a review of science and technology for the craniomaxillofacial surgeon. J. Craniofac. Surg. 16 981-9.

Fenton A H, Zarb G A, MacKay H F. Overdenture oversights. Dent Clin North Am 1979: 23: 117-130.

Fibbe, W. E., Pruijt, J. F., van Kooyk, Y., Figdor, C. G., Opdenakker, G., and Wille, R. The role of metalloproteinases and adhesion molecules in interlukin-8-induced stem cell mobilization. Semin. Hematol. 37, 19, 2000.

Fiedler, J., Leucht, F., Waltenberger, J., Dehio, C, and Brenner, R. E. VEGF-A and PIGF-I stimulate chemotactic migration of human mesenchymal progenitor cells. Biochem. Biophys. Res. Commun. 334, 561, 2005.

Fong H K, Foster B L, Popowics T E, Somerman M J. The crowning achievement: getting to the root of the problem. J Dent Educ 2005; 69: 555-70.

Friedenstein A J, Ivanov-Smolenski A A, Chajlakjan R K, Gorskaya U F, Kuralesova A I, Latzinik N W, Geraswimow U W. Origin of bone marrow stromal mechanocytes in radiochimeras and heterotopic transplants. Exp Hematol 1978: 6: 440-444.

Friedenstein A J. Precursor cells of mechanocytes. Int Rev Cytol 1976: 47: 327-359.

Fuchs J R, Hannouche D, Terada S, Vacanti J P, Fauza D O. Fetal tracheal augmentation with cartilage engineered from bone marrow-derived mesenchymal progenitor cells. J Pediatr Surg 2003: 38: 984-987.

Fujiwara N, Tabata M J, Endoh M, Ishizeki K, Nawa T. Insulin-like growth factor-I stimulates cell proliferation in the outer layer of Hertwig's epithelial root sheath and elongation of the tooth root in mouse molars in vitro. Cell Tissue Res 2005; 320: 69-75.

Gazdag A R, Lane J M, Glaser D. Alternatives to autogenous bone graft: Efficacy and indication. J Am Acad Orthop Surg 1995; 3:I-8.

Gazzerro E, Rydziel S and Canalis E 1999 Skeletal bone morphogenetic proteins suppress the expression of collagenase-3 by rat osteoblasts Endocrinology 140 562-7.

Geiger M, Li R H and Friess W 2003 Collagen sponges for bone regeneration with rhBMP-2 Adv. Drug Deliv. Rev. 55 1613-29.

Giannobile W V, Lee C S, Tomala M P, Tejeda K M, Zhu Z. Platelet-derived growth factor (PDGF) gene delivery for application in periodontal tissue engineering. J Periodontol 2001: 72: 815-823.

Giannobile W V. Periodontal tissue engineering by growth factors. Bone 1996: 19: 23S-37S.

Giannoudis P V and Tzioupis C 2005 Clinical applications of BMP-7: the UK perspective Injury 36 Suppl. 3 S47-50.

Giannoudis P V, Dinopoulos H and Tsiridis E 2005 Bone substitutes: an update Injury 36 Suppl. 3 S20-7.

Gojo S, Gojo N, Takeda Y, Mori T, Abe H, Kyo S, Hata J, Umezawa A. In vivo cardiovasculogenesis by direct injection of isolated adult mesenchymal stem cells. Exp Cell Res 2003: 288: 51-59.

Griffith, L. G., and Naughton, G. Tissue engineering—current challenges and expanding opportunities. Science 295, 1009, 2002.

Groeneveld E H and Burger E H 2000 Bone morphogenetic proteins in human bone regeneration Eur. J. Endocrinol. 142 9-21.

Gronthos S, Chen S, Wang C Y, Robey P G, Shi S. Telomerase accelerates osteogenesis of bone marrow stromal stem cells by upregulation of CBFAI, osterix, and osteocalcin. J Bone Miner Res 2003: 18: 716-722.

Gronthos S, Graves S E, Ohta S, Simmons P J. The STRO-1+ fraction of adult human bone marrow contains the osteogenic precursors. Blood 1994: 84: 4164-4173.

Gronthos S, Mankani M, Brahim J, Gehron Robey P, Shi S. Postnatal human dental pulp stem cells (DPSCs) in vitro and in vivo. Proc Natl Acad Sci USA 2000: 97: 13625-13630.

Gronthos S, Zannettino AC, Graves S E, Ohta S, Hay S J, Simmons P J. Differential cell surface expression of the STRO-I and alkaline phosphatase antigens on discrete developmental stages in primary cultures of human bone cells. J Bone Miner Res 1999: 14: 47-56.

Gronthos S, Zannettino A C, Hay S J, Shi S, Graves S E, Kaortesidis A, Simmons

PJ. Molecular and cellular characterization of highly purified stromal stem cells derived from human bone marrow. J Cell Sci 2003: 116: 1827-1835.

Guglielmotti M, Cabrini R, Alveolar wound healing and ridge remodeling after tooth extraction in the rat: a histologic, radiographic, and histometric study. J. Oral Maxillofac. Surg. 43 5 (1985), pp. 359-364.

Harada H, Mitsuyasu T, Toyono T, Toyoshima K. Epithelial stem cells in teeth. Odontology 2002; 90: 1-6.

Harada H, Ohshima H. New perspectives on tooth development and the dental stem cell niche. Arch Histol Cytol 2004: 67: 1-11.

Hawkins N, Garriga G. Asymmetric cell division: from a toz. Genes Dev 1998: 12: 3625-3638.

Heijl L, Heden G, Sva“rdstro”m G, O” stgren A. Enamel matrix derivative (EMDOGAIN) in the treatment of intrabony periodontal pockets. J Clin Periodontol 1997: 24: 705-714.

Heo S J, Kim S E. Fabrication of porous scaffolds for bone tissue engineering using a 3-D robotic system: Comparison with conventional scaffolds fabricated by particulate leaching. Mol Cell Biol 2007; 3: 179-180.

Herodin, F., Bourin, P., Mayol, J. F., Lataillade, J. J., and Drouet, M. Short-term injection of antiapoptotic cytokine combinations soon after lethal gamma-irradiation promotes survival. Blood. 101: 2609-2616.

Hirooka H. The biologic concept for the use of enamel matrix protein: true periodontal regeneration. Quintessence Int 1998: 9: 621-630.

Hogan B L 1996 Bone morphogenetic proteins: multifunctional regulators of vertebrate development. Genes Dev. 10 1580-94.

Hollinger J O, Uludag J O and Winn S R 1998 Sustained release emphasizing recombinant human bone morphogenetic protein-2 Adv. Drug Deliv. Rev. 31 303-18.

Hollister, S. J. Porous scaffold design for tissue engineering. Nat Mater 4, 518, 2005.

Honda M J, Sumita Y, Kagami H, Ueda M. Histological and immunohistochemical studies of tissue engineered odontogenesis. Arch Histol Cytol 2005: 68: 89-101.

Hong, L., and Mao, J. J. Tissue-engineered rabbit cranial suture from autologous fibroblasts and BMP2. J Dent Res 83, 751, 2004.

Horwitz E M, Gorden P L, Koo W K, Marx J C, Neel M D, McNall R Y, et al. Isolated allogenic bone marrow-derived messenchymal cells engraft and stimulate growth in children with osteogenesis imperfect: implications for cell therapy of bone. Proc Natl Acad Sci USA 2002; 99; 8932-7.

Horwitz E M, Prockop D J, Gordon P L, Fitzpatrick L A, Neel M D, McCarville M E, et al. Clinical responses to bone marrow transplantation in children with severe osteogenesis imperfect. Blood 2001; 97: 1227-31.

Howell T H, Fiorellini J P, Paquette D W, Offenbacher S, Giannobile W V, Lynch S E, A phase I/II clinical trial to evaluate a combination of recombinant human plateletderived growth factor-BB and recombinant insulin-like growth factor in patients with periodontal disease. J Periodontol 1997: 68: 1186-1193.

Hu B, Nadiri A, Bopp-Kuchler S, Perrin-Schmitt F, Lesot H. Dental epithelial histomorphogenesis in vitro. J Dent Res 2005; 84: 521-5.

Hu B, Nadiri A, Kuchler-Bopp S, Perrin-Schmitt F, Peters H, Lesot H. Tissue engineering of tooth crown, root, and periodontium. Tissue Eng 2006; 12: 2069-75.

Hu B, Unda F, Bopp-Kuchler S et al. Bone marrow cells can give rise to ameloblast-like cells. J Dent Res 2006; 85: 416-21.

Huang, G. T., Shagramanova, K., and Chan, S. W. Formation of odontoblast-like cells from cultured human dental pulp cells on dentin in vitro. J Endod 32, 1066, 2006.

Hutmacher D W, Goh J C H, Tech S H. An introduction to biodegradable materials for tissue engineering applications. Ann Acad Med Singapore 2001: 30: 183-191.

Hutmacher D W, Schantz J T, Zein I, Ng K W, Tan K C, Teoh S H Mechanical Properties and Cell Cultural Response of Polycaprolactone Scaffolds Designed and Fabricated via Fused Deposition Modeling. J Biomed Mat Res 2001, 55:203-216.

Huysseune A, Van der heyden C, Sire J Y. Early development of the zebrafish (Danio rerio) pharyngeal dentition (Teleostei, Cyprinidae). Anat Embryol (Berl) 1998: 198: 289-305.

Ikada Y. Tissue engineering research trends at Kyoto University. In: Ikada Y, ed. Tissue Engineering for Therapeutic Use 1. Tokyo: Elsevier, 1998; 1-14.

Ikeda, E., Morita, R., Nakao, K., Ishida, K., Nakamura, T., Takano-Yamamoto, T., et al. Fully functional bioengi-neered tooth replacement as an organ replacement therapy. Proc Natl Acad Sci U S A 106, 13475, 2009.

Isobe M, Yamazaki Y, Mori M, Amagasa T (1999) Bone regeneration produced in rat femur defects by polymer capsules containing recombinant human bone morphogenetic protein-2. J Oral Maxillofac Surg 57, 695-8.

Israel D I, Nove J, Kerns K M, Kaufman R J, Rosen V, Cox K A and Wozney J M (1996) Heterodimeric bone morphogenetic proteins show enhanced activity in vitro and in vivo. Growth Factors 13 291-300.

Ivanovski S, Haase H R, Bartold P M. Expression of bone matrix protein mRNAs by primary and cloned cultures of the regenerative phenotype of human periodontal fibroblasts. J Dent Res 2001: 80: 1665-1671.

Jackman W R, Draper B W, Stock D W. Fgf signaling is required for zebrafish tooth development. Dev Biol 2004: 274: 139-157.

Jernvall J, Thesleff I. Reiterative signaling and patterning during mammalian tooth morphogenesis. Mech Dev 2000: 92: 19-29.

Jin Q M, Anusaksathien O, Webb S A, Printz M A, Giannobile W V. Engineering of tooth supporting structures by delivery of PDGF gene therapy vectors. Mol Ther 2004: 9: 519-526.

Jin Q M, Anusaksathien O, Webb S A, Rutherford R B, Giannobile W V. Gene therapy of bone morphogenetic protein for periodontal tissue engineering. J Periodontol 2003: 74: 202-213.

Jin Q M, Zhao M, Webb S A, Berry J E, Somerman M J, Giannobile W V. Cementum engineering with threedimensional polymer scaffolds. J Biomed Mater Res A 2003: 67: 54-60.

Jorgensen C, Gordeladze J, Noel D. Tissue engineering through autologous mesenchymal stem cells. Current Opin Biotechnol 2004: 15: 406-410.

Kaigler D, Mooney D J. Tissue engineering impact on dentistry. J Dent Educ 2001: 65: 456-462.

Kang Q et al 2004 Characterization of the distinct orthotopic bone-forming activity of 14 BMPs using recombinant adeno virus-mediated gene delivery Gene Ther. 11 1312-20.

Karring T, Nyman S, Gottlow J, Laurell L. Development of the biological concept of guided tissue regenerationanimal and human studies. Periodontal 2000 1993: 1: 26-35.

Katchburian E, Arana V. Histologia e Embriologia Oral, 2nd edn. Brazil: Editorial Medica Panamericana. Guanabara Koogan, 2005: 151-179.

Kato M, Toyoda H, Namikawa T, Hoshino M, Terai H, Miyamoto S and Takaoka K 2006 Optimized use of a biodegradable polymer as a carrier material for the local delivery of recombinant human bone morphogenetic protein-2 (rhBMP-2) Biomaterials 27 2035-41.

Kawano S, Saito M, Handa K, Morotomi T, Toyono T, Seta Y, Nakamura N, Uchida T, Toyoshima K, Ohishi M, Harada H. Characterization of dental epithelial progenitor cells derived from cervical-loop epithelium in a rat lower incisor. J Dent Res 2004: 83: 129-133.

Kenley R A, Yim K, Abrams J, Ron E, Turek T, Marden L J and Hollinger J O 1993 Biotechnology and bone graft substitutes Pharm. Res 10 1393-401.

Kim B S. Development of biocompatible synthetic extracellular matrices for tissue engineering. Trends Biotechnol 2001; 16: 224-230.

Kim H W, Jonathan C. Hydroxyapatite/PCL composite coatings on hydroxyapatite porous bone scaffold for drug delivery. Biomaterials 2004; 25: 1279-1287.

Kim J, Amar S. Periodontal disease and systemic conditions: a bidirectional relationship. Odontology 2006; 94: 10-21.

Kim S S, Utsunomiya H, Koski J A, Wu B M, Cima M J, Sohn J, Mukai K, Griffith L G, Vacanti J P. Survival and function of hepatocytes on a novel three dimensional synthetic biodegradable polymer scaffold with an intrinsic network of channels. Ann Surg 1998: 28: 8-13.

Kim S S, Vacanti J P. The current status of tissue engineering as potential therapy. Semin Pediatr Surg 1999: 8: 119-123.

Kim, C. H., and Broxmeyer, H. E. In vitro behavior of hematopoietic progenitor cells under the influence of chemoattractants: stromal cell-derived factor-1, steel factor, and the bone marrow environment. Blood 91, 100, 1998.

Kim, J., and Amar, S. Periodontal disease and systemic conditions: a bidirectional relationship. Odontology 94, 10, 2006.

Kim, K., Lee, C. H., Kim, B. K., and Mao, J. J. Anatomically shaped tooth and periodontal regeneration by cell homing. J Dent Res 89, 842, 2010.

Kim, T. H., Bae, C. H., Lee, J. C., Ko, S. O., Yang, X., Jiang, R., et al. beta-catenin is required in odontoblasts for tooth root formation. J Dent Res 92, 215, 2013.

Koempel J A, Patt B S, O'Grady K, Wozney J, Toriumi D M (1998) The effect of recombinant human bone morphogenetic protein-2 on the integration of porous hydroxyapatite implants with bone. J Biomed Mater Res 41, 359-363.

Koh Y H, Jun I K, Kim H E. Fabrication of poly ε-caprolactone/hydroxyapatite scaffold using rapid direct deposition. Materials Letters 2006: Vol. 60: Issues 9-10: 1184-1187.

Kollet, O., Shivtiel, S., Chen, Y. Q., Suriawinata, J., Thung, S. N., Dabeva, M. D., Kahn, J., Spiegel, A., Dar, A., Samira, S.,Goichberg, P., Kalinkovich, A., Arenzana-Seisdedos, F., Nagler, A., Hardan, L, Revel, M., Shafritz, D. A., and Lapidot, T. HGF, SDF-I and MMP-9 are involved in stress-induced CD34p stem cell recruitment to the liver. J. Clin. Invest. 112, 160, 2003.

Kortesidis, A., Zannettino, A., Isenmann, S., Shi, S., Lapidot, T., and Gronthos, S. Stromal-derived factor-1 promotes the growth, survival, and development of human bone marrow stromal stem cells. Blood 105, 3793, 2005.

Krebsbach P H, Mankani M H, Satomura K, Kuznetsov S A, Robey P G. Repair of craniotomy defects using bone marrow stromal cells. Transplantation 1998: 66: 1272-1278.

Kuboki Y, Saito T, Murata M, Takita H, Mizuno M, Inoue M, Nagai N, Poole A R (1995) Two distinctive BMP-carriers induce zonal chondrogenesis and membranous ossification, respectively; geometrical factors of matrices for cell-differentiation. Connect Tissue Res 32, 219-226

Kucia, M., Reca, R., Miekus, K., Wanzeck, J., Wojakowski,W., Janowska-Wieczorek, A., Ratajczak, J., and Ratajczak, M. Z. Trafficking of normal stem cells and metastasis of cancer stem cells involve similar mechanisms: pivotal role of the SDF-1-CXCR4 axis. Stem Cells 23, 879, 2005.

Laflamme C, Mahmoud R. Effect of BMP-2 and BMP-7 homodimers and a mixture of BMP-2/BMP-7 homodimers on osteoblast adhesion and growth following culture on a collagen scaffold, 2008 Biomed. Mater. 3 015008 (IOpp)

Landers, R., Pfister, A. (2005). Rapid prototyping in medicine. Internal Report, EnvisionTec, Germany.

Landers, R., U. Hubner, et al. (2002). “Rapid prototyping of scaffolds derived from thermoreversible hydrogels and tailored for applications in tissue engineering.” Biomaterials 23(23): 4437-47.

Lang H, Schu”ler N, Nolden R. Attachment formation following replantation of cultured cells into periodontal defects. J Dent Res 1998: 77: 393-405.

Langer R, Vacanti J P. Tissue engineering. Science 1993: 260: 920-926.

Lapidot, T., and Petit, I. Current understanding of stem cell mobilization: the roles of chemokines, proteolytic enzymes, adhesion molecules, cytokines, and stromal cells. Exp. Hematol. 30, 973, 2002.

Laurell L, Gottlow J. Guided tissue regeneration update. Int J Dent 1998: 48: 386-398.

Lee, C. H., Cook, J. L., Mendelson, A., Moioli, E. K., Yao, H., and Mao, J. J. Regeneration of the articular surface of the rabbit synovial joint by cell homing: a proof of concept study. Lancet 376, 440, 2010.

Lee, C. H., Marion, N. W., Hollister, S., and Mao, J. J. Tissue formation and vascularization in anatomically shaped hu [symbol] man joint condyle ectopically in vivo. Tissue Eng Part A 15, 3923, 2009.

Lee, C. H., Shah, B., Moioli, E. K., and Mao, J. J. CTGF directs fibroblast differentiation from human mesenchymal stem/stromal cells and defines connective tissue healing in a rodent injury model. J Clin Invest 120, 3340, 2010.

Lee, C. H., Shin, H. J., Cho, I. H., Kang, Y. M., Kim, I. A., Park, K. D., et al. Nanofiber alignment and direction of mechanical strain affect the ECM production of human ACL fibroblast. Biomaterials 26, 1261, 2005.

Lekic P, McCulloch C A. Periodontal ligament cell population: the central role of fibroblasts in creating a unique tissue. Anat Rec 1996: 245: 327-341.

Leong K F. Solid freeform fabrication of three-dimensional scaffolds for engineering replacement tissues and organs. Biomaterials 2003; 24:2363-2378.

Li, Y., Jin, F., Du, Y., Ma, Z., Li, F., Wu, G., et al. Ce-mentum and periodontal ligament-like tissue formation induced using bioengineered dentin. Tissue Eng Part A 14, 1731, 2008.

Lijun K, Yuan G, Guangyuan L. A study on the bioactivity of chitosan/nano-hydroxyapatite composite scaffolds for bone tissue engineering. Eur Polym J 2006; 42:3171-3179.

Lin H. The self-renewing mechanism of stem cells in the germ line. Curr Opin Cell Biol 1998: 10: 687-693.

Lindskog S. Formation of intermediate cementum. I. Early mineralization of aprismatic enamel and intermediate cementum in monkey. J Cranio fac Genet Dev Biol 1982: 2: 147-160.

Liu H W, Chen C H, Tsai C L and Hsiue G H 2006 Targeted delivery system for juxtacrine signaling growth factor based on rhBMP-2-mediated carrier-protein conjugation. Bone 39 825-36.

Lu L., Stamatas G., Mikos A, Controlled release of transforming growth factor βI from biodegradable polymer microparticles, J. of Biomedical Materials Res. Part A., Volume 50, Issue 3, Pages 440-451.

Lu, H. H., Subramony, S. D., Boushell, M. K., and Zhang, X. Tissue engineering strategies for the regener-ation of orthopedic interfaces. Ann Biomed Eng 38, 2142, 2010.

Lu, L. and A. G. Mikos (1996). “The importance of new processing techniques in tissue engineering.” MRS Bull 21(11): 28-32.

Lynch S E, Genco R J, Marx R E., eds. Tissue engineering. Applications in maxillofacial surgery and periodontics, 1st edn. Carol Stream, Ill.: Quintessence Publishing, 1999.

Lyons K M, Hogan B L and Robertson E J 1995 Colocalization of BMP-7 and BMP-2 RNAs suggests that these factors cooperatively mediate tissue interactions during murine development Mech. Dev. 50 71-83.

Ma P X, Choi J W. (AQ) Biodegradable polymer scaffolds with well defined interconnected spherical pore network. Tissue Eng 2001: 7: 23-33.

Malekzeh R, Hollinger J O, Buck D, Adams D F, McAllister B S. Isolation of human osteoblast-like cells and in vitro amplification for tissue engineering. J Periodontol 1998: 69: 1256-1262.

Mano J F, Sousa R A, Boesel L F. Bioinert biodegradable and injectable polymeric matrix composites for hard tissue replacement: State of the art and recent developments. Compos Sci Technol 2004; 64:789-817.

Manolagas S C 1998 The role of IL-6 type cytokines and their receptors in bone. Ann. NY Acad. Sci. 840 194-204.

Mantesso, A., and Sharpe, P. Dental stem cells for tooth regeneration and repair. Expert Opin Biol Ther 9, 1143, 2009.

Mao, J., Stosich, M. S., Moioli, E., Lee, C. H., Fu, S., Bastian, B., et al. Facial reconstruction by biosurgery: cell transplan [symbol] tation vs. cell homing. Tissue Eng Part B Rev 16, 257, 2010.

Mao, J. J., and Prockop, D. J. Stem cells in the face: tooth regeneration and beyond. Cell Stem Cell 11, 291, 2012.

Marion, N. W., and Mao, J. J. Mesenchymal stem cells and tissue engineering. Methods Enzymol 420, 339, 2006.

Mayer H, Scutt A M and Ankenbauer T 1996 Subtle differences in the mitogenic effects of recombinant human bone morphogenetic proteins -2 to -7 on DNA synthesis on primary bone-forming cells and identification of BMP-2/4 receptor Calcif. Tissue Int. 58 249-55.

McCulloch C A, Nemeth E, Lowenberg B, Melcher A H. Paravascular cells in endosteal spaces of alveolar bone contribute to periodontal ligament cell populations. Anat Rec 1987: 219: 233-242.

McCulloch C A. Origins and functions of cells essential for periodontal repair: the role of fibroblasts in tissue homeostasis. Oral Dis 1995: 1: 271-278.

McCulloch C A. Progenitor cell populations in the periodontal ligament of mice. Anat Rec 1985: 211: 258-262.

Meinel L, Fajardo R, Hofmann S, Langer R, Chen J, Snyder B, Vunjak-Novakovic G, Kaplan D. Silk implants for the healing of critical size bone defects. Bone 2005: 37: 688-698.

Melcher A H. Cells of periodontium: their role in the healing of wounds. Ann R Coll Surg Engl 1985: 67: 130-131.

Mikos A G, Lyman M D, Freed L E, Langer R. Wetting of poly (L-lactic acid) and poly (DL-lactic-co-glycolic acid) foams for tissue culture. Biomaterials 1993: 15: 55-58.

Mikos A G, Sarakinos G, Leite S M, Vacanti J P, Langer R. Laminated three-dimensional biodegradable foams for use in tissue engineering. Biomaterials 1993: 14: 323-330.

Mikos K F. Preparation and characterization of poly L-lactic acid foam. Polymer 1994; 35:1068-1077.

Miletich I, Sharpe P T. Neural crest contribution to mammalian tooth formation. Birth Defects Res C Embryo Today 2004; 72: 200-12.

Mina M, Braut A. New insight into progenitor/stem cells in dental pulp using Collal-GFP transgenes. Cells Tissues Organs 2004: 176: 120-133.

Miura M, Gronthos S, Zhao M, Lu B, Fisher L W, Robey P G, Shi S. SHED: stem cells from human exfoliated deciduous teeth. Proc Natl Acad Sci USA 2003: 100: 5807-5812.

Modino S A, Sharpe P T. Tissue engineering of teeth using adult stem cells. Arch Oral Biol 2005: 50: 255-258.

Moioli E K, Mao J J. Chondrogenesis of mesenchymal stem cells by controlled delivery of transforming growth factor-beta3. Conf Proc IEEE Eng Med Biol Soc. 2006; 1:2647-50

Moioli, E. K., Hong, L., Guardado, J., Clark, P. A., and Mao, J. J. Sustained release of TGFbeta3 from PLGA micro-spheres and its effect on early osteogenic differentiation of human mesenchymal stem cells. Tissue Eng 12, 537, 2006.

Mooney D J, Mikos A G. Growing new organs. Sci Am 1999: 280: 60-65.

Mooney D J, Powell C, Piana J, Rutherford B. Engineering dental pulp-like tissue in vitro. Biomaterials 1996: 12: 865-868.

Mooney D J. Novel approach to fabrication porous sponge of poly D,L-lactic-co-glycolic acid without the use of organic solvents. Biomaterials 1996; 17:1417-1422.

Moradian-Oldak J. Amelogenins: assembly, processing and control of crystal morphology. Matrix Biol 2001: 20: 293-305.

Moroni L, de Wijn J R, van Blitterswijk C A. 3D fiber-deposited scaffolds for tissue engineering: Influence of pores geometry and architecture on dynamic mechanical properties. Biomaterials 2006; 27:974-985.

Moss M L. Studies on dentin. I. Mantle dentin. Acta Anat (Basel) 1999: 87: 481-507.

Moule A J, Li H, Bartold P M. Donor variability in the proliferation of human dental pulp fibroblasts. Aust Dent J 1995: 40: 110-114.

Murata M, Inoue M, Arisue M, Kuboki Y, Nagai N (1998) Carrier-dependency of cellular differentiation induced by bone morphogenetic protein in ectopic sites. Int J Oral Maxillofac Surg 27, 391-396.

Murphy W, Simmons C, Kaigler D, Mooney D, Bone Regeneration via a Mineral Substrate and Induced Angiogenesis, Journal of Dental Research 2004 83: 204-210.

Murphy W L, Mooney D J. Controlled delivery of inductive proteins, plasmid DNA and cells from tissue engineering matrices. J Periodontal Res 1999: 34: 413-419.

Muschler G F, Nakamoto C, Griffith L G., Engineering principles of clinical cell-based tissue engineering. J Bone Joint Surg Am. 2004 July; 86-A(7): 1541-58

Na, S., Zhang, H., Huang, F., Wang, W., Ding, Y., Li, D., et al. Regeneration of dental pulp/dentine complex with a three-dimensional and scaffold-free stem-cell sheet-derived pellet. J Tissue Eng Regen Med 2013 [Epub ahead of print]; DOI: 10.1002/term. 1686.

Nait Lechguer, A., Kuchler-Bopp, S., Hu, B., Haikel, Y., and Lesot, H. Vascularization of engineered teeth. J Dent Res 87, 1138, 2008.

Nakagawa T and Tagawa T 2000 Ultrastructural study of direct bone formation induced by BMPs-collagen complex implanted into an ectopic site Oral Dis. 6 172-9.

Nakahara T, Nakamura T, Kobayashi E et al. In situ tissue engineering of periodontal tissues by seeding with periodontal ligament-derived cells. Tissue Eng 2004; 10: 537-44.

Nakahara T, Nakamura T, Kobayashi E et al. Novel approach to regeneration of periodontal tissues based on in situ tissue engineering: effects of controlled release of basic fibroblast growth factor from a sandwich membrane. Tissue Eng 2003; 9: 153-62.

Nakahara T. A review of new developments in tissue engineering therapy for periodontitis. Dent Clin North Am 2006; 50: 265-76, ix-x.

Nakao K, Morita R, Saji Y et al. The development of a bioengineered organ germ method. Nat Meth 2007; 4: 227-30.

Nakao, K., Morita, R., Saji, Y., Ishida, K., Tomita, Y., Ogawa, M., et al. The development of a bioengineered organ germ method. Nat Methods 4, 227, 2007.

Nakashima M, Akamine A. The application of tissue engineering to regeneration of pulp and dentin in endodontics. J. Endod 2005: 31: 711-718.

Nakashima M, Bone morphogenetic proteins in dentin regeneration for potential use in endodontic therapy. Cytokine & Growth Factor Reviews 2005: Vol. 16: Issue 3: 369-376.

Nakashima M, lohara K, Ishikawa M, Ito M, Tomokiyo A, Tanaka T, Akamine A. Stimulation of reparative dentin formation by ex vivo gene therapy using dental pulp stem cells electrotransfected with growth/differentiation factor 11 (Gdfl 1). Hum Gene Ther 2004: 15: 1045-1053.

Nakashima M. The application of bone morphogenic proteins to dental tissue engineering. Nature Biotechnology, Vol 21 Number 9 2003 Pg 1025-1032.

Nakatomi M, Morita I, Eto K, Ota M S. Sonic hedgehog signaling is important in tooth root development. J Dent Res 2006; 85: 427-31.

Nakatsu M, Sainson R, Perez-del-Pulgar S, Aoto J, Aitkenhead M, Taylor K, Carpenter P, Hughes C, VEGF121 and VEGF 165 Regulate Blood Vessel Diameter Through Vascular Endothelial Growth Factor Receptor 2 in an In Vitro Angiogenesis Model, Lab Invest. 2003, 83:12, p I873.

Nanci, A., and Bosshardt, D. D. Structure of periodontal tissues in health and disease. Periodontol 2000 40, 11, 2006.

National Institute for Dental and Craniofacial Research. Strategic Plan-2003-2008. J Am Coll Dent 2003: 70: 43-55.

Nebahat D, Dilhan M K, Elvan B. Biocomposites of nanohydroxyapatite with collagen and poly vinyl alcohol. Coll Surf B 2006; 48:42-49.

Nie, H., Lee, C. H., Tan, J., Lu, C., Mendelson, A., Chen, M., et al. Musculoskeletal tissue engineering by endogenous stem/progenitor cells. Cell Tissue Res 347, 665, 2012.

Ohazama A, Modino S A, Miletich I, Sharpe P T. Stem-cell based tissue engineering of murine teeth. J Dent Res 2004: 83: 518-522.

Onishi T, Ishidou Y, Nagamine T, Yone K, Imamura T, Kato M, Sampath T K, ten Dijke P and Sakou T 1998 Distinct and overlapping patterns of localization of bone morphogenetic protein (BMP) family members and a BMP type II receptor during fracture healing in rats Bone 22 605-12.

Orban, B. J. Orban's Oral Histology and Embryology. Mosby, St. Louis, 1980.

Owen M, Friedenstein A J. Stromal stem cells: marrow derived osteogenic precursors. Ciba Found Symp 1988: 136: 42-60.

Owen M E, Cave J, Joyner C J. Clonal analysis in vitro of osteogenic differentiation of marrow CFU-F. J Cell Sci 1987: 87: 731-738.

Papagerakis, P., Berdal, A., Mesbah, M., Peuchmaur, M., Malaval, L., Nydegger, J., et al. Investigation of osteo-calcin, osteonectin, and dentin sialophosphoprotein in d [symbol] eveloping human teeth. Bone 30, 377, 2002.

Park, C. H., Rios, H. F., Jin, Q., Sugai, J. V., Padial-Molina, M., Taut, A. D., et al. Tissue engineering bone-ligament complexes using fiber-guiding scaffolds. Biomaterials 33, 137, 2012.

Payne T L, Skobe Z, Yelick P C. Regulation of tooth development by the novel type I TGFβ family member receptor Alk8. J Dent Res 2001: 80: 1968-1973.

Peled, A., Grabovsky, V., Habler, L., Sandbank, J., Arenzana-Seisdedos, F., Petit, L, Ben-Hur, H., Lapidot, T., and Alon, R. The chemokine SDF-I stimulates integrin-mediated arrest of CD34 cells on vascular endothelium under shear flow. J. Clin. Invest. 104, 1199, 1999.

Peled, A., Petit, L, Kollet, O., Magid, M., Ponomaryov, T., Byk, T., Nagler, A., Ben-Hur, H., Many, A., Shultz, L., Lider, O., Alon, R., Zipori, D., and Lapidot, T. Dependence of human stem cell engraftment and repopulation of NOD/SCID mice on CXCR4. Science 283, 845, 1999.

Peng Y, Kang Q, Cheng H, Li X, Sun M H, Jiang W, Luu H H, Park J Y, Haydon R C and He T C 2003 Transcriptional characterization of bone morphogenetic proteins (BMPs)-mediated osteogenic signalling J. Cell. Biochem. 90 1149-65.

Perez M A A, Pitaru S, Fregoso A O, Gasga J R, Arzate H. Anticementoblastoma-derived protein antibody partially inhibits mineralization on a cementoblastic cell line. J Struct Biol 2003: 143: 1-13.

Perkins S, Fleischman R A. Stromal cell progeny of murin bone marrow fibroblast colony-forming units are clonal endothelial-like cells that express collagen IV and laminin. Blood 1990: 75: 620-625.

Perrino M A, Yelick P C. Immuno localization of Alk8 during replacement tooth development in zebrafish. Cells Tissues Organs 2004: 176: 17-27.

Persidis A. Tissue engineering. Nature Biotechnol 1999: 17: 508-510.

Pietrokovski J, Massler M. Ridge remodeling after tooth extraction in rats. J. Dent. Res. 46 1 (1967), pp. 222-231

Pihlstrom B L, Michalowicz B S, Johnson N W. Periodontal diseases. Lancet 2005; 366: 1809-20.

Pitaru S, McCulloch C A G, Naryanan A S. Cellular origins and differentiation control mechanisms during periodontal development and wound healing. J Periodontal Res 1994: 29: 81-94.

Plikus M V, Zeichner-David M, Mayer J A et al. Morphoregulation of teeth: modulating the number, size, shape and differentiation by tuning Bmp activity. Evol Dev 2005; 7: 440-57.

Poison A M. Periodontal regeneration. Chicago: Quintessence Publishing Co.,1994.

Popowics, T., Foster, B. L., Swanson, E. C., Fong, H., and Somerman, M. J. Defining the roots of cementum formation. Cells Tissues Organs 181, 248, 2005.

Qmg C, Jian Y, Jianzhong B, Shenguo W. A novel porous cells scaffold made of polylactide-dextran blend by combining phase-separation and particle leaching techniques. Biomaterials 2002; 23:4483-4492.

Quesenberry P J, Becker P, Stewart F M. Phenotype of the engrafting stem cell in mice. Stem Cells. 1998; 16 Suppl 1:33-5

Quinones C R, Caffesse R G. Current status of guided tissue regeneration. Periodontal 2000 1995: 9: 55-68.

Rahaman M N, Mao J J. Stem cell-based composite tissue constructs for regenerative medicine. Biotechnol Bioeng 2005; 91: 261-84.

Rao M S. Multipotent and restricted precursors in the central nervous system. Anat Rec 1999: 257: 137-148.

Rezwan K, Chen Q, Blaker J. Biodegradable and bio active porous polymer/inorganic composite scaffolds for bone tissue engineering. Biomaterials 2006; 27:3413-3431.

Rich J, Jaakkola T, Tirri T. In vitro evaluation of poly e-caprolactone-co-DL-lactide/bioactive glass composites. Biomaterials 2002; 23:2143-2150.

Ripamonti U, Reddi A H. Tissue engineering, morphogenesis, and regeneration of the periodontal tissues by bone morphogenetic proteins. Crit Rev Oral Biol Med 1997: 8: 154-163.

Rouabhia M, Ross G, Page N and Chakir J 2002 Interleukin-18 and gamma interferon production by oral epithelial cells in response to exposure to Candida albicans or lipopolysaccharide stimulation Infect. Immun. 70 7073-80.

Rubio D, Garcia-Castro J, Martin M C, de la Fuente R, Cigudosa J C, Lloyd A C, Bernad A. Spontaneous human adult stem cell transformation. Cancer Res 2005: 65: 3035-3039 [Erratum in Cancer Res 2005: 65: 4969].

Rutherford R B, Ryan M E, Kennedy J E, Tucker M M, Charette M F. Platelet-derived growth factor and dexamethasone combined with a collagen matrix induce regeneration of the periodontium in monkeys. J Clin Periodontal 1993: 20: 537-544.

Sainio K, Raatikainen-Ahokas A. Mesonephric kidney—stem cell factory? Int J Dev Biol 1999: 43: 435-439.

Saito N and Takaoka K 2003 New synthetic biodegradable polymers as BMP carriers for bone tissue engineering Biomaterials 24 2287-93.

Saito N, Okada T, Toba S, Miyamoto S, Takaoka K (1999) New synthetic absorbable polymers as BMP carriers: plastic properties of poly-D,L-lactic acidpolyethylene glycol block copolymers. J Biomed Mater Res 47, 104-110.

Samavedi, S., Guelcher, S. A., Goldstein, A. S., and Whit [symbol] tington, A. R. Response of bone marrow stromal cells to graded co-electrospun scaffolds and its implications for engineering the ligament-bone interface. Biomaterials 33, 7727, 2012.

Sampath T K, Coughlin J E, Whetstone R M, Banach D, Corbett C, Ridge R J, Ozkaynak E, Oppermann H and Rueger D C 1990 Bovine osteogenic protein is composed of dimers of OP-I and BMP-2A, two members of the transforming growth factor-beta superfamily. J. Biol. Chem. 265 13198-205.

Santos E, Badin S, Shenker B, Shapiro I, Ducheye P, Si—Ca—P xerogels and bone morphogenetic protein act synergistically on rat stromal marrow cell differentiation in vitro. J Biomed Mater Res 41, 87-94.

Schantz J, Chim H, Whiteman M. Cell Homing in Tissue Engineering: SDF-I Mediates Site-Directed Homing of Mesenchymal Stem Cells within Three-Dimensional Polycaprolactone Scaffolds, Tissue Engineering 2007: Vol. 13: 11: 2615-2624.

Schantz, J. T., and Ng, K. W. A Manual for Primary Human Cell Culture. New Jersey: World Scientific, 2004.

Schantz, J. T., Hutmacher, D. W., Chim, H., Ng, K. W., Lim, T. C., and Teoh, S. H. Induction of ectopic bone formation by using human periosteal cells in combination with a novel scaffold technology. Cell Transplant. 11, 125, 2002.

Scott, L. J., Clarke, N. W., George, N. J., Shanks, J. H., Testa, N. G., and Lang, S. H. Interactions of human prostatic epithelial cells with bone marrow endothelium: binding and invasion. Br. J. Cancer 84, 1417, 2001.

Seale P, Rudnicki M A. A new look at the origin, function, and stem-cell” status of muscle satellite cells. Dev Biol 2000: 218: 115-124.

Seo, B. M., Miura, M., Gronthos, S., Bartold, P. M., Batouli, S., Brahim, J., et al. Investigation of multipotent postnatal stem cells from human periodontal ligament. Lancet 364, 149, 2004.

Sharpe P T, Young C S. Test-tube teeth. Sci Am 2005; 293: 34-41.

Shi S, Bartold P M, Miura M, Seo B M, Robey P G, Gronthos S (2005) The efficacy of mesenchymal stem cells to regenerate and repair dental structures. Orthod Cranio-fac Res 8: 191-199.

Shi S, Gronthos S, Chen S, Reddi A, Counter C M, Robey P G, Wang C Y. Bone formation by human postnatal bone marrow stromal stem cells is enhanced by telomerase expression. Nat Biotechnol. 2002 June; 20(6):587-91.

Shi S, Gronthos S. Perivascular niche of postnatal mesenchymal stem cells in human bone marrow and dental pulp. J Bone Miner Res 2003: 18: 696-704.

Shi S, Robey P G, Gronthos S. Comparison of human dental pulp and bone marrow stromal stem cells by cDNA microarray analysis. Bone 2001: 29: 532-539.

Shieh S J, Vacanti J P. State-of-the-art tissue engineering: from tissue engineering to organ building. Surgery 2005 137: 1-7.

Shimizu Y. Tissue engineering for soft tissues. In: Ikada Y, ed. Tissue Engineering for Therapeutic Use 2. Tokyo: Elsevier, 1998; 119-22.

Shin H, Jo S, Mikos A G. Biomimetic materials for tissue engineering. Biomaterials 2003; 24:4353-4364.

Simmons P J, Torok-Storb B. Identification of stromal cell precursors in human bone marrow by a novel monoclonal antibody, STRO-I. Blood 1991: 78: 55-62.

Simonsen J L, Rosada C, Serakinci N, Justesen J, Stenderup K, Rattan S I, Jensen T G, Kassem M. Telomerase expression extends the proliferative life-span and maintains the osteogenic potential of human bone marrow stromal cells. Nat Biotechnol 2002: 20: 592-596.

Sittinger M, Bujia J, Rotter N, Reitzel D, Minuth W W, Burmester G R. Tissue engineering and autologous transplant formation: practical approaches with resorbable biomaterials and new cell culture techniques. Biomaterials 1996: 17: 237-242.

Slavkin H C, Bringas P Jr, Bessem C, Santos V, Nakamura M, Hsu M Y, Snead M L, Zeichner-David M, Fincham A G. Hertwig's epithelial root sheath differentiation and initial cementum and bone formation during long-term organ culture of mouse mandibular first molars using serumless, chemically defined medium. J Periodontal Res 1989: 24: 28-40.

Smith A J, Murray P E, Sloan A J, Matthews J B, Zhao S. Transdentinal stimulation of tertiary dentinogenesis. Adv Dent Res 2001: 15: 51-54.

Smith A J. Tooth tissue engineering and regeneration—a translational vision. J Dent Res 2004: 83: 517.

Sodek J. A new approach to assessing collagen turnover by using a microassay. A highly efficient and rapid turnover of collagen in rat periodontal tissues. Biochem J 1976: 160:

Sonoyama W, Liu Y, Fang D, Yamaza T, Seo B M, Zhang C, Liu H, Gronthos S, Wang C, Shi S, Wang S, Mesenchymal Stem Cell-Mediated Functional Tooth Regeneration in Swine, PLoS ONE. 2006; 1(1): e79.

Spalazzi, J. P., Dagher, E., Doty, S. B., Guo, X. E., Rodeo, S. A., and Lu, H. H. In vivo evaluation of a multiphased scaffold designed for orthopaedic interface tissue engineering and soft tissue-to-bone integration. J Biomed Mater Res A 86, 1, 2008.

Staels, S., De Coster, P., Vral, A., Temmerman, L., and De Pauw G. An experimental study on periodontal regenera [symbol] tion after subcutaneous transplantation of rat molar with and without cryopreservation: an in vivo study. Cryobiology 66, 303, 2013.

Steele-Perkins G, Butz K G, Lyons G E et al. Essential role for NFI-C/CTF transcription-replication factor in tooth root development. Mol Cell Biol 2003; 23: 1075-84.

Sternlicht M D and Werb Z 2001 How matrix metalloproteinases regulate cell behavior Annu. Rev. Cell Dev. Biol. 17 463-516.

Stock U A, Vacanti J P. Tissue engineering: current state and prospects. Annu Rev Med 2001: 52: 143-151.

Stosich M S, Bastian B, Marion N W, Clark P A, Reilly G, Mao J J, Vascularized adipose tissue grafts from human mesenchymal stem cells with bioactive cues and microchannel conduits. Tissue Eng. 2007 December; 13(12):2881-90

Sumikawa D A, Marshall G W, Gee L, Marshall S J. Microstructure of primary tooth dentin. Pediatr Dent 1999: 21: 439-444.

Sundaramurthy, S., and Mao, J. J. Modulation of endo-chondral development of the distal femoral condyle by mechanical loading. J Orthop Res 24, 229, 2006.

Susan Liao, Kazuchika T. Human neutrophils reaction to the biodegraded nano-hydroxyapatite/collagen and nano-hydroxyapatite/collagen/poly L-lactic acid composite. J Biomed Mater Res 2006; 76A: 820-825.

Suzuki Y, Tanihara M, Suzuki K, Saitou A, Sufan W and Nishimura Y 2000 Alginate hydrogel linked with synthetic oligopeptide derived from BMP-2 allows ectopic osteoinduction in vivo J. Biomed. Mater. Res. 50 405-9.

Sweeney T M, Opperman L A, Persing J A, Ogle R C (1995) Repair of critical size rat calvarial defects using extracellular matrix protein gels. J Neurosurg 83, 710-715.

Sylvain D, Eduardo S, Antoni P T. Freeze casting of hydroxyapatite scaffolds for bone tissue engineering. Biomaterials 2006; 27:5480-5489.

Taba M Jr, Jin Q, Sugai J V, Giannobile W V. Current concepts in periodontal bioengineering. Orthod Craniofac Res 2005: 8: 292-302.

Tabata Y. Significance of release technology in tissue engineering. Drug Discov Today 2005; 10: 1639-46.

Taguchi Y, Yamamoto M, Yamate T, Lin S C, Mocharla H, DeTogni P, Nakayama N, Boyce B F, Abe E and Manolagas S C 1998 Interleukin-6-type cytokines stimulate mesenchymal progenitor differentiation toward the osteoblastic lineage. Proc. Assoc. Am. Physicians 110 559-74.

Tan K H, Chua C K, Leong K F. Scaffold development using selective laser sintering of polyetheretherketone-hydroxyapatite biocomposite blends. Biomaterials 2003; 24:3115-3123.

Tardif F, Ross G and Rouabhia M 2004 Gingival and dermal fibroblasts produce interleukin-1 beta converting enzyme and interleukin-1 beta but not interleukin-18 even after stimulation with lipopolysaccharide J. Cell. Physiol. 198 125-32.

Thesleff I, Aberg T. Molecular regulation of tooth development. Bone 1999: 25: 123-125.

Thesleff I, Keranen S, Jernvall J. Enamel knots as signaling centers linking tooth morphogenesis and odontoblast differentiation. Adv Dent Res 2001: 15: 14-18.

Thesleff I, Sharpe P. Signalling networks regulating dental development. Mech Dev 1997; 67: 111-23.

Thesleff I, Vaahtokari A, Kettunen P, Aberg T. Epithelialmesenchymal signaling during tooth development. Connect Tissue Res 1995: 32: 9-15.

Thesleff I. Epithelial-mesenchymal signalling regulating tooth morphogenesis. J Cell Sci 2003; 116: 1647-8.

Thesleff I. The genetic basis of tooth development and dental defects. Am J Med Genet A 2006; 140: 2530-5.

Thies R S, Bauduy M, Ashton B A, Kurtzberg L, Wozney J M and Rosen V 1992 Recombinant human bone morphogenetic protein-2 induces osteoblastic differentiation in W-20-17 stromal cells Endocrinology 130 1318-24.

Toma C, Pittenger M F, Cahill K S, Byrne B J, Kessler P D. Human mesenchymal stem cells differentiate to a cardiomyocyte phenotype in the adult murine heart. Circulation 2002: 105: 93-98.

Tsuji K, Ito Y and Noda M 1998 Expression of the PEBP2alphaA/AML3/CBFAI gene is regulated by BMP4/7 heterodimer and its overexpression suppresses type I collagen and osteocalcin gene expression in osteoblastic and nonosteoblastic mesenchymal cells Bone 22 87-92.

Tucker A, Sharpe P. The cutting-edge of mammalian development: how the embryo makes teeth. Nat Rev Genet 2004; 5: 499-508.

Tummers M, Thesleff I (2003) Root or crown: a developmental choice orchestrated by the differential regulation of the epithelial stem cell niche in the tooth of two rodent species. Development 130: 1049-1057.

US Department of Health and Human Services. Oral health in America: a report of the surgeon general. Rockville, Md.: US Department of Health and Human Services, NIDCR, NIH, 2000.

Vacanti M P, Leonard J L, Dore B, Bonassar L J, Cao Y, Stachelek S J, Vacanti J P, O'Connell F, Yu C S, Farwell A P, Vacanti C A. Tissue-engineered spinal cord. Transplant Proc 2001: 33: 592-598.

Valles-Lluch, A., Novella-Maestre, E., Sancho-Tello, M., Pradas, M. M., Ferrer, G. G., and Batalla, C. C. Mimicking natural dentin using bioactive nanohybrid scaffolds for dentinal tissue engineering. Tissue Eng Part A 16, 2783, 2010.

Van der Heyden C, Allizard F, Sire J Y, Huysseune A. Tooth development in vitro in two teleost fish, the cichlid Hemichromis bimaculatus and the cyprinid Danio rerio. Cell Tissue Res 2005: 321: 375-389.

Van der Heyden C, Huysseune A. Dynamics of tooth formation and replacement in the zebrafish (Danio rerio) (Teleostei, Cyprinidae). Dev Dyn 2005: 219: 486-496.

Van der Heyden C, Wautier K, Huysseune A. Tooth succession in the zebrafish (Danio rerio). Arch Oral Biol 2001: 46: 1051-1058.

Vandervelde S, van Luyn M J, Tio R A, Harmsen M C Signaling factors in stem cell-mediated repair of infarcted myocardium. J Mol Cell Cardiol. 2005 August; 39(2):363-76.

Varghese S and Canalis E 1997 Regulation of collagenase-3 by bone morphogenetic protein-2 in bone cell cultures Endocrinology 138 1035-40. [0390] Van Dijk L J, Schakenraad J M, van der Voort H M, Busscher H J. Cell seeding of periodontal ligament fibroblasts. A pilot study. J Clin Periodontal 1991: 18: 196-199.

Vavidovitch Z. Bone metabolism associated with tooth eruption and orthodontic tooth movement. J Periodontal 1979: 50 (4 Spec No): 22-29.

Viljanen V V, Lindholm T C, Gao T J, Lindholm T S (1997) Low dosage of native allogeneic bone morphogenetic protein in repair of sheep calvarial defects. Int J Oral Maxillofac Surg 26, 389-393.

Viswanathan, H. L., Berry, J. E., Foster, B. L., Gibson, C. W., Li, Y., Kulkarni, A. B., et al. Amelogenin: a potential regulator of cementum-associated genes. J Periodontol 74, 1423, 2003.

Wei Jie, Li Yubao. A study on nano-composite of hydroxy apatite and polyamide. J Mater Sci 2003; 38:3303-3306.

Wei, F., Song, T., Ding, G., Xu, J., Liu, Y., Liu, D., et al. Functional tooth restoration by allogeneic mesenchymal stem cell-based bio-root regeneration in swine. Stem Cells Dev 22, 1752, 2013.

Williams, J. M., Adewunmi, A., Schek, R. M., Flanagan, C. L., Krebsbach, P. H., Feinberg, S. E., et al. Bone tissue engineering using polycaprolactone scaffolds fabricated via selective laser sintering. Biomaterials 26, 4817, 2005.

Woodfield, T. B., Van Blitterswijk, C. A., De Wijn, J., Sims, T. J., Hollander, A. P., and Riesle, J. Polymer scaffolds fabricated with pore-size gradients as a model for studying the zonal organization within tissue-engineered cartilage constructs. Tissue Eng 11, 1297, 2005.

Woodfield, T. B., J. Malda, et al. (2004). “Design of porous scaffolds for cartilage tissue engineering using a three-dimensional fiber-deposition technique.” Biomaterials 25(18): 4149-61.

Wozney J M, Rosen V, Byrne M, Celeste A J, Moutsatsos I, Wang E A. Growth factors influencing bone development. J Cell Sci Suppl. 1990; 13:149-156.

Wynn, R. F., Hart, C. A., Corradi-Perini, C, O'Neill, L., Evans, C. A., Wraith, E., Fairbairn, L. J., and Bellantuono, I. A small proportion of mesenchymal stem cells strongly expresses functionality active CXCR4 receptor capable of promoting migration to bone marrow. Blood 104, 2643, 2004.

Xiao Y, Qian H, Young W G, Bartold P M. Tissue engineering for bone regeneration using differentiated alveolar bone cells in collagen scaffolds. Tissue Eng 2003: 9: 1167-1177.

Yamada S, Murakami S, Matoba R, Ozawa Y, Yokokoji T, Nakahira Y, Ikezawa K, Takayama S, Matsubara K, Okada H. Expression profile of active genes in human periodontal ligament and isolation of PLAP-I, a novel SLRP family gene. Gene 2001: 275: 279-286.

Yamashiro T, Tummers M, Thesleff I. Expression of bone morphogenetic proteins and Msx genes during root formation. J Dent Res 2003; 82: 172-6.

Yang, P. J., and Temenoff, J. S. Engineering orthopedic tissue interfaces. Tissue Eng Part B Rev 15, 127, 2009.

Yang, R., Chen, M., Lee, C. H., Yoon, R., Lal, S., and Mao, J. J. Clones of ectopic stem cells in the regeneration of muscle defects in vivo. PLoS One 5, e13547, 2010.

Yelick P C, Schilling T F. Molecular dissection of craniofacial development using zebrafish. Crit Rev Oral Biol Med 2002: 13: 308-322.

Yelick P C, Vacanti J P. Bioengineered teeth from tooth bud cells. Dent Clin North Am 2006; 50: 191-203, viii.

Yeong W-Y, Chua C-K. Rapid prototyping in tissue engineering: Challenges and potential. Trends Biotechnol 2004; 22:643-652.

Yildirim, S., Fu, S. Y., Kim, K., Zhou, H., Lee, C. H., Li, A., et al. Tooth regeneration: a revolution in stomatology and evolution in regenerative medicine. Int J Oral Sci 3, 107, 2011.

Young C S, Abukawa H, Asrican R et al. Tissue-engineered hybrid tooth and bone. Tissue Eng 2005; 11: 1599-610.

Young C S, Abukawa H, Asrican R, Ravens M, Troulis M J, Kaban L B, Vacanti J P, Yelick P C (2005) Tissue-engineered hybrid tooth and bone. Tissue Eng 11: 1599-1610.

Young C S, Kim S-W, Taylor R, Vacanti J P, Bartlett J D, Yelick P C. Developmental analysis and three-dimensional computer modeling of tooth crowns grown on biodegradable polymer scaffolds. Arch Oral Biol 2005: 50: 259-265.

Young C S, Terada S, Vacanti J P, Honda M, Bartlett J D, Yelick P C. Tissue engineering of complex tooth structure on biodegradable polymer scaffolds. J Dent Res 2002: 81: 695-700.

Zhang W, Walboomers X F, Wolke J G, Bian Z, Fan M W, Jansen J A. Differentiation ability of rat postnatal dental pulp cells in vitro. Tissue Eng 2005: 11: 357-368.

Zhao J, Guo L Y, Yang X B, Weng J. Preparation of bioactive porous HA/PCL composite scaffolds. Applied Surface Science 2008: Vol. 255: Issue 5: Part 2: 2942-2946.

Zhao L R, Duan W M, Reyes M, Keene C D, Verfaillie C M, Low W C. Human bone marrow stem cells exhibit neural phenotypes and ameliorate neurological deficits after grafting into the ischemic brain of rats. Exp Neural 2002: 174: 11-20.

Zhao M, Jin Q, Berry J E, Nociti F H Jr, Giannobile W V, Somerman M J. Cementoblast delivery for periodontal tissue engineering. J Periodontol 2004: 75: 154-161.

Zhu W, Rawlins B A, Boachie-Adjei O, Myers E R, Arimizu J, Choi E, Lieberman J R, Crystal R G and Hidaka C 2004 Combined bone morphogenetic protein-2 and -7 gene transfer enhances osteoblastic differentiation and spine fusion in a rodent model J. Bone Miner. Res. 19 2021-32.

What is claimed is:

1. An acellular mammalian tooth-shaped scaffold comprising:
(i) a matrix material;
(ii) a composition comprising stromal cell-derived factor-1 (SDF-1) and a bone morphogenetic protein-7 (BMP-7);
wherein,
the composition is chemotactic, osteogenic, dentinogenic, amelogenic, or cementogenic;
the composition induces migration of progenitor cells when the scaffold is in contact with a dental tissue of a mammalian subject;
the composition is distributed throughout the tooth-shaped scaffold; and
the scaffold does not comprise a living cell prior to implantation.

2. The tooth-shaped scaffold of claim 1, having the shape of a human incisor, a human cuspid, a human bicuspid, or a human molar.

3. The tooth-shaped scaffold of claim 1, the composition further comprising platelet-derived growth factor (PDGF), endothelial cell growth factor (ECGF), transforming growth factor-β (TGF-β), transforming growth factor-β1 (TGF-β1), epidermal growth factor (EGF), hepatocyte growth factor (HGF), a bone morphogenetic protein (BMP) other than BMP-7, a growth and differentiation factor (GDF), insulin-like growth factor-1 (IGF1), vascular endothelial growth factor (VEGF), fibroblast growth factor (FGF), a dentin matrix protein, a dentin sialoprotein, a bone sialoprotein, amelogenin, or an integrin.

4. The tooth-shaped scaffold of claim 1, wherein SDF-1 functions as a chemotactic growth factor is and BMP-7 functions as an osteogenic, dentinogenic, amelogenic, or cementogenic growth factor.

5. The tooth-shaped scaffold of claim 1, comprising:
(i) BMP-7 at about 10 ng/g to 1000 μg/g scaffold and SDF1 at about 10 ng/g to 1000 μg/g scaffold; or
(ii) BMP-7 at about 100 μg/g scaffold and SDF1 at about 100 μg/g scaffold.

6. The tooth-shaped scaffold of claim 1, wherein the matrix material comprises an osteoconductive material.

7. The tooth-shaped scaffold of claim 6, wherein the osteoconductive material is hydroxyapatite.

8. The tooth-shaped scaffold of claim 7, comprising at least one feature selected from the group consisting of:
(i) the matrix material comprises a mixture of ε-polycaprolactone and hydroxyapatite; or
(ii) the matrix material comprises a mixture of about 80 wt % ε-polycaprolactone and about 20 wt % hydroxyapatite.

9. The tooth-shaped scaffold of claim 1, further comprising microchannels having a diameter of (i) between 50 and 500 μm; or (ii) about 200 μm.

10. The tooth-shaped scaffold of claim 9, wherein:
(i) the composition is imbedded in a gel in the microchannels; or
(ii) the composition is imbedded in a collagen gel in the microchannels.

11. The tooth-shaped scaffold of claim 9, wherein the composition is imbedded in a gel in the microchannels and the scaffold further comprises a nonporous cap.

12. The tooth-shaped scaffold of claim 9, wherein:
the microchannels have a diameter of about 200 μm;
BMP-7 is imbedded in the microchannels in a collagen gel at a concentration of about 100 ng/ml gel;
SDF1 is imbedded in the microchannels in a collagen gel at a concentration of about 100 ng/ml gel; and
the scaffold further comprises a nonporous cap.

13. The tooth-shaped scaffold of claim 1, wherein the composition is in a slow-release formulation.

14. The tooth-shaped scaffold of claim 1, comprising:
a slow release formulation composition comprising a chemotactic growth factor of SDF1 and an osteogenic, dentinogenic, amelogenic, or cementogenic growth factor of BMP-7;
an osteoconductive material comprising a mixture of about 80 wt % ε-polycaprolactone and about 20 wt % hydroxyapatite;
microchannels in the osteoconductive material having a diameter of between 50 μm and 500 μm, the microchannels comprising a gel; and
a nonporous cap;
wherein
the scaffold has the shape of a human incisor, a human cuspid, a human bicuspid or a human molar;
the BMP-7 is imbedded in the gel at about 10 ng/g to 1000 μg/g scaffold; and
the SDF1 is imbedded in the gel at about 10 ng/g to 1000 μg/g scaffold.

15. The tooth-shaped scaffold of claim 1, comprising at least one feature selected from the group consisting of:
(i) a 3D printed scaffold;
(ii) the scaffold is the shape of a first molar from a human mouth;
(iii) the matrix material comprises an osteoconductive material;
(iv) the matrix material comprises hydroxyapatite;
(v) the matrix material comprises a mixture of ε-polycaprolactone and hydroxyapatite;
(vi) the matrix material comprises a mixture of about 80 wt % ε-polycaprolactone and about 20 wt % hydroxyapatite;
(vii) the scaffold comprises microchannels having a diameter of between about 50 and about 500 μm;
(viii) the scaffold comprises microchannels having a diameter of about 200 μm;
(ix) the composition is imbedded in microchannels in a collagen gel;
(x) the composition is imbedded in microchannels in a collagen gel, the collagen gel comprising SDF1 at a concentration of about 100 ng/ml gel, and BMP-7 at a concentration of about 100 ng/ml gel; and
(xi) the scaffold comprises a nonporous cap.

16. The tooth-shaped scaffold of claim 1, comprising:
(i) collagen gel imbedded in the microchannels of the scaffold;
(ii) BMP-7 at a concentration of about 100 ng/ml in the microchannels of the scaffold; and
(iii) SDF-1 at a concentration of about 100 ng/ml in the microchannels of the scaffold.

17. The tooth-shaped scaffold of claim 1, comprising at least one feature selected from the group consisting of:
(i) the scaffold is shaped like a tooth that is absent in a mammal;
(ii) the scaffold is shaped like a first molar from a human mouth;
(iii) the matrix material comprises an osteoconductive material;
(iv) the matrix material comprises hydroxyapatite; and
(v) the matrix material comprises a mixture of ε-polycaprolactone and hydroxyapatite;
(vi) the scaffold comprises microchannels having a diameter of between 50 μm and 500 μm; and
(vii) the scaffold further comprises a nonporous cap.
